(19) United States
(12) Patent Application Publication
(10) Pub. No.: US 2015/0037240 A1
(43) Pub. Date: Feb. 5, 2015

(54) METHODS OF PREPARING CATALYSTS FOR THE CHIRALLY SELECTIVE SYNTHESIS OF SINGLE-WALLED CARBON NANOTUBES

(71) Applicant: Nanyang Technological University, Singapore (SG)

(72) Inventor: Yuan Chen, Singapore (SG)

(21) Appl. No.: 14/384,614

(22) PCT Filed: Mar. 12, 2013
(86) PCT No.: PCT/SG2013/000101

§ 371 Date: Sep. 11, 2014

Related U.S. Application Data
(60) Provisional application No. 61/609,703, filed on Mar. 12, 2012.
(60) Provisional application No. 61/753,645, filed on Jan. 17, 2013.

(51) Int. Cl. B01J 27/053; B01J 21/08; C01B 31/02

(52) U.S. Cl. CPC B01J 27/053; C01B 31/0233; B01J 21/08; C01B 2202/02; C01B 2202/20
USPC 423/447.3; 502/217

(57) ABSTRACT

Methods of preparing a sulfur-containing catalyst for the chirally selective synthesis of single-walled carbon nanotubes are presented. Sulfur-containing catalysts for the chirally selective synthesis of single-walled carbon nanotubes, the catalysts comprising sulfur-doped transition metal as active phase on a support, and methods of forming single-walled carbon nanotubes having a selected chirality using the catalysts are also presented.

### CROSS-REFERENCE TO RELATED APPLICATIONS

This application claims the benefit of priority of U.S. provisional application No. 61/609,703 filed on 12 Mar. 2012 and U.S. provisional application No. 61/753,645 filed on 17 Jan. 2013, the content of which are incorporated herein by reference in their entirety for all purposes.

### TECHNICAL FIELD

The invention relates to methods of preparing catalysts for the chirally selective synthesis of single-walled carbon nanotubes, and catalysts formed thereof. The invention also relates to methods of forming single-walled carbon nanotubes having a selected chirality.

### BACKGROUND

Single-walled carbon nanotubes (SWCNT) have been widely studied since its discovery. Electronic and optical properties of single-walled carbon nanotubes correlate with their chiral structures, and many applications need chirally pure SWCNTs that current synthesis methods cannot produce. Instead, state of the art synthesis methods produce SWCNTs with different (n,m) structures, leading to mixtures with distinct electronic properties ranging from metal to semiconductors with different band gaps.

Although single chirality nanotubes may be separated from SWCNT mixtures using various separation processes, yield, scalability, and cost of such separations, as well as the property (length and functionality) of resulting SWCNTs, are dependent on the initial chirality distribution in SWCNT mixtures. This, in turn, is largely determined during SWCNT growth.

Current methods to form chiral-specific carbon nanotubes are restricted to small-diameter chiral SWCNTs, such as SWCNTS having a chiral index of (6,5) or (7,5). Furthermore, total carbon (SWCNT) yield of reported chiral specific growth thus far is very low, which translates into difficulties in achieving scalable production of specific SWCNTs for various applications. Adding to the fact that there are more than 100 different chiral SWCNTs with diameters in the range of between 0.6 nm and 1.5 nm alone, there remains a need for improved methods and catalysts that allow formation of carbon nanotubes having single chirality selectivity.

In view of the above, there is a need for improved methods of preparing catalysts for the chirally selective synthesis of single-walled carbon nanotubes, and catalysts formed thereof, as well as methods of forming single-walled carbon nanotubes having a selected chirality, that addresses at least one of the above-mentioned problems.

### SUMMARY

In a first aspect, the invention refers to a method of preparing a sulfur-containing catalyst for the chirally selective synthesis of single-walled carbon nanotubes. The method comprises:

a)
i) providing a transition metal-containing support, wherein the transition metal is selected from the group consisting of cobalt, iron, nickel, chromium, manganese, copper, rhodium, ruthenium, and mixtures thereof;
ii) impregnating the transition metal-containing support with a solution comprising sulfur to form a sulfur-doped transition metal-containing support; and
iii) calcining the sulfur-doped transition metal-containing support at a temperature of less than 700° C. to form the catalyst; or

b)
i) impregnating a support with a solution comprising a sulfate salt of a transition metal to form a transition metal sulfate-impregnated support, wherein the transition metal is selected from the group consisting of cobalt, iron, nickel, chromium, manganese, copper, rhodium, ruthenium, and mixtures thereof; and
ii) calcining the transition metal sulfate-impregnated support at a temperature of less than 700° C. to form the catalyst.

In a second aspect, the invention refers to a sulfur-containing catalyst for the chirally selective synthesis of single-walled carbon nanotubes prepared by a method according to the first aspect.

In a third aspect, the invention refers to a sulfur-containing catalyst for the chirally selective synthesis of single-walled carbon nanotubes, the catalyst comprising sulfur-doped transition metal as active phase on a support, wherein the transition metal is selected from the group consisting of cobalt, iron, nickel, chromium, manganese, copper, rhodium, ruthenium, and mixtures thereof.

In a fourth aspect, the invention refers to a method of forming single-walled carbon nanotubes having a selected chirality. The method comprises:
a) reducing a catalyst according to the second aspect or the third aspect with a reducing agent; and
b) contacting a gaseous source of carbon with the catalyst to form the carbon nanotubes.

In a fifth aspect, the invention refers to single-walled carbon nanotubes formed by a method according to the fourth aspect.

### BRIEF DESCRIPTION OF THE DRAWINGS

Hereinafter, the present invention will be described more fully with reference to the accompanying drawings, in which exemplary embodiments of the invention are shown. This invention may, however, be embodied in many different forms and should not be construed as limited to the exemplary embodiments set forth herein. Rather, these embodiments are provided so that this disclosure will be thorough and complete, and will fully convey the scope of the invention to those skilled in the art. In the drawings, lengths and sizes of layers and regions may be exaggerated for clarity.

FIG. 1 are (A) temperature-programmed reduction (TPR) profiles; and (B) UV-vis-drs spectra of cobalt sulfate/silica (CoSO₄/SiO₂) catalysts uncalcined and calcined at different temperatures of 400° C., 450° C., 500° C., 600° C., 700° C., 800° C., 900° C., and CoSO₄.7H₂O, CoO, Co₃O₄ references.

FIG. 2 are (A) normalized Extended X-ray Absorption Fine Structure (EXAFS) spectra near Co K edge (E₀=7709 eV) recorded for CoSO₄/SiO₂ catalysts before calcining (uncalcined), and after calcining at different temperatures of 400° C., 600° C., 800° C. in air flow, and Co foil, Co₃O₄ and CoO references; and (B) EXAFS spectra in R space for CoSO₄/SiO₂ catalysts uncalcined and calcined at different temperatures of 400° C., 600° C., 800° C. along with Co₃O₄ and CoO references.

FIG. 3 depict photoluminescent (PLE) maps of SWCNTs grown on CoSO₄/SiO₂ catalysts (A) uncalcined, and calcined at different temperatures of (B) 400° C., (C) 450° C., (D) 500° C., (E) 600° C., (F) 700° C., (G) 800° C., and (H) 900° C. FIG. 3 suggests that SWCNTs grown on catalysts under different calcination temperatures may be shifted from the large diameter to small diameter SWCNTs. As seen from the figure, 400° C. is the optimal calcination temperature for CoSO₄/SiO₂ catalysts for growing the narrowest chirality distribution with good selectivity towards (9,8) nanotube.

FIG. 4 is a graph showing UV-vis-NIR spectra of SWCNTs grown on CoSO₄/SiO₂ catalysts (i) uncalcined, and calcined at different temperatures of (ii) 400° C., (iii) 450° C., (iv) 500° C., (v) 600° C., (vi) 700° C., (vii) 800° C., and (viii) 900° C.

FIG. 5 is Raman spectra of SWCNTs grown on CoSO₄/SiO₂ catalysts uncalcined and calcined at different temperatures. All spectra are normalized to the intensity of the G-band. (a) Radial Breathing Mode (RBM) peaks under 514 nm laser, (b) D-band and G-band under 514 nm laser, (c) RBM peaks under 785 nm laser, and (d) D-band and G-band under 785 nm laser.

FIG. 6 are graphs showing thermogravimetric analysis (TGA) and derivative weight loss (DTG) profiles of carbon deposits synthesized on the CoSO₄/SiO₂ catalysts calcined at three different temperatures. (a) 400° C., (b) 700° C. and (c) 900° C.

FIG. 7 depicts a calcination process scheme of the CoSO₄/SiO₂ catalyst at various temperatures.

FIG. 8 is a graph showing EA results of S content in catalysts uncalcined and calcined in air at different temperatures. Error bars represent the standard deviation.

FIG. 9 is (a,b) Raman spectra of SWCNTs under three excitation wavelengths for catalyst reduction at 540° C. and 780° C., respectively. The regions on the left between 100 cm⁻¹ and 350 cm⁻¹ correspond to Radial Breathing Mode (RBM) peaks, while the regions on the right correspond to D and G bands; (c,d) PL contour plots as a function of excitation and emission energies from SDBS-dispersed SWCNTs grown after catalyst reduction at 540° C. and 780° C., respectively. Major chiral tubes identified in PL are marked with their (n,m) indexes.

FIG. 10 is (a) Relative abundance of (n,m) SWCNTs produced from the CoSO₄/SiO₂ catalyst after catalyst reduction at 540° C. They are identified by the three characterization techniques. PL: dark grey, Raman: grey, and absorption: light grey; (b) Two-dimensional projected chirality map of SWCNTs. Most of (n,m) species produced in the work are at larger diameter around 1.17 nm, as compared to previous chiral selectivity synthesis studies usually around 0.76 nm.

FIG. 11 is (a) UV-vis-NIR absorbance spectra of dodecyl-benzenesulfonate (SDBS)-dispersed SWCNTs grown after catalyst reduction at 540° C. before and after baseline subtraction. (b) E^{S}₁₁ spectral reconstruction by the summation of the contribution from each (n,m) semiconducting SWCNT (Lorentzian peaks in black). (c) E^{M}₁₁ and E^{S}₂₂ spectral reconstruction by the summation of the contribution from both semiconducting (black) and metallic (grey) SWCNTs. The (n,m) indexes, thick solid line and red circles represent the same as in (b). (d) Relative abundance of both semiconducting (black) and metallic (grey) (n,m) SWCNTs obtained from the reconstruction of absorption spectra.

FIG. 12 are graphs showing TGA and DTG profiles of carbon deposits synthesized on the CoSO₄/SiO₂ catalyst. (a) Catalyst reduction at 540° C., and then SWCNT growth at 780° C., (b) reduction at 780° C. for 30 min, and then SWCNT growth. The total carbon yield is calculated from the weight loss between 200° C. and 1000° C.

FIG. 13 are SEM (a, d) and TEM (e, f) images of catalysts and SWCNTs. (a) fresh catalyst; (b) catalyst after reduction in H₂ at 540° C. and then cooled to room temperature under He; (c) as-synthesized SWCNTs on catalyst; and (d) SWCNT films after SiO₂ removal. The scale bars in (a, c) are 1 μm and 100 nm in (d). (e) Same sample as (b), and (f) same sample as (c). The scale bar in (e) denotes 10 nm, and (f) denotes 20 nm.

FIG. 14 are graphs showing physicochemical properties of the CoSO₄/SiO₂ catalyst. (a) X-ray diffraction pattern of the calcined CoSO₄/SiO₂ catalyst. (b) Nitrogen physisorption isotherms and pore size distribution (inset) of the catalyst. (c) UV-vis absorption spectra of the catalyst and several references (Co₃O₄, CoSO₄ powders, and fumed SiO₂). (d) H₂ temperature-programmed reduction profiles of the catalyst and several Co references (Co₃O₄, CoO, and CoSO₄).

FIG. 15 are XAS spectra of the CoSO₄/SiO₂ catalysts and model of Co clusters. (a) Near-edge spectra at the Co K-edge (E₀=7709 eV) of fresh catalyst, catalysts after reduction at 540° C. and SWCNT growth, and Co foil. (b) Fourier transform of EXAFS spectra at the Co K-edge for samples in (a). (c) Average diameter of Co metal clusters in catalysts determined by the first shell coordination number from X-ray absorption spectroscopy (XAS) spectra. (d) Optimized structures of Coₙ (n=13, 55, and 147) clusters from theoretical simulation and their likely matching carbon caps.

FIG. 16 are graphs showing sulfur content in CoSO₄/SiO₂ catalyst. (a) X-ray Absorption Near Edge Structure (XANES) spectra at the sulfur K-edge of fresh and treated catalysts at different reduction conditions. CoSO₄.7H₂O and CoS are references. Four samples include (1) fresh catalyst; (2) catalyst reduced in H₂ at 540° C., and then cooled to room temperature under He; (3) catalyst reduced in H₂ at 540° C., and then increased temperature to 700° C. under He before cooled to room temperature; and (4) catalyst reduced in H₂ at 700° C., and then cooled to room temperature under He. (b) Sulfur content in catalyst determined by element analysis and integrated sulfur peak area of XANES spectra. Four samples are the same as (a) and one more sample after reduction in H₂ at 780° C.

FIG. 17 is a graph showing optical transition energies versus radial breathing mode (RBM) frequencies for SWCNTs. RBM frequencies from peaks identified in Raman analysis of SWCNT samples (red dots) are plotted against theoretical and experimental transition energies. The three horizontal lines correspond to the laser excitation used for SWCNT characterization. The solid circles in navy color are E₁₁ and E₂₂ van Hove transitions of semiconducting SWCNTs from an empirical Kataura plot. The open and solid circles in black color are E₁₁ transitions of metallic SWCNTs, E₃₃ transitions of semiconducting SWCNTs, and other higher order transitions of SWCNTs from Kataura plots computed using a tight-binding model. RBM frequencies were calculated as (223.5 cm⁻¹/dₜ)+12.5 cm⁻¹, and diameters of SWCNTs were calculated assuming C—C bond length of 0.144 nm.

FIG. 18 is a graph showing transition energies versus nanotube diameter and RBM frequency. Expanded view of the Kataura plots show in FIG. 17 near to the laser energy at 514 nm. The dotted horizontal lines correspond to the upper and lower limits of the resonance window of approximate 100 meV. The vertical dashed lines around the experimental data points indicate ±4 cm⁻¹ variability in measurement of RBM frequencies because of different environments or instruments as suggested by previous researchers. Five RBM peaks are identified in our Raman analysis of SWCNT samples (FIG. 9 and FIG. 17) at 193 cm⁻¹, 213 cm⁻¹, 246 cm⁻¹, 293 cm⁻¹, and 312 cm⁻¹ respectively. The peak at 193 cm⁻¹ may be contributed by two types of chiral nanotubes: (16, 0) and (15, 2), as they are both close to the resonance window. Similarly, the peak at 213 cm⁻¹ is from (12, 3), and the peak at 246 cm⁻¹ is accredited to (11, 2) and (12, 0). There are no chiral nanotubes in the resonance windows of 293 cm⁻ and 312 cm⁻¹ peaks, we assign them to the nearest (10, 0) and (7, 3). FIG. 9A and FIG. 9B show that the peak at 213 cm⁻¹ is much more intense compared to other three peaks. The diameter of (12, 3) nanotube at 1.11 nm is similar to that of (9, 8) nanotube at 1.17 nm, which would be one of the main chiral nanotubes in our SWCNT samples.

FIG. 19 is a graph showing transition energies versus nanotube diameter and RBM frequency. Expanded view of the Kataura plots shown in FIG. 17 near to the laser energy at 633 nm.

FIG. 20 is a graph showing transition energies versus nanotube diameter and RBM frequency. Expanded view of the Kataura plots shown in FIG. 17 near to the laser energy at 785 nm.

FIG. 21 shows (a) typical transmission electron microscopy (TEM) images of as-synthesized SWCNTs. The scale bar in the left and right figure denotes 20 nm and 10 nm respectively; (b) the diameter distribution of nanotubes obtained by measuring about 100 nanotubes in TEM images.

FIG. 22 shows (a) atomic force microscopy (AFM) image SWCNTs drop-casted on mica surface. (b) The height profile of nanotubes along the red line shown in (a).

FIG. 23 is Raman spectra of SWCNTs grown from catalysts calcined at different conditions marked on the right side of figures under excitation of (a) 514 nm laser; (b) 785 nm laser. Region on the left of each graph between 100 and 350 cm⁻¹ correspond to RBM peaks, while the region on the right corresponds to D and G bands.

FIG. 24 shows PL contour plots as a function of excitation and emission energies of SDBS-dispersed SWCNTs grown from catalysts calcined at different conditions. (a) uncalcined, (b) 400° C., (c) 500° C., (d) 600° C., (e) 700° C., and (f) 800° C. Major chiral species identified in PL are marked with their (n,m) indices.

FIG. 25 is (a) graph showing change of relative abundance of semiconducting (n,m) tubes at different catalyst calcination temperatures. The relative abundance is calculated from the intensity of PL peaks of various (n,m) species; (b) chiral map of (n,m) species identified in PL plots. The few major species shown in (a) are highlighted in different colors.

FIG. 26 is a graph showing UV-vis-NIR absorption spectra of SDBS-dispersed SWCNTs grown from catalysts calcined at different conditions. The label E^{S}₁₁ (shaded purple from λ=910 nm to 1600 nm) marks the excitonic optical absorption bands for semiconducting SWCNTs corresponding to the first one-dimensional van Hove singularities; the E^{S}₂₂ and E₁₁ (shaded yellow from λ=500 nm to 910 nm) correspond to the overlapping absorption bands of the first van Hove singularities from metallic SWCNTs and the second van Hove singularities from semiconducting SWCNTs. All spectra were normalized at 1420 nm for easy comparison.

FIG. 27 are graphs showing TG and DTG profiles of carbon deposits grown on the CoSO₄/SiO₂ catalysts (with about 1 wt % Co) calcined at three different temperatures of (a) 400° C., (b) 700° C., and (c) 900° C.

FIG. 28 (a) to (b), and (d) to (f) depict TEM images of SWCNTs and other carbon species grown from the CoSO₄/SiO₂ catalyst, where (a-b) the catalyst calcined at 400° C.; (d-f) the catalyst calcined at 800° C. (c) AFM image of purified SWCNTs deposited on silicon wafer and the height profile of nanotubes along the red line. The scale bar in (a) denotes 20 nm, (b) denotes 10 nm, (d) denotes 20 nm, (e) denotes 10 nm, and (f) denotes 10 nm.

FIG. 29 is a graph showing H₂-temperature programmed reduction profiles of the CoSO₄/SiO₂ catalyst calcined at different conditions and several Co references (Co₃O₄, CoO, CoSO₄.7H₂O and CoSiO₃).

FIGS. 30A and B are XAS spectra of CoSO₄/SiO₂ catalysts calcined at different conditions and several references (CoSO₄.7H₂O, CoSiO₃, CoO, Co₃O₄ and Co foil). (A) XANES spectra near the Co K-edge. The inset shows the enlarged spectra near the Co K-edge. (B) Fourier transforms of EXAFS spectra in r-space at the Co K-edge for samples in (A).

FIG. 31 is a graph showing weight fraction of sulfur in CoSO₄/SiO₂ catalysts calcined at different temperatures and after reduction in H₂ at 540° C. during SWCNT growth.

FIG. 32 is XANES spectra at the S K-edge of the CoSO₄/SiO₂ catalysts calcined at different conditions and the reference (CoSO₄.7H₂O). The spectra are shifted in Y-axis direction for easy comparison.

FIG. 33 is a schematic diagram depicting catalyst transitions at different calcination temperatures. Silica particles are around 20 nm in diameter, thus a curved surface is used to represent the surface of silica particles.

FIG. 34A to F are PL maps of SDBS-dispersed SWCNTs grown on undoped and S doped Co/SiO₂ catalysts for (A) CoACAC/SiO₂; (B) CoCl/SiO₂, (C) CoN/SiO₂, (D) CoACAC/SiO₂/S, (E) CoCl/SiO₂/S, and (F) CoN/SiO₂/S. Some major (n,m) species identified on PL maps are marked. FIGS. 34 G and H are UV-vis-NIR absorption spectra for CoACAC/SiO₂, CoCl/SiO₂, and CoN/SiO₂ on (G) undoped and (H) S doped Co/SiO₂ catalysts. The shaded pink (910 nm to 1600 nm) indicates the E^{S}₁₁ absorption band and the shaded blue (550 nm to 910 nm) shows the overlapping E^{S}₂₂ and E^{M}₁₁ bands.

FIG. 35A to D are Raman spectra of SWCNTs grown on (A) undoped Co/SiO₂ catalyst under 785 nm laser excitation; (B) S doped Co/SiO₂ catalyst under 785 nm laser excitation; (C) undoped Co/SiO₂ catalysts 514 nm laser excitation; and (D) S doped Co/SiO₂ catalyst under 514 nm laser excitations respectively. The regions on the left correspond to RBM peaks, while the regions on the right correspond to D and G bands.

FIG. 36A to D are H₂-TPR profiles of undoped and S doped Co/SiO₂ catalysts and several Co references (CoO, Co₃O₄, CoSiO₃, CoCl₂ and CoSO₄.7H₂O).

FIGS. 37A and B are UV-vis diffuse reflectance spectra of (A) Co/SiO₂ catalysts and references (Co₃O₄, CoO and CoSiO₃), and (B) S doped Co/SiO₂ catalysts as well as the references CoCl and CoSO₄.

FIG. 38 is a schematic illustration of changes in Co species on Co/SiO₂ catalysts caused by S doping.

FIGS. 39A and B are TEM images of SWCNTs and catalyst particles. The scale bar in the figures denotes a length of 20 nm.

FIG. 40 is a PL map of SDBS-dispersed SWCNTs grown on the CoN/SiO₂/AS catalyst.

FIG. 41 is a graph showing UV-vis-NIR absorption spectra of SDBS-dispersed SWCNTs grown on CoN/SiO₂/AS.

FIG. 42 is a graph showing H₂-TPR profile of the CoN/SiO₂/AS catalyst.

FIG. 43 is a graph showing UV-vis diffuse reflectance spectrum of CoN/SiO₂/AS.

FIG. 44 is a graph showing nitrogen physisorption of purified SWCNTs. The inserts show the pore size of micropores and mesopores determined by the Horvath-Kawazoe (HK) and Barrett, Joyner, and Halenda (BJH) method respectively.

FIG. 45 are scanning electron microscopy images of the CoSO₄/SiO₂ catalysts calcined at (A) 400° C.; and (B) 900° C. The scale bar in (A) and (B) denotes a length of 1 μm.

FIG. 46 is a graph showing X-ray diffraction patterns of the CoSO₄/SiO₂ catalyst calcined at different conditions. CoSO₄.7H₂O is a reference.

FIG. 47 is a graph showing nitrogen physisorption isotherms and pore size distributions (insert) of the CoSO₄/SiO₂ catalyst calcined at 400° C. and 800° C.

FIG. 48 is a graph showing UV-vis diffuse reflectance spectra of the CoSO₄/SiO₂ catalyst calcined at different conditions and references (Co₃O₄, CoO, CoSO₄, CoSiO₃ and fumed SiO₂).

### DETAILED DESCRIPTION

Advantageously, methods of the invention allow synthesis of single-walled carbon nanotubes in a chirally selective manner. Carbon nanotubes having large diameters as characterized by their chiral index may be selectively formed. Sulfur present on the catalyst may serve to limit aggregation of transition metal atoms and/or to limit formation of transition metal-S compounds. In embodiments where sulfate ions are used as the sulfur source, presence of S═O bonds in sulfate ions serve to stabilize the large sulfur-doped transition metal nanoparticles, that in turn lead to the large diameter carbon nanotubes. In particular, using methods of the invention, it has been demonstrated that the carbon nanotubes formed have a mean diameter of 1.17 nm with 51.7% abundance among semiconducting tubes, and 33.5% abundance among all nanotube species.

The invention refers accordingly in a first aspect to a method of preparing a sulfur-containing catalyst for the chirally selective synthesis of single-walled carbon nanotubes.

The terms “carbon nanotube” and “nanotube” are used interchangeably throughout the entire disclosure, and refer to a cylindrical single- or multi-walled structure in which the at least one wall of the structure is predominantly made up of carbon. Carbon nanotubes may exist in different forms, such as single-walled carbon nanotubes (SWNT), double-walled carbon nanotubes (DWNT), multi-walled carbon nanotubes (MWNT), or modified multi-walled carbon nanotubes.

A single-walled carbon nanotube refers generally to a seamless cylinder formed from one graphite layer. For example, carbon nanotubes may be described as a graphite plane (so called graphene) sheet rolled into a hollow cylindrical shape so that the structure is one-dimensional with axial symmetry, and in general exhibiting a spiral conformation, called chirality.

A single-walled carbon nanotube may be defined by a cylindrical sheet with a diameter in the range from about 0.7 nm to about 20 nm, such as about 1 nm to about 20 nm, about 5 nm to about 20 nm, about 10 nm to about 20 nm, about 1 nm to about 10 nm, about 1 nm to about 5 nm, about 0.5 nm to about 1.5 nm, or about 1 nm to about 2 nm.

The single-walled carbon nanotubes formed may be of any suitable length, such as in the range from about 0.1 nm to about 10 μm, about 0.1 nm to about 5 μm, about 1 nm to about 5 μm, about 10 nm to about 5 μm, about 10 nm to about 1 μm, about 1 μm to about 5 μm, about 3 μm to about 8 μm, or about 2 μm to about 5 μm. In various embodiments, the carbon nanotubes may be at least 1 μm, at least 2 μm, between about 0.5 μm and about 1.5 gm, or between about 1 μm and about 5 μm. Atomic Force Microscopy (AFM) and/or Raman Scattering Spectroscopy may for instance be used to determine the dimensions of single-walled carbon nanotubes.

As mentioned above, carbon nanotubes may form a one-dimensional structure with axial symmetry and exhibit a spiral conformation called chirality. The chirality of the carbon hexagon rings may depend on the arrangement of the carbon hexagon rings along the surface of the nanotubes.

The arrangement of the carbon hexagon rings may be characterized by the chiral vector of the carbon nanotubes. Chiral vector is a two dimensional vector (n,m) that may be used to describe the geometry of carbon nanotubes. The values of n and m determine the chirality, or “twist” of the nanotube. For example, nanotubes with indices (m, 0) are termed “zig-zag” due to shape of the atomic configuration along the perimeter of the nanotubes. When m=n, the resulting nanotubes are termed “armchair” because of the position of the carbon atoms which are arranged in an “armchair” pattern.

The chirality in turn affects properties such as electronic and mechanical characteristics, such as conductance, density, and lattice structure of the carbon nanotubes. Depending on the arrangement of the carbon hexagon rings along the surface of the nanotube as characterized by its chiral vector, carbon nanotubes may be metallic or semiconducting.

For example, SWNTs may be metallic when n−m=3r, where r is an integer such as 0, 1, 2, 3, 4, 5, and so on, and may be semiconducting otherwise. Metallic SWNTs refer to carbon nanotubes with non-zero density of states (DOS) at its Fermi level. The term “density of states” refers to the number of states at an energy level that are available to be occupied, and the term “Fermi level” refers to an energy level with a probability of 50 percent for existence of an electron. Therefore, a SWNT may be metallic when the DOS value at its Fermi level is not zero. Semiconducting SWNTs refer to carbon nanotubes with varying band gaps, wherein the term “band gap” refers to difference in energy between the valance band and the conduction band of a material.

Chirality of the carbon nanotubes may in turn be governed by the diameter of the catalysts from which the nanotubes are grown. Diameter (d) of carbon nanotubes in nanometers may be expressed as a function of the n and m indexes, using the equation d=a[n²+m²+nm]^{1/2}, where a=0.0783. From this equation, it may be seen that a very small change in the nanotube diameter, may result in change in chirality of the nanotube, which in turn leads to a significant effect on electronic character of the nanotube. By using a sulfur-containing catalyst prepared by methods of the first aspect, single-walled carbon nanotubes having a specific or selected chirality may be synthesized.

The method to prepare the sulfur-containing catalyst includes providing a transition metal-containing support, wherein the transition metal is selected from the group consisting of cobalt, iron, nickel, chromium, manganese, copper, rhodium, ruthenium, and mixtures thereof.

One or more of the above-mentioned transition metals may be present on the transition metal-containing support. The transition metal may be present on the support in the form of particles or nanoparticles. Of the transition metals, it has been found that iron, cobalt, and nickel, which are from Groups 8 to 10 of the Periodic Table of Elements and similar in size, are particularly suitable for forming single-walled carbon nanotubes having large diameters as characterized by a chiral index of (9,8). Accordingly, in various embodiments, the transition metal is selected from the group consisting of cobalt, nickel, iron, and mixtures thereof. The transition metal may comprise or consist essentially of cobalt. In various embodiments, the transition metal consists of cobalt.

The transition metal-containing support may be provided by impregnating a support with a solution comprising transition metal to form an impregnated support, and calcining the impregnated support at a temperature of less than 700° C. to form the transition metal-containing support.

The concentration of transition metal in the solution may be any suitable amount to render the amount of transition metal in the catalyst in the range from about 0.1 wt % to about 30 wt %. The amount of transition metal in the catalyst may also be termed as the loading level of the catalyst. In various embodiments, the loading level or the amount of transition metal in the catalyst is in the range from about 0.1 wt % to about 30 wt %, such as about 0.1 wt % to about 20 wt %, about 0.1 wt % to about 15 wt %, about 0.1 wt % to about 10 wt %, about 0.1 wt % to about 5 wt %, about 0.1 wt % to about 3 wt %, about 1 wt % to about 30 wt %, about 1 wt % to about 20 wt %, about 1 wt % to about 15 wt %, about 1 wt % to about 10 wt %, about 1 wt % to about 8 wt %, about 1 wt % to about 5 wt %, about 3 wt % to about 8 wt %, about 5 wt % to about 30 wt %, about 5 wt % to about 20 wt %, about 5 wt % to about 10 wt %, about 5 wt % to about 8 wt %, about 10 wt % to about 30 wt %, about 10 wt % to about 20 wt %, or about 30 wt %, about 20 wt %, about 10 wt %, about 5 wt %, about 4 wt %, about 3 wt %, about 2 wt %, or about 1 wt %. Generally, the chiral selectivity of single-walled carbon nanotubes is higher at a lower transition metal loading level, such as about 0.1 wt % to about 10 wt % on the catalyst, or about 0.1 wt % to about 5 wt %, or about 0.5 wt % to about 3 wt % on the catalyst. In various embodiments, the amount of transition metal in the catalyst is about 1 wt %.

The solution comprising transition metal may be an aqueous solution having dissolved therein a salt of the transition metal. For example, the solution comprising transition metal may be an aqueous solution having dissolved therein a salt of cobalt, iron, nickel, chromium, manganese, copper, rhodium and/or ruthenium. In various embodiments, the solution comprising transition metal is an aqueous solution having dissolved therein a salt of cobalt, iron and/or nickel. In further embodiments, the solution comprising transition metal is an aqueous solution having dissolved therein a salt of cobalt.

The salt may be completely or at least substantially dissolved in the aqueous solution. Generally, any salt of a transition metal that is able to dissolve in an aqueous solution may be used. In various embodiments, the salt of the transition metal is selected from the group consisting of an acetylacetonate salt, a halide salt, a nitrate salt, a phosphate salt, a carbonate salt, and mixtures thereof. In some embodiments, the salt of the transition metal is an acetylacetonate salt, a halide salt, a nitrate salt, or mixtures thereof. For example, in embodiments wherein the transition metal is cobalt, the solution comprising transition metal may be a solution comprising cobalt, provided by a solution comprising a salt selected from the group consisting of cobalt acetylacetonate, cobalt chloride, cobalt nitrate, or mixtures thereof.

A support is used as a base upon which the transition metal is dispersed upon. The transition metal may be incorporated into the support by impregnating with a solution comprising the transition metal to form a transition metal-containing support. Generally, the support is porous to provide a greater surface area upon which the sulfur-doped transition metal, which acts as active phase for carbon nanotube growth, may be dispersed. The surface area of the support may range from about 100 m²g⁻¹ to about 1000 m²g⁻¹, such as about 100 m²g⁻¹ to about 800 m² g⁻¹, about 100 m² g⁻¹ to about 600 m²g⁻¹, about 100 m² g⁻¹ to about 400 m²g⁻¹, about 200 m²g⁻¹ to about 500 m²g⁻¹, about 200 m²g⁻¹ to about 400 m² about 400 m²g⁻¹, about 300 m²g⁻¹, or about 200 m²g⁻¹. In various embodiments, the support is selected from the group consisting of silica, alumina, magnesia, silica-alumina, zeolite, and mixtures thereof. For example, the support may comprise or consist essentially of silica.

Porosity of the support may be characterized by the size of the pores. According to the definition of the International Union of Pure and Applied Chemistry (IUPAC), the term “mesopore/mesoporous” refers to pore size in the range of 2 nm to 50 nm; while a pore size below 2 nm is termed a micropore range, and a pore size that is greater than 50 nm is termed a macropore range. In various embodiments, the support comprises or consists essentially of mesopores.

As mentioned above, providing the transition metal-containing support may include impregnating the support with the solution comprising transition metal to form an impregnated support. As used herein, the term “impregnate” refers to introduction of a solution into a porous material. This may take place, for example, by soaking or immersing the support into a solution such that the solution infiltrates into the pores of the support. In various embodiments, the solution is introduced into the pores of the support by capillary action.

The impregnation process is usually carried out at ambient temperature and conditions. The term “ambient temperature” as used herein refers to a temperature of between about 20° C. to about 40° C. The time required for impregnation may vary depending, for example, on the type of support used, the concentration of the impregnating solution, and the temperature at which impregnation is carried out.

Generally, impregnating the support may take place for a time period ranging from a few hours to a few days, such as about 1 hour to about 48 hours, about 1 hour to about 24 hours, about 1 hour to about 12 hours, about 1 hour to about 5 hours, about 1 hour to about 3 hours, about 3 hours to about 20 hours, about 3 hours to about 10 hours, about 3 hours to about 5 hours, about 5 hours to about 18 hours, about 12 hours to about 24 hours, about 3 hours, about 2 hours, or about 1 hour. In various embodiments, the support is allowed to age at room temperature for a few hours to allow a more uniform impregnation of the solution into the support.

A higher concentration of impregnating solution may require a longer impregnation time due to higher viscosity of the solution, thereby requiring a greater time for infiltration of the support into the pores of the support. The temperature at which impregnation is carried out may also affect the impregnation time, with a higher temperature generally having a shorter impregnation time.

Following impregnation, the impregnated support may be calcined at a temperature of less than 700° C. to form a transition metal-containing support. Calcination is normally carried out in furnaces or reactors (sometimes referred to as kilns) of various designs including shaft furnaces, rotary kilns, multiple hearth furnaces, and fluidized bed reactors. By the phrase “a temperature of less than 700° C.”, it is meant that the impregnated support is subjected to a furnace, kiln or reactor temperature of less than 700° C. In various embodiments, the temperature on the impregnated support is the same as or is lower than the temperature in the furnace, kiln or reactor. The calcination may be carried out under air flow. Following impregnation of the support with the solution comprising transition metal, calcination allows formation of oxidized forms of transition metal on the support.

Advantageously, it has been found by the inventor that chirally selective synthesis of single-walled carbon nanotubes may be performed by varying catalyst calcination temperatures. When catalyst is uncalcined or calcined at a lower temperature of 400° C. for example, the sulfur-containing catalyst formed demonstrated good selectivity towards larger diameter single-walled nanotubes when they are used to form the single-walled carbon nanotubes. In particular, it has been found that nanotubes having a chiral index of (9,8) form the dominating species. With an increase in calcination temperature, the chirality of SWCNTs may be shifted from large diameter tubes to small diameter tubes. Therefore, accordingly, calcination temperature may be used to affect size of the single-walled carbon nanotubes formed, and to result in formation of single-walled carbon nanotubes having a selected chirality.

As mentioned above, calcining of the impregnated support may be carried out at a temperature of less than 700° C. For example, calcining of the impregnated support may be carried out at a temperature of about 200° C. to about 700° C., about 300° C. to about 700° C., about 300° C. to about 500° C., about 400° C. to about 550° C., about 500° C., about 400° C., or about 300° C. In various embodiments, calcining the impregnated support comprises heating the impregnated support at a temperature in the range from about 300° C. to about 700° C. In some embodiments, calcining comprises heating the impregnated support at a temperature of about 400° C.

Calcination may be carried out for a time period ranging from 30 minutes to several hours, for example, 30 minutes, 1 hour, 2 hours, 3 hours or 4 hours. In various embodiments, the impregnated support is calcined for about 1 hour.

Following calcination, the transition metal-containing support is impregnated with a solution comprising sulfur to form a sulfur-doped transition metal-containing support. In various embodiments, the solution comprising sulfur comprises sulfate ions. In some embodiments, the solution comprising sulfate ions is an aqueous solution, and the sulfate ions are provided by an acid or salt selected from the group consisting of sulfuric acid, sulfurous acid, ammonium sulfate, ammonium bisulfate, and mixtures thereof. For example, the solution comprising sulfur may comprise or consist essentially of sulfuric acid.

In embodiments wherein the solution comprising sulfur comprises sulfate ions, concentration of sulfate ions in the solution may be in the range from about 0.01 mol/L to about 5 mol/L, such as about 0.01 mol/L to about 3 mol/L, about 0.01 mol/L to about 2 mol/L, about 0.01 mol/L to about 1 mol/L, about 0.01 mol/L to about 0.05 mol/L, about 0.1 mol/L to about 5 mol/L, about 0.1 mol/L to about 3 mol/L, about 0.1 mol/L to about 2 mol/L, or about 0.1 mol/L to about 1 mol/L. In various embodiments, the concentration of sulfate ions in the solution is about 0.04 mol/L.

The method of the first aspect includes calcining the sulfur-doped transition metal-containing support at a temperature of less than 700° C. to form the catalyst. Calcination conditions similar to that mentioned above for calcining impregnated support may be used. For example, calcining of the sulfur-doped transition metal-containing support may be carried out at a temperature of less than 700° C., such as about 200° C. to about 700° C., about 300° C. to about 700° C., about 300° C. to about 500° C., about 400° C. to about 550° C., about 500° C., about 400° C., or about 300° C. In various embodiments, calcining the sulfur-doped transition metal-containing support comprises heating the sulfur-doped transition metal-containing support at a temperature in the range from about 300° C. to about 700° C. In some embodiments, calcining comprises heating the sulfur-doped transition metal-containing support at a temperature of about 400° C.

In various embodiments, either of or both the impregnated support and the sulfur-doped transition metal-containing support are dried following their respective impregnation step prior to calcining. The drying may be carried out so as to remove water from the support. In doing so, shattering or destruction of the support due to rapid vaporization of water in the pores of the support at the higher calcination temperatures may be prevented. Similar drying conditions may be used for both the impregnated support and the sulfur-doped transition metal-containing support.

Generally, the drying temperature may be set at any suitable temperature that allows water to be driven off from the supports. The temperature used for drying the impregnated support and the sulfur-doped transition metal-containing support may be the same or different. In various embodiments, drying comprises heating the support at a temperature in the range from about 80° C. to about 120° C., such as about 90° C. to about 110° C., about 95° C. to about 100° C., or about 100° C. In various embodiments, drying comprises heating the support at a temperature of about 100° C.

Besides using a two-tier process as mentioned above, in which transition metal and sulfur are added separately in the form of two separate solutions to form the catalyst, the method of the first aspect also relates to a method to prepare a sulfur-containing catalyst in which a solution comprising a sulfate salt of a transition metal is used to impregnate the support. In doing so, only a single impregnation and calcination procedure is required. Examples of transition metal that may be used have already been described above.

Accordingly, when cobalt sulfate is used, for example, the method of the first aspect includes impregnating a support with a solution comprising cobalt sulfate to form a cobalt sulfate-impregnated support. The support may be impregnated with the solution comprising a sulfate salt of a transition metal under conditions similar to that detailed above for impregnating the support with a solution comprising transition metal. Following impregnation, the transition metal sulfate-impregnated support may be calcined at a temperature of less than 700° C. to form the catalyst. The transition metal sulfate-impregnated support may be calcined using conditions similar to that as mentioned above.

The invention refers in a further aspect to a sulfur-containing catalyst for the chirally selective synthesis of single-walled carbon nanotubes prepared by a method according to the first aspect. In a third aspect, the invention relates to a sulfur-containing catalyst for the chirally selective synthesis of single-walled carbon nanotubes, the catalyst comprising sulfur-doped transition metal as active phase on the support, wherein the transition metal is selected from the group consisting of cobalt, iron, nickel, chromium, manganese, copper, rhodium, ruthenium, and mixtures thereof.

As mentioned above, it has been found that iron, cobalt, and nickel have a similar size range, and are particularly suitable for forming single-walled carbon nanotubes having large diameters, such as single-walled carbon nanotubes characterized by a chiral index of (9,8). In various embodiments, the transition metal is selected from the group consisting of cobalt, nickel, iron, and mixtures thereof. The transition metal may comprise or consist essentially of cobalt. In various embodiments, the transition metal consists of cobalt.

The amount of transition metal in the catalyst may be in the range from about 0.1 wt % to about 30 wt %, such as about 0.1 wt % to about 20 wt %, about 0.1 wt % to about 15 wt %, about 0.1 wt % to about 10 wt %, about 0.1 wt % to about 8 wt %, about 0.1 wt % to about 5 wt %, about 0.1 wt % to about 3 wt %, about 1 wt % to about 30 wt %, about 1 wt % to about 20 wt %, about 1 wt % to about 15 wt %, about 1 wt % to about 10 wt %, about 1 wt % to about 8 wt %, about 1 wt % to about 5 wt %, about 3 wt % to about 8 wt %, about 5 wt % to about 30 wt %, about 5 wt % to about 20 wt %, about 5 wt % to about 10 wt %, about 5 wt % to about 8 wt %, about 10 wt % to about 30 wt %, about 10 wt % to about 20 wt %, or about 30 wt %, about 20 wt %, about 10 wt %, about 5 wt %, about 4 wt %, about 3 wt %, about 2 wt %, or about 1 wt %. Generally, the chiral selectivity of single-walled carbon nanotubes is higher at a lower transition metal loading level, such as about 0.1 wt % to about 10 wt % on the catalyst, or about 0.1 wt % to about 5 wt %, or about 0.5 wt % to about 3 wt % on the catalyst. In various embodiments, the amount of transition metal in the catalyst is about 1 wt %.

The sulfur content in the sulfur-doped transition metal may be in the range from about 0.1 wt % to about 30 wt %, such as about 0.1 wt % to about 20 wt %, about 0.1 wt % to about 15 wt %, about 0.1 wt % to about 10 wt %, about 0.1 wt % to about 5 wt %, about 0.1 wt % to about 2 wt %, about 0.1 wt % to about 1 wt %, about 0.5 wt % to about 2 wt %, about 0.5 wt % to about 15 wt %, about 1 wt % to about 30 wt %, about 1 wt % to about 20 wt %, about 1 wt % to about 15 wt %, about 1 wt % to about 10 wt %, about 1 wt % to about 5 wt %, about 1 wt % to about 3 wt %, about 1 wt % to about 2 wt %, about 5 wt % to about 30 wt %, about 5 wt % to about 20 wt %, about 5 wt % to about 15 wt %, about 5 wt % to about 10 wt %, about 10 wt % to about 30 wt %, about 10 wt % to about 20 wt %, about 10 wt % to about 15 wt %, about 15 wt % to about 30 wt %, about 15 wt % to about 20 wt %, about 20 wt % to about 30 wt %, about 20 wt %, about 15 wt %, about 10 wt %, about 5 wt %, about 3 wt %, about 2 wt %, or about 1 wt %. In various embodiments, the sulfur-doped transition metal has a sulfur content in the range from about 0.5 wt % to about 1.5 wt %. In embodiments in which the transition metal consists essentially of cobalt, the sulfur-doped cobalt comprises or consists essentially of cobalt sulfate.

In various embodiments, the sulfur-doped transition metal may be present in the form of particles or nanoparticles, and may be grafted on the support or within the pores of a porous support. Suitable supports that may be used have already been mentioned herein. In various embodiments, the support comprises or consists essentially of silica.

Size of the sulfur-doped transition metal active phase on the support may be varied to affect the size of single-walled carbon nanotubes formed, and/or to achieve chiral selective synthesis of single-walled carbon nanotubes. For example, size of the selected chirality of single-walled carbon nanotubes formed may be similar to the size of the sulfur-doped transition metal nanoparticles that are present on the support. As mentioned above, of the transition metals, it has been found that iron, cobalt, and nickel are similar in size and are particularly suitable for forming single-walled carbon nanotubes having large diameters. As an example, sulfur-doped cobalt nanoparticles, which are present as active phase on the support, are used to form single-walled carbon nanotubes having a chiral index of (9,8).

The size of the sulfur-doped transition metal active phase may be characterized by their mean maximal dimension. The term “maximal dimension” as used herein refers to the maximal length of a straight line segment passing through the center of a figure and terminating at the periphery. The term “mean maximal dimension” refers to an average maximal dimension of the nanoparticles, and may be calculated by dividing the sum of the maximal dimension of each nanoparticle by the total number of nanoparticles.

The mean maximal dimension of the sulfur-doped transition metal active phase, which may be present as nanoparticles on the support, may be in the range from about 1 nm to about 1.5 nm, such as about 1 nm to about 1.25 nm, about 1.25 nm to about 1.5 nm, about 1.2 nm to about 1.3 nm, or about 1.25 nm. In various embodiments, the mean maximal dimension of the sulfur-doped transition metal on the support is about 1.25 nm. In various embodiments, the sulfur-doped transition metal nanoparticles are essentially monodisperse.

The catalyst according to the second aspect and the third aspect may be used to form single-walled carbon nanotubes having a selected chirality. Accordingly, in a fourth aspect, the invention relates to a method of forming single-walled carbon nanotubes having a selected chirality.

The method includes reducing a catalyst according to the second aspect or the third aspect with a reducing agent. By contacting the catalyst with the reducing agent, the sulfur-doped transition metal particles that are present in the catalyst may be converted into a reduced form.

In various embodiments, reduction carried out by contacting the catalyst with a reducing agent such as hydrogen, an amine, ammonia, diborane, sulphur dioxide, hydrazine, including a flowing reducing gas such as flowing hydrogen gas. In various embodiments, the reducing agent comprises or consists essentially of hydrogen gas.

Reducing the catalyst may be carried out at any suitable temperature and conditions, which may be dependent on the type of reducing agent used. Generally, reducing the catalyst is carried out at a temperature in the range from about 300° C. to about 550° C., such as about 300° C. to about 400° C., about 300° C. to about 350° C., about 400° C. to about 550° C., about 450° C. to about 550° C., about 500° C., about 400° C., or about 300° C.

Following reduction, the method according to the fourth aspect may include purging the catalyst with an inert gas prior to contacting the gaseous source of carbon with the catalyst. In various embodiments, the inert gas is selected from the group consisting of argon, helium, neon, krypton, xenon, nitrogen, and mixtures thereof. In some embodiments, the inert gas comprises or consists essentially of argon.

Purging of the catalyst with the inert gas may be carried out at any suitable temperature. For example, purging the catalyst may be carried out at a temperature in the rage from about 500° C. to about 800° C., such as about 500° C. to about 700° C., about 500° C. to about 600° C., about 600° C. to about 800° C., about 550° C. to about 750° C., about 800° C., about 700° C., about 600° C., or about 500° C.

The gaseous source of carbon may include a carbon source gas, such as carbon monoxide, methane, ethane, propane, butane, ethylene, propylene, acetylene, octane, benzene, naphthalene, toluene, xylene, mixtures of C₁-C₂₀ hydrocarbons, an organic alcohol, e.g. methanol, ethanol, n-propanol, isopropanol, n-butanol, isobutanol, neobutanol or tert-butanol, or any other suitable material, typically in gaseous form, that is efficacious in contact with the sulfur-containing catalyst under the process conditions suitable for growing carbon nanotubes. In various embodiments, the gaseous source of carbon is selected from the group consisting of carbon monoxide, methane, methanol, ethanol, acetylene, and mixtures thereof. In some embodiments, the gaseous source of carbon comprises or consists essentially of carbon monoxide. An inert gas such as argon may optionally be mixed with the gaseous source of carbon before contacting the catalyst.

Contacting the gaseous source of carbon with the sulfur-containing catalyst may be carried out using any suitable conditions to grow carbon nanotubes. For example, a continuous, batch, semi-batch, or other mode of processing appropriate to the specific implementation of the manufacturing operation may be employed. Contacting may, for example, be carried out in a reactor operated as a fluidized bed reactor, through which the gaseous source of carbon is flowed as the fluidizing medium. The carbon-containing gas may for example be fed into a reactor cell having catalytic particles of the sulfur-containing catalyst disposed therein.

Generally, the gaseous source of carbon is applied at a pressure or is contacted with the catalyst at a pressure in the range from about 1 bar to about 10 bar, such as about 1 bar to about 8 bar, about 1 bar to about 6 bar, about 2 bar to about 8 bar, about 3 bar to about 8 bar, about 4 bar to about 10 bar, about 5 bar to about 8 bar, about 8 bar, about 6 bar, about 4 bar, or about 2 bar. In various embodiments, the gaseous source of carbon is contacted with the catalyst at a pressure of about 6 bar.

The time required to form the carbon nanotubes may range from about 1 minute to about 4 hours, such as from about 10 minutes to about 3 hours, about 20 minutes to about 2 hours, about 30 minutes to about 1 hour, about 1 hour to about 2 hours, about 3 hours, about 2 hours, about 1 hour, or about 30 minutes. In various embodiments, the time required to form the carbon nanotubes is about 1 hour.

Using methods of the fourth aspect, majority of the single-walled carbon nanotubes thus formed have diameters within a predetermined range. Generally, the formed carbon nanotubes have a narrow diameter distribution. The narrow diameter distribution may be characterized by the chiral indices.

In various embodiments, at least 50% of the single-walled carbon nanotubes formed have the chiral indices (9,8), (9,7), (10,6), and (10,9), such as at least 55%, at least 60% or at least 70%. Of these, single-walled carbon nanotubes having a chiral index of (9,8) may be the dominating species. In various embodiments, at least 30% of the single-walled carbon nanotubes formed have the chiral index (9,8), such as at least 32%, at least 35%, at least 38%, or at least 40%. In some embodiments, at least 40% of the carbon nanotubes formed have the chiral index (9,8).

In a further aspect, the invention relates to single-walled carbon nanotubes formed by a method according to the fourth aspect. The single-walled carbon nanotubes having a selected chirality formed using a method of the invention, may be used as electrode material for forming an electrode. The electrodes formed using these chirally selective SWNTs may be used for batteries, such as metal-air batteries. Examples for metal-air batteries include a lithium, aluminium, carbon, zinc-air battery in which at least one electrode is made of carbon. They may also be used for fuel cells. In case they are used in fuel cells, catalytic noble metal materials in particulate form may be added to the electrode.

Apart from the applications mentioned above, the single-walled carbon nanotube formed using a method of the invention may also be used as an optical or an optoelectronic device, such as transistors, memory devices and optoelectronic couplers.

It will be understood that when an element or layer is referred to as being “on” another element or layer, the element or layer can be directly on another element or layer or intervening elements or layers. In contrast, when an element is referred to as being “directly on” another element or layer, there are no intervening elements or layers present. Like numbers refer to like elements throughout. As used herein, the term “and/or” includes any and all combinations of one or more of the associated listed items.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

The invention illustratively described herein may suitably be practiced in the absence of any element or elements, limitation or limitations, not specifically disclosed herein. Thus, for example, the terms “comprising”, “including”, “containing”, etc. shall be read expansively and without limitation. Additionally, the terms and expressions employed herein have been used as terms of description and not of limitation, and there is no intention in the use of such terms and expressions of excluding any equivalents of the features shown and described or portions thereof, but it is recognized that various modifications are possible within the scope of the invention claimed. Thus, it should be understood that although the present invention has been specifically disclosed by preferred embodiments and optional features, modification and variation of the inventions embodied therein herein disclosed may be resorted to by those skilled in the art, and that such modifications and variations are considered to be within the scope of this invention.

The invention has been described broadly and generically herein. Each of the narrower species and subgeneric groupings falling within the generic disclosure also form part of the invention. This includes the generic description of the invention with a proviso or negative limitation removing any subject matter from the genus, regardless of whether or not the excised material is specifically recited herein.

Other embodiments are within the following claims and non-limiting examples. In addition, where features or aspects of the invention are described in terms of Markush groups, those skilled in the art will recognize that the invention is also thereby described in terms of any individual member or subgroup of members of the Markush group.

### EXPERIMENTAL SECTION

### Example 1

### Catalyst Preparation (Embodiment 1)

CoSO₄/SiO₂ catalysts with about 1 wt. % cobalt were prepared by the incipient wetness impregnation method. Cobalt (II) sulphate heptahydrate (from Sigma-Aldrich) was first dissolved in deionized (DI) water, and then added to Cab-O-Sil M-5 silica powder (from Sigma-Aldrich, surface area 200 m²/g). The mixture was aged at room temperature and subsequently dried in an oven at 100° C. overnight. The resulting solids were calcined for 1 hour in an air flow. The calcination temperature was adjusted from 400° C. to 900° C.

### Example 2

### Catalyst Characterization (Embodiment 1)

Physical and chemical properties of CoSO₄/SiO₂ catalysts were characterized by H₂-temperature programmed reduction (TPR), UV-vis diffuse reflectance, XAS (X-ray absorption spectroscopy), and element analysis (EA). UV-vis diffuse reflectance spectra were recorded on a Varian 5000 UV-vis near-infrared spectrophotometer. The spectra were recorded in the range of 200 nm to 800 nm with pure barium sulfate (BaSO₄) as a reference. All samples were dried at 100° C. for 3 hour before performing the test. The reducibility of calcined catalysts was characterized by TPR using the thermal conductivity detector (TCD) of a gas chromatography (Techcomp, 7900). Approximately 200 mg of each sample was loaded into a quartz cell. Prior to each TPR run, the sample cell was purged by air at room temperature, then the temperature was increased to 500° C. at 5° C./min, soaked for 1 hour at the same temperature, and cooled to room temperature. This procedure produces a clean surface before running the H₂-TPR. The gas flow was switched to 5% H₂/Ar, and the baseline was monitored until stable. After baseline stabilization, the sample cell was heated at 5° C./min and held for 30 min at 950° C. An acetone trap was installed between the sample cell and the TCD to condense water or H₂S produced during catalyst reduction. The weight percentage of S after different calcination treatments was measured by Elementarvario CHN elemental analyzer. Before the EA test, all the samples were dried at 100° C. overnight. Approximately 5 mg sample was used for each EA test, and each sample was repeated 3 times to get the mean and standard error.

The catalysts calcined at different temperatures were characterized by XAS. All X-ray absorption data were collected at beam line X23A2, National Synchrotron Light Source, Brookhaven National Laboratory. Approximately 60 mg of each sample was pressed into a self-supporting wafer (about 0.5 mm thick). Extended X-ray absorption fine structure spectroscopy (EXAFS) in the transmission mode was collected from 200 eV below the Co K edge to 900 eV above the Co K edge. Analysis of the X-ray adsorption spectra followed the procedures was described in detail in reference. The EXAFS spectra were calibrated to the edge energy of the cobalt foil reference. The background removal and edge-step normalization were performed using the IFEFFIT software. The theoretical EXAFS function for Co₃O₄ was used to fit the experimental data in order to obtain the corresponding Co—O first shell coordination numbers.

### Example 3

### SWCNT Synthesis (Embodiment 1)

In a typical SWCNT growth experiment, 100 mg of CoSO₄/SiO₂ catalysts were first pre-reduced to a pre-reduction temperature under flowing H₂ (1 bar, 50 sccm, 99.99% from Alphagaz, Soxal) using a temperature ramp of 20° C./min in a CVD reactor. Once the pre-reduction temperature of 540° C. was reached, the reactor was purged using flowing Ar (99.99% from Alphagaz, Soxal), while the temperature was further increased to 780° C. A pressured CO (99.99% from Alphagaz, Soxal) flow was introduced into the reactor at 6 bar and lasted for 1 hour. The carbonyls in CO were removed by a Nanochem Purifilter from Matheson Gas Products. All samples are used to synthesize SWCNTs under the same condition.

### Example 4

### Catalyst Characterization (Embodiment 1)

### Example 4.1

### Temperature-Programmed Reduction (TPR)

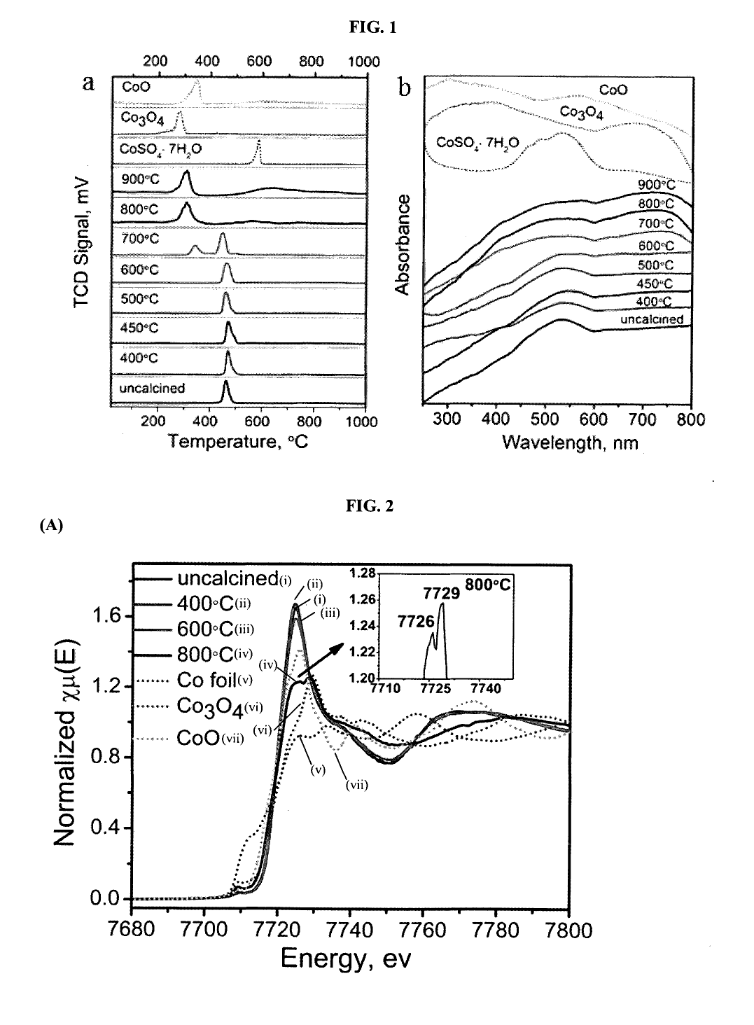

TPR is a useful characterization technique for investigating the metal support interaction and providing surface chemical information, such as stability, metal species, and metal distribution. FIG. 1A shows the TPR profiles of CoSO₄/SiO₂ catalysts uncalcined and calcined at different temperatures in comparison with several references.

From the TPR profiles, CoSO₄.7H₂O exhibits a sharp peak around 585° C., which is ascribed to the reductive decomposition of bulk CoSO₄. The uncalcined catalyst and those calcined at 400° C., 450° C., 500° C. and 600° C. show similar sharp peaks around 460° C. to 470° C., which is attributed to the reductive decomposition of highly dispersed CoSO₄ on the SiO₂ substrate, and no other reduction peaks are observed, such as CoOₓ and cobalt silicates. CoOₓ is usually reduced below 400° C., which is shown by the CoOₓ references (CoO and Co₃O₄) in FIG. 1A.

Surface cobalt silicates usually exhibit a high reduction temperature at around 600° C. to 800° C. However, when the calcination temperature increases to 700° C., CoSO₄ decomposes gradually, and there are two peaks around 450° C. and 340° C. in the profile, which can be assigned to the reduction of remaining CoSO₄ and CoO respectively. The TPR profiles of catalyst calcined at 800° C. and 900° C. are similar, with one peak around 310° C. located between the peaks of CoO and Co₃O₄, which demonstrates the formation of CoO_{X}. In addition, there is another broad peak around 600° C. to 800° C., which is attributed to a small amount of surface cobalt silicate produced on the 800° C.-calcined catalyst, and the broad peak becomes more intense when the catalyst is calcined at 900° C. When the calcination temperature is higher than 950° C., bulk cobalt silicate would form.

### Example 4.2

### Ultraviolet-Visible-Diffuse Reflectance (UV-Vis-Drs) Spectroscopy

UV-vis-drs spectra were used to investigate the surface chemistry of catalysts. The results of Uv-vis-drs are consistent with those of TPR. From FIG. 1B, comparing with the UV-vis spectrum of pure CoSO₄, the catalysts uncalcined and calcined at 400° C., 450° C., 500° C., 600° C. are very similar with only one band around 535 nm, which is ascribed to the ⁴A₂(F)→T₁(P) transition of the tetrahedral Co²⁺ ions, and the color of these samples is the same light pink. When the catalyst is calcined at 700° C., 800° C., and 900° C., the color of samples changes into grey and black, and from the Uv-vis-drs spectra, a small peak and a broad peak appear around 400 nm and 720 nm respectively, which are also detected in the Co₃O₄ reference, and which may be assigned to v₁⁴A_{1g}→¹T_{1g} and v₂¹A_{1g}→¹T_{2g} transitions, indicating octahedral configured Co³⁺ ions. Since the spectrum of CoO is similar with that of Co₃O₄ below the wavelength of 400 nm, and cobalt species are dispersed on the large surface area of the SiO₂ substrate, it is hard to tell whether CoO exists in the calcined catalyst only based on the Uv-vis-drs spectra.

### Example 4.3

### Extended X-Ray Absorption Fine Structure (EXAFS) Spectroscopy

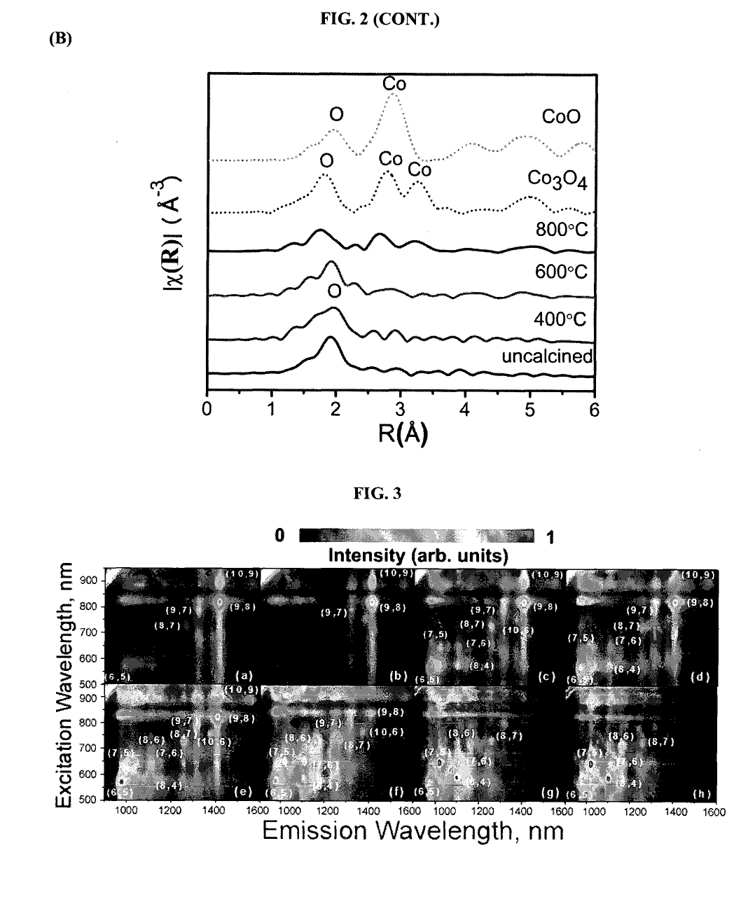

EXAFS spectroscopy is a technique based on the absorption of X-rays and the creation of photoelectrons scattered by neighbour atoms, which can be used to provide detailed information about the coordination number, interatomic distance, and neighbour species of the absorbing atoms. FIG. 2A shows normalized EXAFS spectra of the uncalcined catalyst and catalysts calcined at 400° C., 600° C. and 800° C. The spectra of Co foil, CoO and Co₃O₄ are also given as references for comparison.

Several changes in the EXAFS were observed. The pre-edge peaks of three catalyst samples (uncalcined, calcined at 400° C. and 600° C.) at around 7709 eV overlap, which means that Co atoms in the three samples are in a similar symmetric environment. The XAS edge jump around 7717 eV suggests that Co (II) is the dominant oxidation state for Co atoms in these catalysts. The pre-edge peak of the catalyst calcined at 800° C. located between those of CoO and Co₃O₄, and is more close to that of Co₃O₄. In addition to the pre-edge feature, the intensity of the white line also correlates with the cobalt state in the catalyst. The cobalt foil has only a very weak white line, while the uncalcined CoSO₄/SiO₂ catalyst has a strong white line at 7725 eV, which suggests Co in the uncalcined CoSO₄/SiO₂ sample is in the oxidized state. The spectrum of CoSO₄/SiO₂ catalyst calcined at 400° C. is almost identical to that of the uncalcined sample, indicating that a significant fraction of Co species in the catalyst are still in the same oxidized state after calcined at 400° C. The intensity of the white line of the CoSO₄/SiO₂ catalyst calcined at 600° C. slightly decreased, shown an intermediate state between the catalysts calcined at 400° C. and 800° C. However, after calcination at 800° C., the white line recorded for the CoSO₄/SiO₂ catalyst splits into two peaks. The shoulder peak around 7726 eV can be attributed to CoO and a small amount of surface cobalt silicate, and the peak at 7729 eV is similar with that of Co₃O₄ with respect to both position and intensity, which suggests that Co species in the catalyst were converted into CoOₖ after calcination at 800° C., and the majority of cobalt species are Co₃O₄.

EXAFS spectra in R space are shown in FIG. 2B. For uncalcined and 400° C.-calcined CoSO₄/SiO₂ catalyst, the spectra both have a peak around R=1.96, which is related to the Co—O bond. When the calcination temperature increases to 800° C., the spectrum is identical with that of Co₃O₄ reference with one Co—O bond and two Co—Co bonds, which confirms again that CoOₓ is formed and Co₃O₄ is the major species in the catalyst. α-Cobalt silicate may exist according to the previous report. The spectrum of catalyst calcined at 600° C. is an intermediate state. Fitting the spectra recorded with catalysts uncalcined and calcined at 400° C. to 800° C. with the Co₃O₄ theoretical model, curves with good agreement were obtained. The resulting Co—O first shell coordination numbers are given in TABLE 1. The values of mean-square deviation (<0.01) indicate the fits are within acceptable limits.

TABLE 1
Structure parameters determined from the EXAFS fittings for
CoSO₄/SiO₂ catalysts calcined at different temperatures in an air flow.

| | Co—O first shell | | |
|---|---|---|---|
| Samples | N_{Co—O}^{a} | dR(\acute{Å})^{b} | σ^{2c} |
| Uncalcined | 4.8 ± 0.106 | 0.271 ± 0.011 | 0.006 |
| 400° C. | 5.2 ± 0.168 | 0.266 ± 0.016 | 0.008 |
| 600° C. | 4.6 ± 0.105 | 0.258 ± 0.011 | 0.007 |
| 800° C. | 2.6 ± 0.082 | 0.154 ± 0.014 | 0.008 |

Notations in the table denote:
^{a}N_{Co—O} average first-shell coordination of cobalt-oxygen.
^{b}dR deviation from the effective half-path-length R (R is the inter-atomic distance for single scattering paths).
^{c}σ² (×10⁻² Å²) mean-square deviation in R.

In all, according to above characterization results of the CoSO₄/SiO₂ catalyst at different calcination temperatures, we can conclude that CoSO₄ is well dispersed on the SiO₂ substrate below the calcination temperature of 400° C., and high calcination temperature results in the formation of CoO_{X} and a small amount of cobalt silicate due to the S decomposition in the catalyst.

### Example 5

### SWCNT Characterization (Embodiment 1)

The filtered carbon deposits were further suspended in 2 wt % sodium dodecyl benzene sulfonate (SDBS) (Aldrich) D₂O (99.9 atom % D, Sigma-Aldrich) solution by sonication in a cup-horn ultrasonicator (SONICS, VCX-130) at 20 W for 1 hour. After sonication, the suspensions were centrifuged for 1 hour at 50,000 g.

The clear SWCNT suspensions obtained after centrifugation were characterized by photoluminescence (PLE) and UV-vis-NIR absorption spectroscopy.

### Example 5.1

### Photoluminescence Excitation (PLE) Map

PLE was conducted on a Jobin-Yvon Nanolog-3 spectrofluorometer with the excitation scanned from 500 nm to 950 nm and the emission collected from 900 nm to 1600 nm.

FIG. 3 illustrates the PLE map for SWCNTs with excitation scanned from 500 nm to 950 nm and emission recorded from 900 nm to 1600 nm. Spikes come from the resonance behaviour of both excitation and emission events, representing the transition pair from individual semiconducting (n,m) SWCNTs. FIG. 3 suggests that SWCNTs grown on catalysts under different calcination temperatures can be shifted from the large diameter to small diameter SWCNTs. 400° C. is the optimal calcination temperature for CoSO₄/SiO₂ catalysts which can grow the narrowest chirality distribution with good selectivity towards (9,8) nanotube, although there are a small amount of other nanotubes around (9,8), such as (10,9) and (9,7) (FIG. 3B). The uncalcined sample can also grow dominant (9,8) nanotubes with a small amount of (10,9), (9,7), (8,7) and (6,5). When the calcination temperature of catalysts increases from 450° C. to 600° C., the (n,m) distribution of SWCNTs produced becomes broader including (10,9), (10,6), (9,8), (9,7), (8,7), (8,4), (7,6), (7,5), (6,5), and the intensity of small diameter (6,5) nanotubes keeps increasing. After the calcination temperature of catalysts reaches 700° C., the dominant (n,m) species produced are shifted from (9,8) to (6,5) and the (n,m) distribution is still broad from (6,5) to (9,8). When the calcination temperature increases further from 800° C. to 900° C., the last two PLE spectra are very similar (FIG. 3G and FIG. 3H) which show large diameter nanotubes ((10,9), (9,8) and (9,7)) disappear and the main species are small diameter nanotubes, such as (6,5), (7,5), (7,6) and (8,4). When the calcination temperature of catalysts is higher than 950° C., the bulk cobalt silicate produced is inactive to SWCNT synthesis.

### Example 5.2

### Ultraviolet-Visible-Near Infrared (UV-Vis-NIR) Spectra

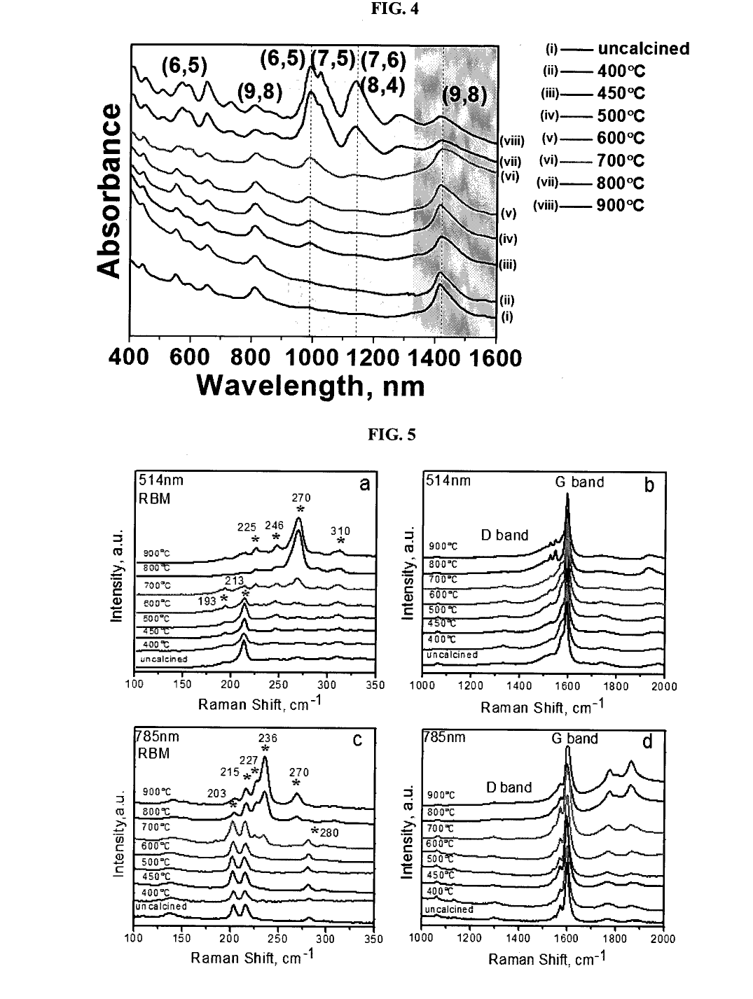

The UV-vis-NIR absorption spectra were measured from 400 nm to 1600 nm on Varian Cary 5000 UV-vis-NIR spectrophotometer. The UV-vis-NIR spectra were conducted to confirm the results of PLE maps. All the spectra were normalized around 1420 nm. FIG. 4 demonstrates that the chirality distribution of SWCNTs varies in the same trend as that in PLE spectra. The spectra of SWCNTs grown on uncalcined and 400° C. calcined CoSO₄/SiO₂ catalysts are similar due to the main species of (9,8) nanotubes. When the calcination temperature of catalysts increases from 450° C. to 600° C., the dominant (n,m) species are still (9,8) nanotubes (as shown by the peak at about λ=1414 nm), but the intensity of (6,5) nanotubes around 980 nm increases gradually. However, with the calcination temperature further roaring to 800° C. and 900° C., both spectra show small diameter nanotubes become the dominant species, such as (6,5), (7,5), (7,6) and (8,4).

### Example 5.3

### Raman Spectroscopy

As-grown SWCNTs were pressed into thin wafers and investigated by Raman spectroscopy. Spectra were collected with a Renishaw Ramanscope in the backscattering configuration over several random spots on samples using 514 nm and 785 nm laser. Laser energies of 2.5 mW to 5 mW were used to prevent destroying SWCNT samples during the measurement. Integration times of 20 s were adapted. There was no significant difference found in the Raman spectra compared with those from SWCNTs on filter membranes after silica support removal. Furthermore, the as-synthesized catalysts loaded with carbon deposits were further refluxed in 1.5 mol/L sodium hydroxide (NaOH) to dissolve the silica matrix and filtered on a nylon membrane (0.2 μm pore).

Raman spectroscopy is widely used to probe into the quality and structure of SWNTs based on radial breathing mode (RBM), D band and G band. Raman spectra were taken on as-synthesized SWCNT samples under 514 nm and 785 nm laser wavelength shown in FIG. 5. All spectra have strong RBM and G band peaks as well as week D band peaks, which demonstrates a good quality of SWCNTs. FIG. 5A and FIG. 5C exhibit a clear shift of (n,m) distribution with calcination temperature.

For the uncalcined CoSO₄/SiO₂ catalyst and catalysts calcined below 700° C., they mainly synthesize larger diameter nanotubes (dₜ≧1.1 nm). The RBM peaks around 193 cm⁻¹ (FIG. 5A), 213 cm⁻¹ (FIG. 5A), 203 cm⁻¹ (FIG. 5C) and 215 cm⁻¹ (FIG. 5C) correspond to (10,8), (10,6), (9,8) and (9,7) nanotubes according to the empirical formula from Weisman, and the (n,m) distribution gradually becomes broader with the calcination temperature increasing.

When calcination temperature is 700° C., there are a few RBM peaks in the wide Raman shift from 193 cm⁻¹ to 310 cm⁻¹ (FIG. 5A), which means that the catalyst calcined at 700° C. totally loses its selectivity towards SWCNTs. When the calcination temperature further roars to 800° C. and 900° C., the intense RBM peaks shift to larger wavelength, which means smaller diameter tubes (dₜ<1.0) become the dominant species. The strong RBM peak around 270 cm⁻¹ (FIG. 5A) and 246 cm⁻¹ (FIG. 5C) correspond to (7,6) and (8,6) nanotubes. All of (n,m) species are identified by RBM peaks in FIG. 5A and FIG. 5C based on the empirical formula. They are listed in TABLE 2, which also collaborates with the results obtained by PLE analysis. 400° C. is an optimal calcination temperature which can produce catalysts for selective synthesis of (9,8) SWCNTs with a narrow (n,m) distribution.

TABLE 2
(n,m) chiralities identified by Raman spectroscopy (from FIG. 5) in the
SWCNT samples synthesized from the CoSO₄/SiO₂ catalyst.

| | Raman Laser | | | | | | | | | | | |
|---|---|---|---|---|---|---|---|---|---|---|---|---|
| | 514 nm | | | | | | 785 nm | | | | | |
| RBM, cm⁻¹ | 193 | 213 | 226 | 246 | 270 | 312 | 203 | 215 | 227 | 236 | 270 | 280 |
| (n,m) | (10,8) | (10,6) | (8,7) | (8,6) | (7,6) | (6,5) | (9,8) | (9,7) | (8,7) | (8,6) | (7,6) | (7,5) |
| dₜ, nm | 1.24 | 1.11 | 1.03 | 0.97 | 0.90 | 0.76 | 1.17 | 1.10 | 1.03 | 0.97 | 0.90 | 0.83 |
| uncalcined | √ | √ | x | x | x | √ | √ | √ | x | x | x | √ |
| 400° C. | x | √ | x | x | x | x | √ | √ | x | x | x | √ |
| 450° C. | √ | √ | x | x | x | √ | √ | √ | x | x | x | √ |
| 500° C. | √ | √ | x | √ | x | √ | √ | √ | x | x | x | √ |
| 600° C. | √ | √ | x | √ | √ | √ | √ | √ | x | x | x | √ |
| 700° C. | √ | √ | √ | √ | √ | √ | √ | √ | √ | √ | x | √ |
| 800° C. | x | x | √ | √ | √ | √ | √ | √ | √ | √ | √ | x |
| 900° C. | x | x | √ | √ | √ | √ | x | √ | √ | √ | √ | x |

### Example 5.4

### Thermal Gravimetric Analysis (TGA)

The total carbon loading was determined on as-synthesized catalysts by thermogravimetric analysis (TGA) using PerkinElmer Diamond TG/DTA equipment. For a typical measurement, about 1 mg sample (as-synthesized SWCNTs on catalysts) was loaded into an alumina pan. The sample was firstly heated to 110° C., and was held at 110° C. for 10 minutes in the air flow (200 sccm) to remove any moisture. Then the temperature was continually hiking from 110° C. to 1000° C. at a 10° C./min ramp. The weight of the sample was monitored and recorded as a function of the temperature. The same procedure was repeated after the sample was cooled to room temperature and another weight/temperature curve was obtained serving as a baseline.

TGA was used to analyze the carbon loading and different carbon species of carbon deposits. Carbon loading was directly calculated by weight loss from TGA profiles. The carbon yields of three representative carbon deposits synthesized on catalysts calcined at 400° C., 700° C. and 900° C. are 5.9%, 6.6% and 6.8% respectively, which demonstrates that carbon yields increase slightly with the calcination temperature increasing.

However, in most cases, carbon deposits contain not only SWCNTs but also other impurities like amorphous carbon, multi-walled carbon nanotubes (MWCNTs) and graphite, which can be determined based on DTG (derivative thermogravimetry) patterns obtained by taking the derivative of TGA profiles. DTG patterns of carbon deposits can be categorized into three oxidation regions: amorphous carbon below 300° C., carbon nanotubes (SWCNTs and MWCNTs) between 400° C. and 700° C., and graphite above 800° C.

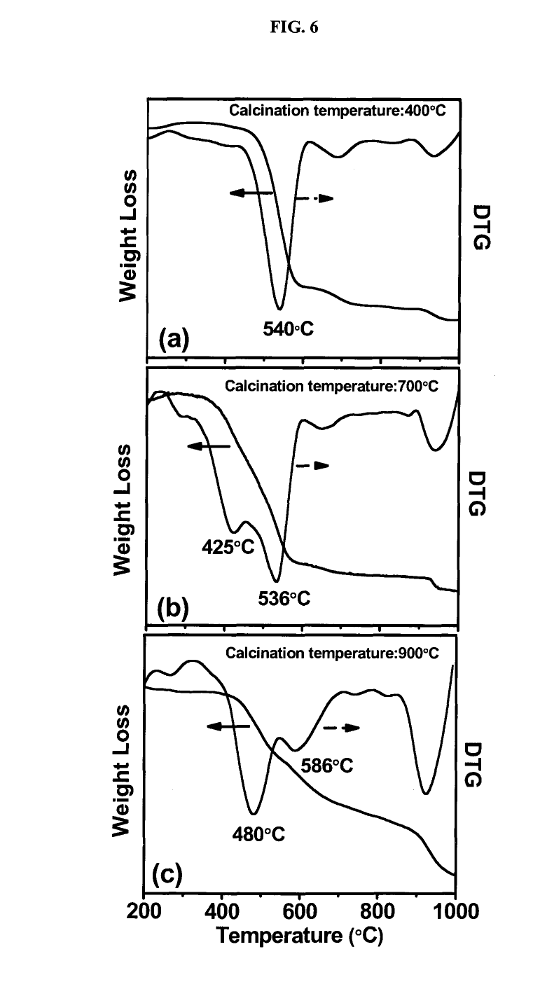

FIG. 6 shows DTG patterns of carbon deposits produced on the three representative catalysts. The dominant peaks at 540° C., 425° C., 536° C., and 480° C. on the DTG profiles can be attributed to the oxidation of SWCNTs. Since the oxidation temperature of SWCNTs can be influenced by the diameter of SWCNTs and larger diameter SWCNTs have higher oxidation temperature compared with smaller diameter nanotubes, the peak shift from 540° C. to lower temperature 425° C. and 480° C. may indicate that the diameter of SWCNTs synthesized on CoSO₄/SiO₂ catalysts decreases with the calcination temperature increasing from 400° C. to 900° C. And the intense peak in FIG. 6A show majority of SWCNTs synthesized on the 400° C.-calcined catalyst are the same structures, while the two intense peaks in FIG. 6B and FIG. 6C may indicate that SWCNTs synthesized on catalysts calcined at higher temperature contain different structures.

However, when metal residues are present, metal residues may affect the oxidation of SWCNTs and result in the shift of oxidation temperature. In all of the three DTG profiles, there are positive peaks below 250° C. supporting the existence of metal residues which are cobalt particles resulted from the reduction of cobalt species during the synthesis of SWCNTs. The formation of graphite can also confirm the presence of metal residues. Larger metal particles are easily covered by layers of graphite. The peaks above 900° C. on DTG profiles come from the oxidation of graphite. Carbon deposits synthesized after the catalyst calcined at 900° C. have the most intense graphite peak. In addition, the small peak around 586° C. may be attributed to the existence of a small amount of MWCNTs. Therefore, with the calcination temperature increasing, the enhanced carbon yield comes from the oxidation of graphite, and furthermore, high calcination temperature can disturb the dispersion of cobalt species on the catalyst, resulting in large metal particle during the synthesis of SWCNTs, which in turn decreases the yield of SWCNTs.

Based on above SWCNT characterization results, conclusions can be obtained that the highly selective growth of (9,8) nanotubes with a narrow (n,m) distribution can be achieved on CoSO₄/SiO₂ catalysts calcined at a lower temperature of 400° C., and that the chirality of SWCNTs can be shifted from larger diameter (9,8) nanotubes to small diameter (7,5) and (6,5) nanotubes with the calcination temperature increasing. Because of the correlation between the SWCNT diameter and the size of the catalyst metal particle from which it grows, we attribute the (n,m) shift to the change in size of the catalyst particles resulting from the reduction of different Co species produced on the CoSO₄/SiO₂ catalyst by calcination. At the lower calcination temperature, the Co species are well dispersed on the catalyst, and the size of most Co nanoparticles stabilized on the substrate after reduction matches with that of (9,8) nanotubes, which therefore results in the good chiral selectivity.

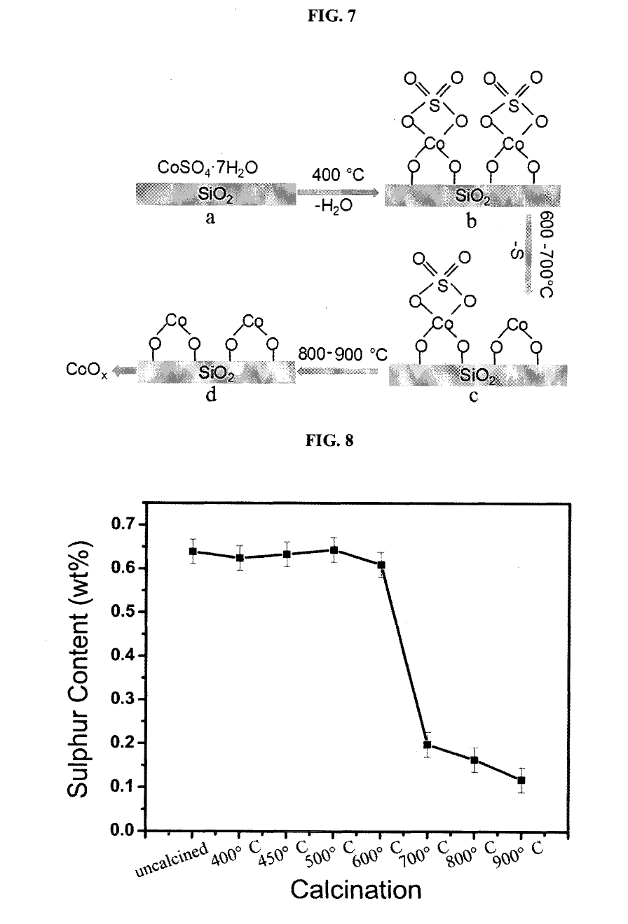

TPR and XAS results have already shown CoO_{X} and cobalt silicate are formed under high calcination temperature, and the dispersion of Co species decreases with the calcination temperature. We believe the presence of S can improve the distribution and avoid the formation of CoO_{X} and cobalt silicate. However, the S decomposition occurs with the calcination temperature increasing, and different Co species can produce on the catalyst, which may be responsible for the SWCNT chirality shift. The calcination process of CoSO₄/SiO₂ catalyst at different temperatures is proposed in FIG. 7.

When the calcination temperature is low (400° C.), S in the CoSO₄/SiO₂ catalyst exists in the form of two terminal S═O bonds (FIG. 7B), which is believed to give a well-dispersed metal oxide particles. From the EXAFS fitting results (TABLE 1), the coordination number of Co—O is around 5, which means the structure in a distorted tetrahedral environment. When the calcination temperature increases, S═O bonds start to decompose, and the decomposition of a small amount of S═O results in the formation of

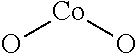

(FIG. 7C). The coordination number of Co—O of the catalyst calcined at 600° C. decreases slightly to 4.6, which also proves the cleavage of a small amount of tetrahedral structures. When the calcination temperature further increases to 900° C., S═O bonds in the catalyst decompose completely, while a large amount of

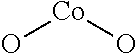

are not stable and eventually converses into CoOₓ (FIG. 7D). Meanwhile, high temperature may result in a small amount of cobalt silicate because of the reaction of CoO and SiO₂. Accordingly, the decrease of Co—O coordination number to 2.6 demonstrates the break of tetrahedral structures due to decomposition of a large amount of S. The role of S needs more detailed analysis. In-situ XAS to study the state of S under different calcination conditions have also been investigated.

To further confirm the S decomposition with the calcination conditions, the S content is measured by conducting element analysis on CoSO₄/SiO₂ catalysts uncalcined and calcined at different temperatures. FIG. 8 shows that the S content keeps almost constant at 0.64% before the calcination temperature of 500° C. It drops slightly to 0.6% at 600° C. and dramatically to 0.2% at 700° C., which is due to the gradual S decomposition. With the calcination temperature roaring to 900° C., S decomposes almost completely.

According to the above discussion, an explanation about the effects of catalyst calcination temperature on the chirality selectivity of SWCNT synthesized on CoSO₄/SiO₂ catalysts is provided below. For uncalcined catalysts and catalysts calcined at 400° C., Co atom is bonded to O atom and terminated by S═O bonds, which results in the well dispersed Co nanoparticles under reduction suitable for the synthesis of (9,8) nanotubes. The uncalcined catalyst contains some water molecules, and the color of the catalyst is pink. The color of the catalyst calcined at 400° C. changes from light violet to pink when it absorbs moisture due to exposure to air at room temperature. Therefore, these water molecules in the uncalcined catalyst may have a small effect on the reduction of Co species, which results in the little difference of SWCNTs products. When CoSO₄/SiO₂ catalysts are calcined at higher temperature (500° C. and 600° C.), most of Co atoms are still in the distorted tetrahedron structure, however, S═O bonds start to decompose and a fraction of

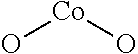

forms, and when these catalysts expose to H₂ during reduction, the reduced Co nanoparticles may aggregate, which result in the broader (m, m) distribution of SWCNTs. Especially, when the calcination temperature increases to 700° C., the Co nanoparticles aggregate severely to form various size of nanoclusters due to the decomposition of S═O bonds, which results in the loss of (n,m) selectivity. When the calcination temperature further increases to 800° C. and 900° C., with the complete decomposition of S═O bonds, CoOₓ and cobalt silicate form, which results in the synthesis of small diameter tubes, such as (6,5), (7,5), (7,6) and (8,4).

As can be seen from the above, the CoSO₄/SiO₂ catalyst prepared by cobalt sulphate heptahydrate was calcined in an air flow at different temperature from 400° C. to 900° C. Catalyst characterization results demonstrated that CoSO₄ is well dispersed on the SiO₂ substrate below the calcination temperature of 400° C., and high calcination temperature results in the formation of CoOₓ and cobalt silicate due to the decomposition of S═O in the catalyst. SWCNTs were synthesized on the uncalcined CoSO₄/SiO₂ catalyst and those catalysts calcined at different temperatures, and the chirality of SWCNTs was shifted from larger diameter nanotubes to small diameter nanotubes with the catalyst calcination temperature increasing. Co SO₄/SiO₂ catalysts are selective to the synthesis of (9,8) SWCNTs at a lower temperature of 400° C. The presence of S═O is proved to be critical to disperse the cobalt well on the catalysts and hence prevent efficiently the formation of cobalt oxides and cobalt silicate. Only well-dispersed Co species would aggregate into large metal clusters which are active for (9,8) SWCNT growth.

### Example 6

### Catalyst Preparation (Embodiment 2)

The CoSO₄/SiO₂ catalyst was prepared by incipient wetness impregnation method, in which metal salt dissolved in water dissolved in water is added to the catalyst support materials.

Cobalt (H) sulfate heptahydrate (CoSO₄.7H₂O) (Sigma-Aldrich, ≧99% purity) was first dissolved in deionized water and then added to CAB-O-SIL M-5 fumed silica with a surface area of 254 m²/g and a pore volume of 0.89 mL/g. The total Co weight loading in the catalyst is about 1.0 wt %.

The mixture was first aged at room temperature for 1 h and afterward dried in an oven at 100° C. for 2 h. The dried catalyst was further calcined under airflow of 20 sccm per gram of catalyst from room temperature to 400° C. at 1° C./min ramping rate and then kept at 400° C. for 1 h.

### Example 7

### SWCNT Synthesis (Embodiment 2)

The catalyst was used to catalyze SWCNT growth in a continuous-flow tubular chemical vapor deposition reactor. To catalyze SWCNT growth, 200 mg of the CoSO₄/SiO₂ catalyst was loaded in a ceramic boat at the center of a horizontal chemical vapor deposition reactor. The catalyst was first reduced under pure H₂ (1 bar, 50 sccm, 99.99% from Alphagaz, Soxal), during which the reactor temperature was increased from room temperature to an elevated temperature at 20° C./min. Once the reduction temperature reached 540° C., the reactor was purged by Ar (99.99% from Alphagaz, Soxal), while its temperature was further increased to 780° C. At 780° C., pressured CO (6 bar, 99.9% from Alphagaz, Soxal) was introduced into the reactor at 200 sccm flow rate to initiate SWCNT growth, and the growth time was 1 h. Carbonyl residues in CO gas were removed by a purifier (Nanochem, Matheson Gas Products) before entering the reactor.

In another experiment, the catalyst was reduced in H₂ from room temperature to 780° C. and further reduced for 30 min at 780° C. before exposing to CO.

### Example 8

### SWCNT Characterization (Embodiment 2)

### Example 8.1

### Raman Spectroscopy (Embodiment 2)

As-synthesized SWCNTs deposited on the CoSO₄/SiO₂ catalyst were first studied by Raman spectroscopy. Raman spectra were collected with a Renishaw Ramanscope in the backscattering configuration over a few random spots on samples under 514 nm, 633 nm, and 785 nm lasers with the integration time of 10 s. Laser energies of 2.5 mW to 5 mW were used to prevent sample damages during the measurement. SWCNTs were further refluxed in 1.5 mol/L NaOH aqueous solution to dissolve the SiO₂ catalyst and then filtered on a nylon membrane (0.2 μm pores). No significant differences between the Raman spectra of as-synthesized SWCNTs and SWCNTs on filter membranes after catalyst removal were found.

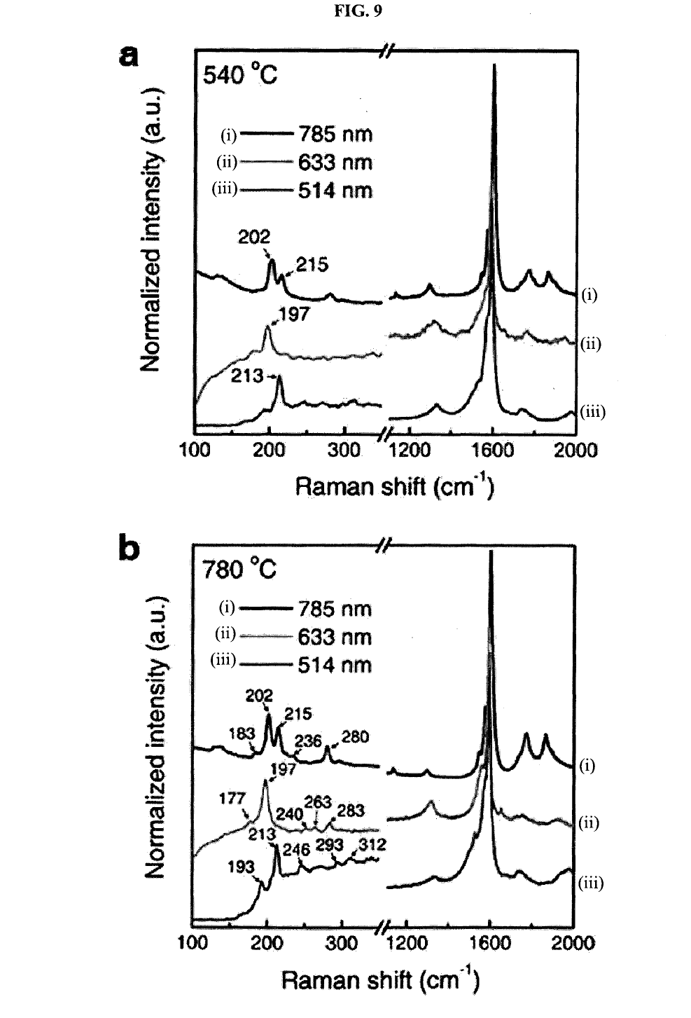

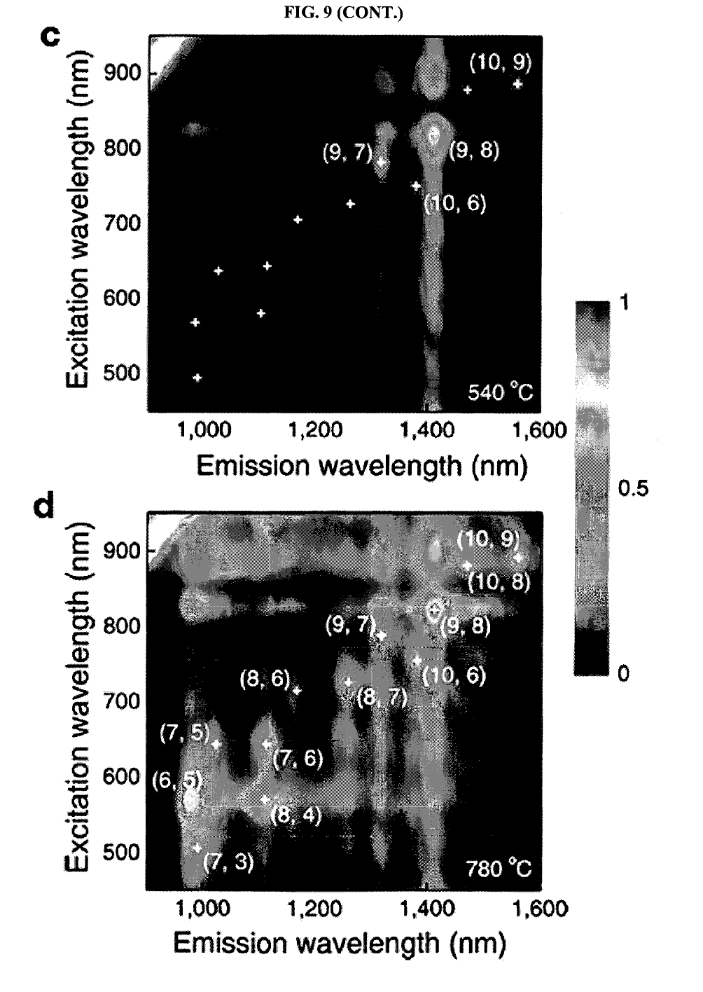

FIG. 9A and FIG. 9B depict Raman spectroscopy at three excitation wavelengths (785 nm, 633 nm, and 514 nm) of the collected solid carbon products. The presence of the radial breathing mode (RBM) peaks between 100 cm⁻¹ and 350 cm⁻¹ and the low ratio of the D-to-G band intensities indicated that samples consist primarily of SWCNTs. The sample produced after reduction at 540° C. consists of fewer RBM peaks centered around 202 cm⁻¹ to 215 cm⁻¹ compared with the sample produced after 780° C. reduction.

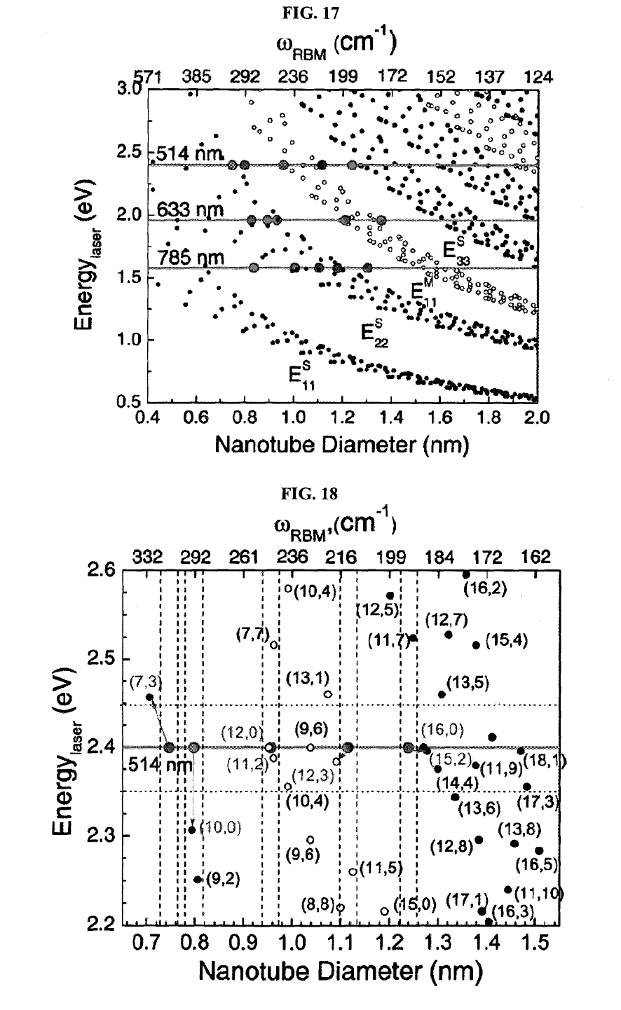

The chiral indexes (n,m) of RBM peaks are assigned based on empirical and theoretical Kataura plots (see FIGS. 17 to 20 and TABLE 3).

A combination of empirical and theoretical Kataura plots are used because for E₁₁ and E₂₂ van Hove transitions of semiconducting SWCNTs, the available empirical Kataura plots are more accurate, while no empirical Kataura plots are currently available for metallic SWCNTs and higher order transitions of semiconducting SWCNTs.

TABLE 3
Summary of chirality assignment for RBM peaks identified in
Raman analysis of SWCNT samples.

| Excitation | RBM frequency | dₜ | |
|---|---|---|---|
| Laser (nm) | (cm−1) | (nm) | Chirality |
| 514 | 193 | 1.34 | (16, 0), (15, 2) |
| | 213 | 1.11 | (12, 3) |
| | 246 | 0.96 | (12, 0), (11, 2) |
| | 293 | 0.80 | (10, 0) |
| | 312 | 0.75 | (7, 3) |
| 633 | 177 | 1.36 | (15, 3) |
| | 197 | 1.20 | (9, 9), (15, 0), (14, 2), (13, 4) |
| | 252 | 0.93 | (10, 3) |
| | 262 | 0.90 | (7, 6) |
| | 282 | 0.83 | (7, 5) |
| 785 | 183 | 1.30 | (16, 0) |
| | 202 | 1.18 | (12, 5), (13, 3), (9, 8) |
| | 215 | 1.10 | (9, 7) |
| | 236 | 1.00 | (11, 3), (12, 1) |
| | 280 | 0.84 | (11, 0) |

*Major Raman peaks and their corresponding (n, m) tubes are highlighted in bold.

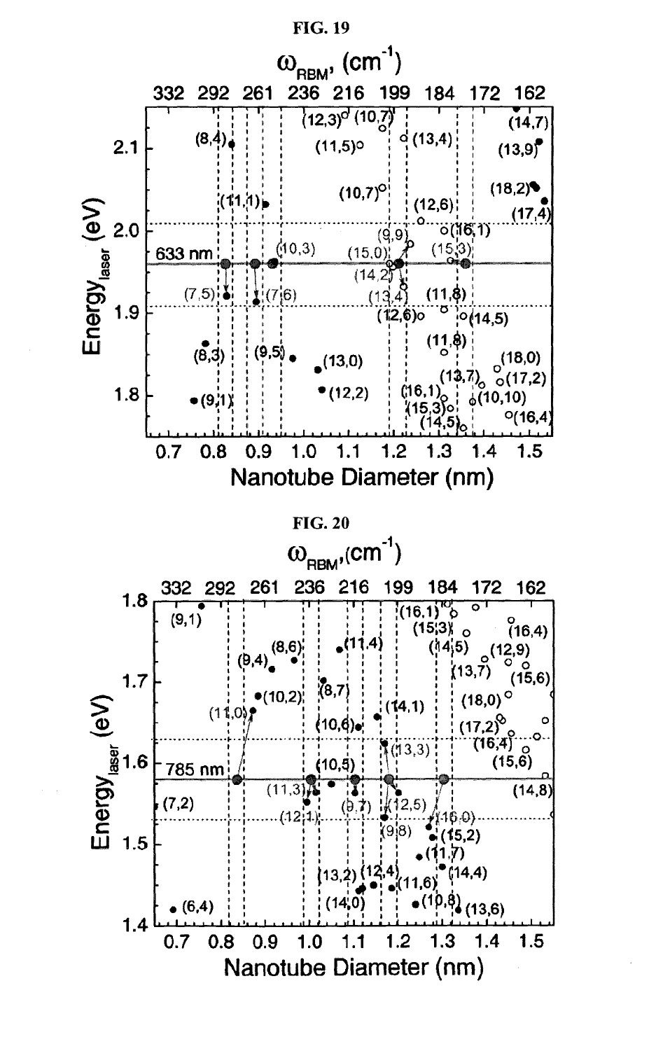

Five RBM peaks are observed under the 633 nm laser (FIGS. 9A and 9B) at 177 cm⁻¹, 197 cm⁻¹, 252 cm⁻¹, 262 cm⁻¹, and 282 cm⁻¹, respectively. As shown in FIG. 19, 177 cm⁻¹, and 197 cm⁻¹ peaks come from metallic nanotubes, which cannot be detected in PL spectroscopy. They are credited to E₁₁ transitions of (15, 3), (9, 9), (13, 4), (14, 2) and (15, 0) metallic nanotubes based on Kataura plots computed using a tight-binding model. The other three peaks at 252 cm⁻¹, 262 cm⁻¹, and 282 cm⁻¹ are from E₂₂ transitions of semiconducting (10, 3), (7, 6) and (7, 5) nanotubes, respectively. The peak at 197 cm⁻¹ is much more intense compared to others, thus, (9, 9), (13, 4), (14, 2) and (15, 0) nanotubes would have higher abundance.

There are five RBM peaks identified under the 785 nm laser (FIG. 9B and FIG. 17) at 183 cm⁻¹, 202 cm⁻¹, 215 cm⁻¹, 236 cm⁻¹, and 280 cm⁻¹, respectively. No chiral nanotubes are found in the resonance windows of the peaks at 183 cm⁻¹ and 280 cm⁻¹. Thus, we assign them to (16, 0) and (11, 0) respectively, which are the chiral structures closest to their resonance windows. On the other hand, several chiral nanotubes fall within the resonance windows of the peaks at 202 cm⁻¹, 215 cm⁻¹, and 236 cm⁻¹. The peak at 202 cm⁻¹ can be attributed to (12, 5), (13, 3) and (9, 8). The peak at 215 cm⁻¹ is from (9, 7). (11,3) and (12, 1) contribute to the peak at 236 cm⁻¹. The major peaks are at 202 cm⁻¹ and 215 cm⁻¹, thus (12, 5), (13, 3), (9, 8) and (9, 7) would be among the main chiral nanotubes in SWCNT samples.

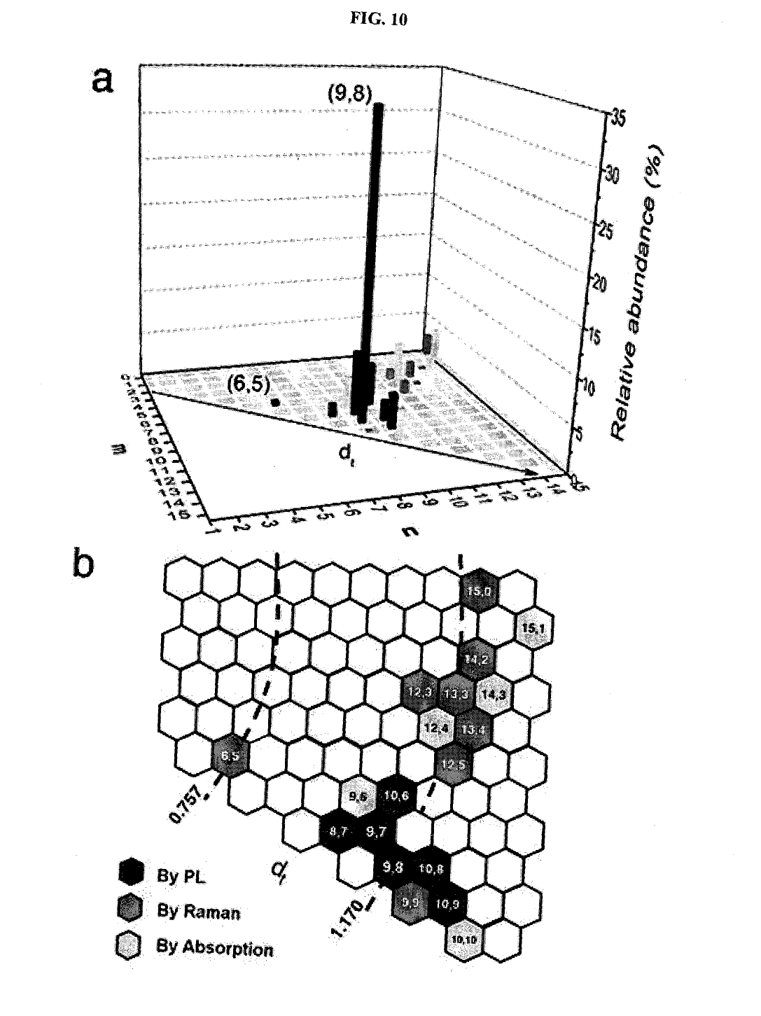

The most intense RBM peaks belong to (12,3), (9,9), (15,0), (14,2), (13,4), (12,5), (13,3), (9,8), and (9, 7) tubes, which are highlighted as red bars ((9,8) and (9,7) are shown in blue) and hexagons in FIG. 10. This result suggests the diameter selectivity is around 1.17 nm in SWCNT growth. Next, PL spectroscopy was used to assign the (n,m) structure of semiconducting tubes. FIG. 9C and FIG. 9D show contour plots of the PL intensity collected from SWCNTs dispersed in 2 wt % sodium dodecyl benzene sulfonate (SDBS) D₂O solution as a function of excitation and emission. The relative abundance of semiconducting (n,m) tubes identified in FIG. 9C and FIG. 9D is determined by their PL intensities. Results are listed in TABLES 4A and 4B.

TABLE 4A
Photoluminescence intensities for (n,m) tubes identified in
SWCNTs produced on CoSO₄/SiO₂ catalyst after catalyst
reduction at 540° C. The relative abundance is calculated
based on the PL intensity of different (n,m) tubes.

| | Diameter | Chiral | | | PL | Relative |
|---|---|---|---|---|---|---|
| (n,m) | dₜ | angle | E₁₁ | E₂₂ | intensity | abundance* |
| index | (nm) | θ (°) | (nm) | (nm) | (counts) | (%) |
| (6,5) | 0.76 | 27.00 | 983 | 570 | 209.4 | 3.6% |
| (7,3) | 0.71 | 17.00 | 993 | 502 | 168.9 | 2.9% |
| (7,5) | 0.83 | 24.50 | 1022 | 638 | 79.0 | 1.4% |
| (7,6) | 0.90 | 27.46 | 1113 | 642 | 82.0 | 1.4% |
| (8,4) | 0.84 | 19.11 | 1102 | 578 | 124.7 | 2.1% |
| (8,6) | 0.97 | 25.28 | 1165 | 718 | 44.2 | 0.8% |
| (8,7) | 1.03 | 27.80 | 1263 | 726 | 209.8 | 3.6% |
| (9,7) | 1.10 | 25.87 | 1321 | 790 | 861.8 | 14.8% |
| (9,8) | 1.17 | 28.05 | 1414 | 818 | 3007.6 | 51.7% |
| (10,6) | 1.11 | 21.79 | 1384 | 754 | 447.7 | 7.7% |
| (10,8) | 1.24 | 26.30 | 1467 | 870 | 188.7 | 3.2% |
| (10,9) | 1.31 | 28.30 | 1559 | 886 | 395.2 | 6.8% |

*Major (n,m) tubes (with relative abundance > 3%), including (9,8), (9,7), (10,6), (8,7), (10,8), (10,9), and (6,5) are highlighted in bold.

FIG. 9C and TABLE 4A show that the catalyst is highly selective to the single chiral (9,8) tube (51.7%) after 540° C. reduction. Several other (n,m) tubes (with relative abundance>3%) are also detectable in FIG. 9C, such as (9,7), (10,6), (10,8), (8,7), (10,9), and (6,5). Similar to previous studies, the existence of those species suggests a strong selectivity toward high chiral angle tubes in SWCNT growth. In contrast, the sample grown after 780° C. as shown in TABLE 4B reduction comprises numbers of (n,m) tubes centered around (6,5) (16.3%) and (9,8) (17.5%).

TABLE 4B
Photoluminescence intensities for (n, m) nanotubes identified in SWCNTs
produced on CoSO₄/SiO₂ catalyst after catalyst reduction at 780° C. for
30 min. The relative abundance is calculated based on the PL intensity of
different (n, m) nanotubes.

| | Diameter | Chiral | | | | Relative |
|---|---|---|---|---|---|---|
| (n, m) | dₜ | angle | E₁₁ | E₂₂ | PL intensity | abundance* |
| index | (nm) | θ (°) | (nm) | (nm) | (counts) | (%) |
| (6, 5) | 0.76 | 27.00 | 983 | 570 | 2754.9 | 16.3% |
| (7, 3) | 0.71 | 17.00 | 991 | 514 | 1144.8 | 6.7% |
| (7, 5) | 0.83 | 24.50 | 1022 | 638 | 788.9 | 4.7% |
| (7, 6) | 0.90 | 27.46 | 1114 | 642 | 1537.8 | 9.1% |
| (8, 4) | 0.84 | 19.11 | 1110 | 574 | 1330.3 | 7.8% |
| (8, 6) | 0.97 | 25.28 | 1166 | 710 | 620.3 | 3.7% |
| (8, 7) | 1.03 | 27.80 | 1263 | 726 | 1663.0 | 9.8% |
| (9, 7) | 1.10 | 25.87 | 1321 | 790 | 1596.0 | 9.4% |
| (9, 8) | 1.17 | 28.05 | 1415 | 822 | 2972.5 | 17.5% |
| (10, 6) | 1.11 | 21.79 | 1380 | 754 | 1045.5 | 6.2% |
| (10, 8) | 1.24 | 26.30 | 1470 | 870 | 624.2 | 3.7% |
| (10, 9) | 1.31 | 28.30 | 1559 | 890 | 872.3 | 5.1% |

*Relative abundance (RA (n, m)) in TABLE 4B was calculated using the equation (1):
$\begin{matrix}RA ( n , m ) = \frac{{I ( n , m )}_{PL}^{exp}}{\sum {I ( n , m )}_{PL}^{exp}} \times 100 \% \\ ( 1 )\end{matrix}$

### Example 8.2

### PL Spectroscopy (Embodiment 2)

To obtain SWCNT suspensions, carbon deposits on filter membranes were further dispersed in 2 wt % SDBS (Aldrich) D₂O (99.9 atom % D, Sigma-Aldrich) solution by sonication in a cup-horn ultrasonicator (SONICS, VCX-130) at 20 W for 1 h. After sonication, SWCNT suspensions were centrifuged for 1 h at 50 000g.

SWCNT suspensions obtained after centrifugation were characterized by PL and absorption spectroscopy. PL was conducted on a Jobin-Yvon Nanolog-3 spectrofluorometer with the excitation scanned from 450 nm to 950 nm and the emission collected from 900 nm to 1600 nm.

### Example 8.3

### UV-Vis-NIR Absorbance Spectroscopy (Embodiment 2)

To further evaluate the abundance of metallic tubes which cannot be observed in PL analysis, UV-vis-NIR absorbance spectroscopy was carried out. UV-vis-NIR absorption spectra were measured from 500 nm to 1600 nm on the Varian Cary 5000 spectrophotometer.

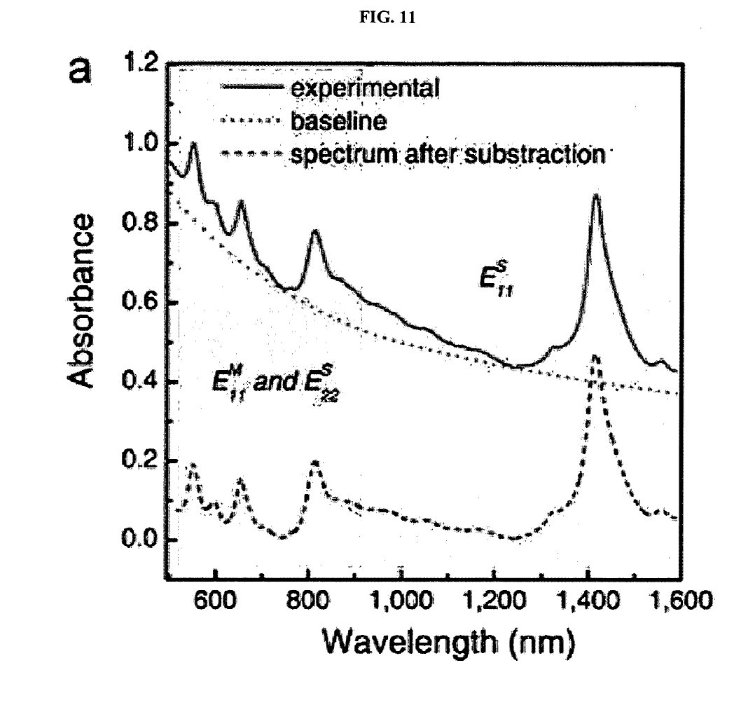

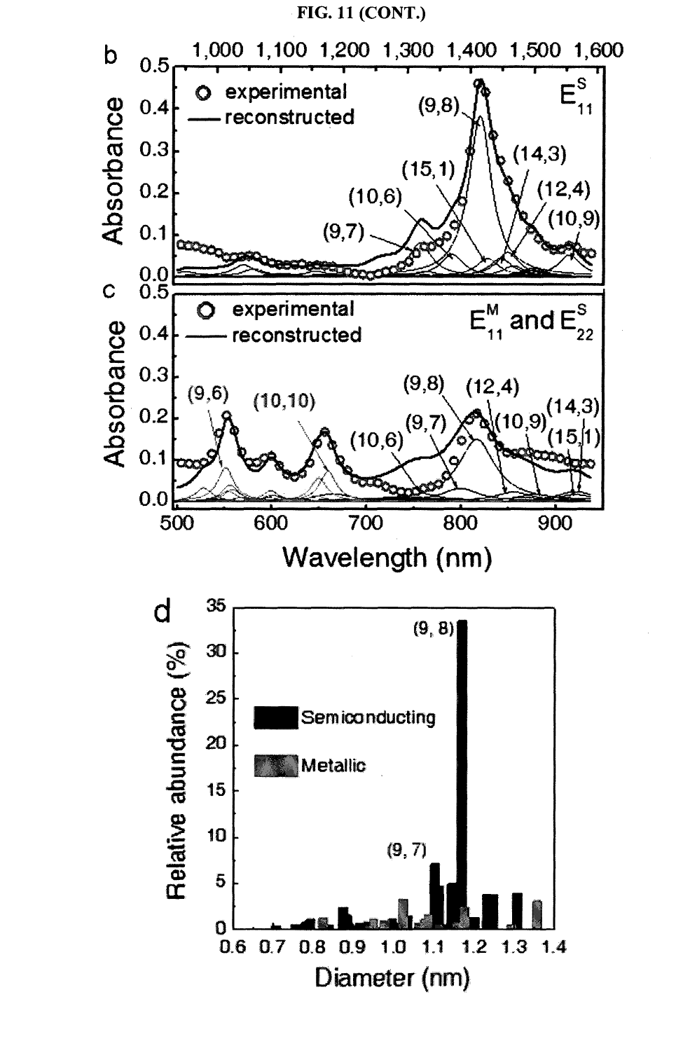

UV-vis-NIR absorbance spectrum of the sample produced after catalyst reduction at 540° C. is shown in FIG. 11A. The label E₁₁^{S} (910 nm to 1600 nm) indicates the excitonic optical absorption bands for semiconducting SWCNTs corresponding to the first one-dimensional van Hove singularities; the E₁₁^{M} and E₂₂^{S} (500 nm to 910 nm) correspond to the overlapping absorption bands of the first van Hove singularities from metallic SWCNTs and the second van Hove singularities from semiconducting SWCNTs. Intense absorption peaks at 1416 nm and 816 nm correspond to the first and second one-dimensional van Hove singularity transitions of (9,8) tubes. Additional absorption peaks below 700 nm may be assigned to either the E₁₁^{M} transition of metallic tubes or E₂₂^{S} transition of semiconducting tubes.

A method based on the electron-phonon interaction model was used to reconstruct the UV-vis-NIR absorbance spectrum (see TABLES 5 to 7).

The modified methodology from Luo et al. (Luo et al., J. Am. Chem. Soc, 2006, 128, 15511-15516) was used to reconstruct UV-vis-NIR absorbance spectra. A baseline based on the power law (that is Aλ^{-b}) curve was subtracted from the experimental spectrum as shown in FIG. 10A. The NIR portion of absorption spectra belonging to the E^{S}₁₁ transition of semiconducting SWCNTs was reconstructed between 935 nm and 1590 nm. The overall contribution to the expected optical density (OD) of all (n,m) SWCNTs at a specific optical energy E can be calculated by using the equation (2), where C is the normalization factor introduced to account for sampling conditions and the collection geometries. The relative contribution (A(n,m)) of individual (n,m) tubes to the OD was calculated using the equation (3).

I(n,m)^{exp}_{PL} is the experimental PL intensity of individual (n,m) tubes extracted from FIG. 9C and TABLES 4A and 4B. I(n,m)^{cal}_{PL} and W^{abs}_{cal}(n,m) are the calculated corresponding PL and absorption intensity based on an electron-phonon interaction model. γₑ is the width of the optical transitions, which is related to the lifetime of the excited states, and equation (4) was approximated with C₁ and C₂ as adjustable parameters.

E (n,m) values were obtained from PL measurement in TABLES 4A and 4B or from theoretical Kataura plots.

$$\begin{matrix}OD ( E ) = C {\sum }_{n , m}^{ } A ( n , m ) \frac{{γ}_{e}}{4 {( E - E ( n , m ) )}^{2} + {γ}_{e}^{3}} & ( 2 ) \\ A ( n , m ) = \frac{{I ( n , m )}_{PL}^{exp}}{{I ( n , m )}_{PL}^{cal}} {W}_{cal}^{abs} ( n , m ) & ( 3 ) \\ {γ}_{e} = {C}_{1} + {C}_{2} / {W}_{cal}^{abs} & ( 4 )\end{matrix}$$

Following an analysis routine used in Wang, B et al. (Wang, B et al., J. Am. Chem. Soc., 2007, 129, 9014-9019), the contribution from (n,m) tubes identified in PL analysis was first considered. Their contribution (A (n,m)) to OD was directly calculated using experimental PL intensity from TABLE 4A. However, (n,m) tubes identified in PL analysis alone cannot reconstruct the absorption spectra well. Thus, additional semiconducting tubes identified in Raman analysis from TABLE 3, as well as other tubes with similar diameters, were added. The fitting result was significantly improved, as presented in FIG. 10B. All data used in the reconstruction of E^{S}₁₁ transition of semiconducting SWCNTs were listed in TABLE 5.

TABLE 5
Parameters used to reconstruct E^{S}₁₁ absorption spectra of
semiconducting SWCNTs. The relative abundance (semi) is calculated based on the
reconstructed absorbance E^{S}₁₁ peak area of each semiconducting (n,m) tube only. The relative
abundance (semi + met) is calculated based on the reconstructed absorbance E^{S}₁₁ peak area of
each (n,m) tube, including both semiconducting and metallic SWCNTs.

| | | | | | | | | | |
|---|---|---|---|---|---|---|---|---|---|
| (n,m) | Diameter | E(nm) | | | | | Area | RA (n,m) | RA (n,m) (%) |
| index | dₜ (nm) | (nm) | 1_{PL}^{exp} | 1_{PL}^{cal} | W_{abs}^{cal} | A(n,m) | (n,m)_{Abs}^{Fitted} | (%) (semi) | (semi + met) |

(n,m) tubes identified in PL (C₁ = 25, C₂ = 1)

| | | | | | | | | | |
|---|---|---|---|---|---|---|---|---|---|
| (7,3) | 0.706 | 992 | 168.9 | 0.61 | 1.65 | 456.86 | 0.309 | 0.508 | 0.417 |
| (6,5) | 0.757 | 975 | 209.4 | 0.67 | 1.85 | 578.19 | 0.370 | 0.609 | 0.499 |
| (7,5) | 0.829 | 1018 | 79.0 | 0.71 | 2.04 | 226.99 | 0.159 | 0.261 | 0.214 |
| (8,4) | 0.84 | 1110 | 124.7 | 0.46 | 1.77 | 479.82 | 0.349 | 0.574 | 0.471 |
| (7,6) | 0.895 | 1120 | 82.0 | 0.47 | 1.98 | 345.45 | 0.253 | 0.416 | 0.341 |
| (8,6) | 0.966 | 1176 | 44.2 | 0.49 | 2.18 | 196.64 | 0.145 | 0.238 | 0.196 |
| (8,7) | 1.032 | 1262 | 209.8 | 0.3 | 2.06 | 1440.63 | 1.067 | 1.755 | 1.439 |
| (9,7) | 1.103 | 1320 | 861.8 | 0.27 | 2.22 | 7085.91 | 5.254 | 8.641 | 7.085 |
| (10,6) | 1.111 | 1370 | 447.7 | 0.21 | 2.03 | 4327.77 | 3.496 | 5.749 | 4.714 |
| (9,8) | 1.17 | 1416 | 3007.6 | 0.19 | 2.14 | 33875.07 | 24.855 | 40.881 | 33.516 |
| (10,8) | 1.24 | 1467 | 188.7 | 0.18 | 2.16 | 2264.40 | 1.633 | 2.687 | 2.202 |
| (10,9) | 1.307 | 1555 | 395.2 | 0.14 | 2.22 | 6266.74 | 2.917 | 4.798 | 3.933 |

(n,m) tubes identified in Raman (C₁= 25, C₂ = 1)

| | | | | | | |
|---|---|---|---|---|---|---|
| (10,0) | 0.794 | 1156 | 1445.27 | 0.793 | 1.304 | 1.069 |
| (11,0) | 0.873 | 1037 | 1953.44 | 1.756 | 2.888 | 2.368 |
| (10,3) | 0.936 | 1247 | 937.10 | 0.579 | 0.952 | 0.781 |
| (12,1) | 0.995 | 1330 | 937.47 | 0.786 | 1.292 | 1.060 |
| (11,3) | 1.014 | 1197 | 601.84 | 0.527 | 0.867 | 0.711 |

Other possible (n,m) tubes (C₁ = 25, C₂ = 1)

| | | | | | | |
|---|---|---|---|---|---|---|
| (8,3) | 0.782 | 950 | 937.10 | 0.563 | 0.926 | 0.759 |
| (10,2) | 0.884 | 1053 | 1275.88 | 1.145 | 1.883 | 1.544 |
| (11,1) | 0.916 | 1265 | 40.69 | 0.000 | 0.000 | 0.000 |
| (9,4) | 0.916 | 1102 | 598.32 | 0.466 | 0.766 | 0.628 |
| (9,5) | 0.976 | 1244 | 3.66 | 0.000 | 0.000 | 0.000 |
| (13,0) | 1.032 | 1395 | 349.25 | 0.223 | 0.367 | 0.301 |
| (12,2) | 1.041 | 1377 | 4.88 | 0.003 | 0.005 | 0.004 |
| (10,5) | 1.050 | 1256 | 3.49 | 0.000 | 0.000 | 0.000 |
| (14,0) | 1.111 | 1295 | 261.47 | 0.248 | 0.409 | 0.334 |
| (13,2) | 1.12 | 1307 | 500.24 | 0.437 | 0.719 | 0.589 |
| (12,4) | 1.145 | 1458 | 4240.89 | 3.692 | 6.073 | 4.979 |
| (14,1) | 1.153 | 1502 | 1268.02 | 0.881 | 1.449 | 1.188 |
| (13,3) | 1.17 | 1498 | 1980.51 | 1.299 | 2.136 | 1.752 |
| (12,5) | 1.201 | 1499 | 1421.39 | 1.002 | 1.648 | 1.351 |
| (15,1) | 1.232 | 1426 | 3880.16 | 2.786 | 4.583 | 3.757 |
| (14,3) | 1.248 | 1447 | 5554.95 | 2.806 | 4.615 | 3.784 |

* Semiconducting (n,m) tubes with relative abundance more than 3% are marked in bold, including (9,7), (10,6), (9,8), (10,9), (12,4), (15,1) and (14,3).

The relative abundance of individual semiconducting (n,m) tubes by the equation (5) was recalculated using the reconstructed absorption E^{S}₁₁ peak area from each (n,m) tube, and results are also listed in TABLE 5.

$$RA ( n , m ) = \frac{{Area ( n , m )}_{Abs}^{Fitted}}{\sum {Area ( n , m )}_{Abs}^{Fitted}} \times 100 \% \qquad ( 5 )$$

Next, the absorbance spectra belonging to the E^{S}₂₂ transition of semiconducting SWCNTs and E^{M}₁₁ transition of metallic SWCNTs between 500 nm and 935 nm were reconstructed.

There are two issues related to the reconstruction. First, the theoretical absorption intensity W^{abs}_{cal} (n,m) for E^{S}₂₂ transition is currently unavailable. Second, the E^{M}₁₁ transition of metallic SWCNTs overlaps with the E^{S}₂₂ transition of semiconducting SWCNTs in the same spectra range. In order to obtain an estimation of abundance for all (n,m) tubes in the SWCNT sample, the following protocol to address these two issues was proposed. Firstly, from the study of Popov et al. (Popov et al., Phys. Rev. B: Condens. Matter 2005, 72, 035436), the absorption matrix element patterns for the E^{S}₁₁ and E^{S}₂₂ transitions are similar, thus the theoretical absorption intensity W^{abs}_{cal} (n,m) of E^{S}₁₁ was directly used to approximate the theoretical absorption intensity of E^{S}₂₂. Secondly, a two-step reconstruction procedure was used to separate the contribution of semiconducting SWCNTs from metallic SWCNTs.

In the first step, the relative contribution to OD among each semiconducting (n,m) tubes was assumed to be similar in both E^{S}₁₁ and E^{S}₂₂ transitions, thus the A (n,m) values from E^{S}₁₁ transitions in TABLE 5 were used to reconstruct major E^{S}₂₂ peaks first. As shown in FIG. 11C, the reconstructed spectrum matched well with the experimental data, especially for larger diameter tubes with E^{S}₂₂ absorption above 800 nm. There is some overestimation for smaller diameter tubes between 700 nm and 800 nm, suggesting the abundance of small diameter tubes could be less than what predicts by PL analysis. The relative abundance of individual semiconducting (n,m) tubes was calculated again by the equation (5) using their reconstructed absorption E^{S}₂₂ peak area, and results are listed in TABLE 6.

TABLE 6
Parameters used to reconstruct E^{S}₂₂ absorption spectra of
semiconducting SWCNTs. The relative abundance (semi) is
calculated based on the reconstructed absorbance E^{S}₂₂ peak area
of each semiconducting (n, m) tube. For all semiconducting
SWCNTs, E^{S}₂₂ reconstruction, C₁ = 22 and C₂ = 120.

| | | | | | | RA |
|---|---|---|---|---|---|---|
| | Diameter | E | | | | (n, m) |
| (n, m) | dₜ | (n, m) | | A | | (%) |
| index | (nm) | (nm) | W_{abs}^{cal} | (n, m) | Area | (semi) |
| (7, 3) | 0.706 | 505 | 1.65 | 456.86 | 0.082 | 0.336 |
| (6, 5) | 0.757 | 565 | 1.85 | 578.19 | 0.162 | 0.663 |
| (7, 5) | 0.829 | 645 | 2.04 | 226.99 | 0.068 | 0.278 |
| (8, 4) | 0.84 | 594 | 1.77 | 479.82 | 0.139 | 0.569 |
| (7, 6) | 0.895 | 648 | 1.98 | 345.45 | 0.104 | 0.426 |
| (8, 6) | 0.966 | 718 | 2.18 | 196.64 | 0.059 | 0.241 |
| (8, 7) | 1.032 | 728 | 2.06 | 1440.63 | 0.436 | 1.784 |
| (9, 7) | 1.103 | 799 | 2.22 | 7085.91 | 2.126 | 8.700 |
| (10, 6) | 1.111 | 754 | 2.03 | 4327.77 | 1.434 | 5.868 |
| (9, 8) | 1.17 | 816 | 2.14 | 33875.07 | 10.094 | 41.305 |
| (10, 8) | 1.24 | 865 | 2.16 | 2264.40 | 0.646 | 2.643 |
| (10, 9) | 1.307 | 878 | 2.22 | 6266.74 | 1.101 | 4.505 |
| (8, 3) | 0.782 | 665 | 2.43 | 937.10 | 0.319 | 1.305 |
| (10, 0) | 0.794 | 537 | 1.59 | 1445.27 | 0.28 | 1.146 |
| (11, 0) | 0.873 | 745 | 2.69 b | 1953.44 | 0.744 | 3.044 |
| (10, 2) | 0.884 | 740 | 2.67 | 1275.88 | 0.481 | 1.968 |
| (11, 1) | 0.916 | 610 | 1.73 | 40.69 | 0 | 0.000 |
| (9, 4) | 0.916 | 722 | 2.27 | 598.32 | 0.193 | 0.790 |
| (10, 3) | 0.936 | 632 | 1.80 | 937.10 | 0.233 | 0.953 |
| (9, 5) | 0.976 | 672 | 1.88 | 3.66 | 0 | 0.000 |
| (12, 1) | 0.995 | 799 | 2.42 | 937.47 | 0.318 | 1.301 |
| (11, 3) | 1.014 | 793 | 2.53 | 601.84 | 0.214 | 0.876 |
| (13, 0) | 1.032 | 677 | 1.86 | 349.25 | 0.092 | 0.376 |
| (12, 2) | 1.041 | 686 | 1.87 | 4.88 | 0.001 | 0.004 |
| (10, 5) | 1.050 | 788 | 2.33 | 3.49 | 0 | 0.000 |
| (14, 0) | 1.111 | 859 | 2.74 | 261.47 | 0.097 | 0.397 |
| (13, 2) | 1.12 | 858 | 2.52 | 500.24 | 0.17 | 0.696 |
| (12, 4) | 1.145 | 855 | 2.57 | 4240.89 | 1.476 | 6.040 |
| (14, 1) | 1.153 | 753 | 2.10 | 1268.02 | 0.377 | 1.543 |
| (13, 3) | 1.17 | 764 | 1.98 | 1980.51 | 0.554 | 2.267 |
| (12, 5) | 1.201 | 793 | 2.13 | 1421.39 | 0.425 | 1.739 |
| (15, 1) | 1.232 | 920 | 2.10 | 3880.16 | 0.828 | 3.388 |
| (14, 3) | 1.248 | 920 | 2.10 | 5554.95 | 1.185 | 4.849 |

Comparing the relative abundance of individual semiconducting tubes obtained from E^{S}₁₁ and E^{S}₂₂ reconstruction, no significant differences are observed. This supports our approach of using A (n,m) values from E^{S}₁₁ transitions to reconstruct major E^{S}₂₂ peaks first.

In the second step, the contribution of semiconducting tubes (the spectrum reconstructed by semiconducting SWCNTs only) was subtracted from the overall E^{M}₁₁+E^{S}₂₂ absorbance spectrum. Then, the remaining peaks of the absorbance spectrum (mostly between 500 nm and 800 nm) were reconstructed with possible metallic tubes. The metallic tubes are either identified in Raman analysis or tubes with similar diameters of major semiconducting tubes. All metallic tubes identified are listed in TABLE 7. The E (n,m) values of metallic tubes were obtained from the study by Maultzsch et al. (Maultzsch et al., Phys. Rev. B: Condens. Matter, 2005, 72, 205438). Their theoretical absorption intensity W^{abs}_{cal} (n,m) is currently not available the average value (2.155) of all semiconducting tubes identified in this study was used as an approximation for all metallic tubes. Similar to the reconstruction of E^{S}₁₁ spectrum, the relative contribution (A(n,m)) of individual metallic tubes to the OD was then calculated using equation (2). The reconstructed spectrum is shown in FIG. 11C. The reconstructed E^{M}₁₁ absorbance peak area of each metallic (n,m) tube was listed in TABLE 7. Finally, we calculated the relative abundance of both semiconducting and metallic tubes together using their respective E^{S}₁₁ and E^{M}₁₁ peak areas. The results are listed in TABLES 5 and 7.

TABLE 7
Parameters used to reconstruct E^{M}₁₁ absorption spectra of metallic
SWCNTs. The relative abundance (semi + met) is calculated
based on the reconstructed absorbance E^{S}₁₁ peak area of each
semiconducting (n, m) tube and E^{M}₁₁ peak area of each
metallic (n, m) tube. For all metallic SWCNTs E^{M}₁₁
reconstruction, fitting factors C₁ = 8.2 and C₂ = 160.

| | | | | | | RA |
|---|---|---|---|---|---|---|
| | | | | | | (n, m) |
| | Diameter | E | | | | (%) |
| (n, m) | dt | (n, m) | | | | (semi + |
| index | (nm) | (nm) | W_{abs}^{cal} | A (n, m) | Area | met) |
| (10, 1) | 0.825 | 527.7 | 2.155 | 762.26 | 0.9303 | 1.254 |
| (12, 0) | 0.940 | 568.8 | 2.155 | 245.62 | 0.32161 | 0.434 |
| (11, 2) | 0.950 | 558.6 | 2.155 | 680.95 | 0.88426 | 1.192 |
| (10, 4) | 0.978 | 553.6 | 2.155 | 594.22 | 0.76762 | 1.035 |
| (9, 6) | 1.024 | 551.1 | 2.155 | 1928.00 | 2.48327 | 3.349 |
| (13, 1) | 1.060 | 602.8 | 2.155 | 337.76 | 0.44907 | 0.606 |
| (12, 3) | 1.077 | 599.0 | 2.155 | 601.34 | 0.79858 | 1.077 |
| (8, 8) | 1.085 | 556.1 | 2.155 | 941.81 | 1.21995 | 1.645 |
| (11, 5) | 1.111 | 596.2 | 2.155 | 245.62 | 0.32588 | 0.439 |
| (10, 7) | 1.159 | 599.9 | 2.155 | 372.66 | 0.49503 | 0.668 |
| (15, 0) | 1.175 | 649.9 | 2.155 | 1317.86 | 1.76728 | 2.383 |
| (14, 2) | 1.183 | 641.2 | 2.155 | 37.27 | 0.04992 | 0.067 |
| (13, 4) | 1.206 | 639.2 | 2.155 | 37.27 | 0.04991 | 0.067 |
| (9, 9) | 1.221 | 613.9 | 2.155 | 37.27 | 0.04969 | 0.067 |
| (12, 6) | 1.244 | 642.5 | 2.155 | 40.65 | 0.05447 | 0.073 |
| (11, 8) | 1.294 | 646.8 | 2.155 | 308.29 | 0.41328 | 0.557 |
| (10, 10) | 1.357 | 659.6 | 2.155 | 1712.88 | 2.29919 | 3.100 |

* Metallic (n, m) tubes with relative abundance more than 3% are marked in bold, including (9, 6) and (10, 10).

The thin Lorentzian peaks (black) in FIG. 11B are from the contribution of individual semiconducting tubes, calculated by using the electron-phonon interaction model. Tubes with major contributions are marked with their (n,m) indexes. The thick solid line depicts the sum of all Lorentzian lines, and red circles are experimental data points. FIG. 11C shows the E₁₁^{M} and E₂₂^{S} spectral reconstruction by the summation of the contribution from both semiconducting (black) and metallic (grey) SWCNTs. Other than (n,m) tubes identified in Raman and PL, FIG. 11B and FIG. 11C show a few additional peaks identified in absorption spectra, including semiconducting (12,4), (14,3), and (15,1) and metallic (9,6) and (10,10). Using the contribution from each (n,m) tube obtained in reconstructing the absorbance spectrum, their relative abundance of (n,m) tubes is shown in FIG. 11D. It indicates that the dominant semiconducting tubes identified in PL have much higher abundance as compared to additional metallic tubes identified in absorption spectroscopy. Overall, the abundance of (9,8) tubes is 33.5%, followed by (9,7) at 7.1%. This further corroborates that the CoSO₄/SiO₂ catalyst is highly selective toward the (9,8) tube.

### Example 8.4

### TGA (Embodiment 2)

TGA was used to determine the yield of carbon species. As-synthesized SWCNTs together with catalyst substrates were characterized in TGA using a PerkinElmer Diamond TG/DTA Instruments. In a typical TGA, about 2 mg of the sample was loaded in an alumina pan. The sample was first heated to 200° C. and held at 200° C. for 10 min under airflow (200 sccm) to remove moisture. Afterward, its temperature was continuously increased from 200° C. to 1000° C. at a 10° C./min rate. The weight loss of the sample was monitored and recorded as a function of the temperature. The same procedure was repeated after the sample was cooled to room temperature to obtain the second weight-temperature curve for baseline correction.

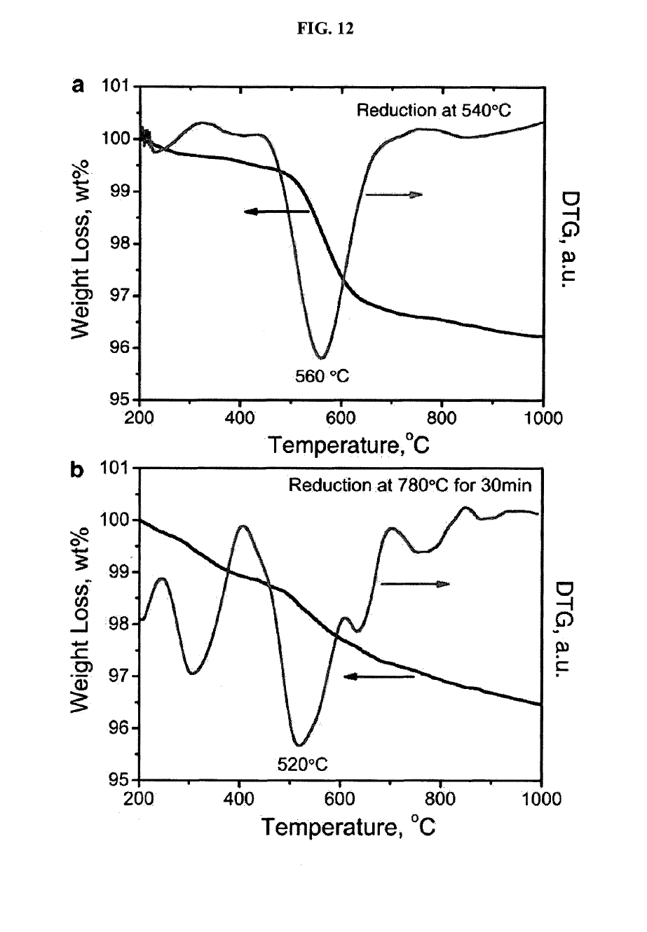

TGA was used to determine the yield of carbon species. FIG. 12 shows the TG and differential TG (DTG) profiles of carbon deposits on catalysts after two reduction conditions. The total carbon yields (the weight loss between 200° C. and 1000° C.) are 3.8 wt % and 3.5 wt % for the 540° C. and 780° C. reduction, respectively. The Co loading on the SiO₂ substrate is about 1 wt %, thus the CoSO₄/SiO₂ catalyst has the carbon/metal ratio of 3.8. On the basis of the Raman spectroscopy results shown in FIG. 9A, the dominant DTG peak at 560° C. in FIG. 12A can be attributed to the oxidation of SWCNTs, which counts for more than 90% of the total carbon deposits based on the integrated peak areas. There are multiple DTG peaks of different carbon species in FIG. 12B. The peak around 300° C. can be credited to the oxidation of amorphous carbon. The peak at 520° C. is contributed by SWCNTs. The peak above 800° C. may come from the oxidation of graphite layers covering large Co particles.

### Example 8.5

### TEM and AFM (Embodiment 2)

The diameter of SWCNTs was also analyzed by TEM and AFM. TEM images of as-synthesized SWCNTs were recorded on a Philips Tecnai 12 microscope. SWCNT suspensions were dropcast on mica surfaces to form nanotube networks. AFM images of nanotubes were recorded on a MFP3D microscope (Asylum Research, Santa Barbara, Calif.) with a cantilever (Arrow NC, Nanoworld) operating in the tapping mode.

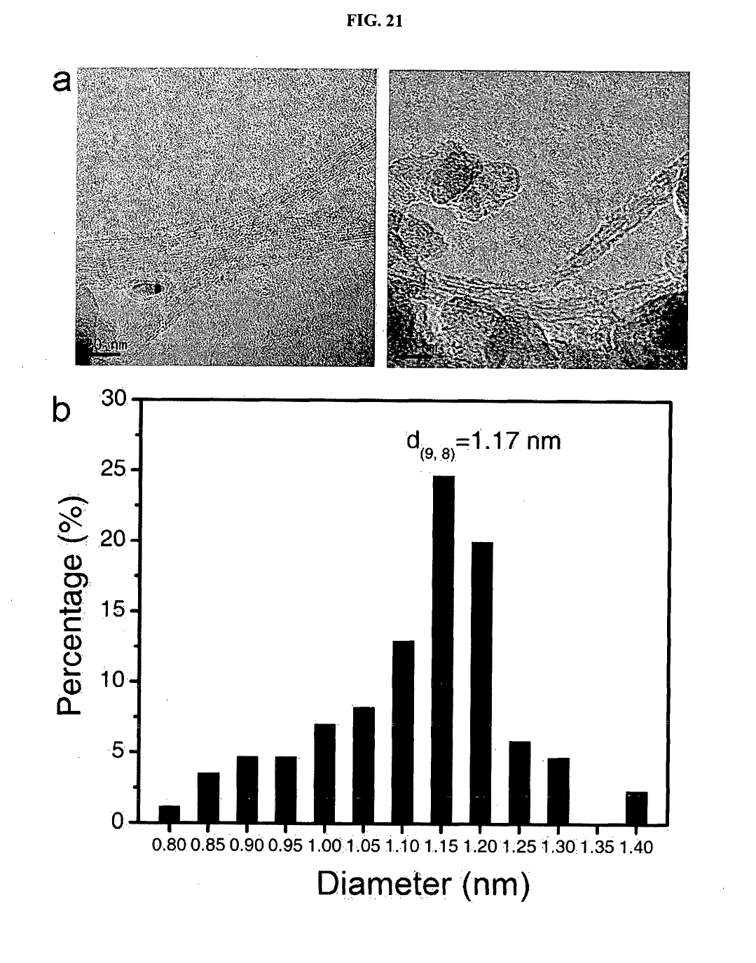

As shown in FIG. 21, the diameter of 45% tubes among about 100 measured ones is between 1.15 nm and 1.20 nm. Similarly, FIG. 22 shows the height profiles of individual nanotubes deposited on the mica surface with a height of about 1.2 nm. Both TEM and AFM results agree with spectroscopic results. The carbon yield is an important criterion for evaluating catalysts used in SWCNT growth. It is necessary to achieve not only good chiral selectivity but also adequate nanotube yield so that scalable production process can be further developed.

### Example 9

### Catalyst Characterization (Embodiment 2)

The morphology, physical, and chemical properties of the CoSO₄/SiO₂ catalyst were evaluated by SEM, TEM, XRD, nitrogen physisorption, UV-vis-diffuse reflectance Spectroscopy (UV-vis-drs), H₂-TPR, and element analysis.

### Example 9.1

### SEM and TEM Analysis (Embodiment 2)

To better understand the CoSO₄/SiO₂ catalyst, morphology of the catalyst was analysed using SEM and TEM. SEM images were obtained by using JEOL field-emission SEM (JSM-6701F) at 5 kV. TEM images were recorded on the Philips Tecnai 12 microscope. The solid samples were first dispersed in anhydrous ethanol by bath sonication for 30 min, and then one drop of the suspension was applied to a TEM grid covered with holey carbon film.

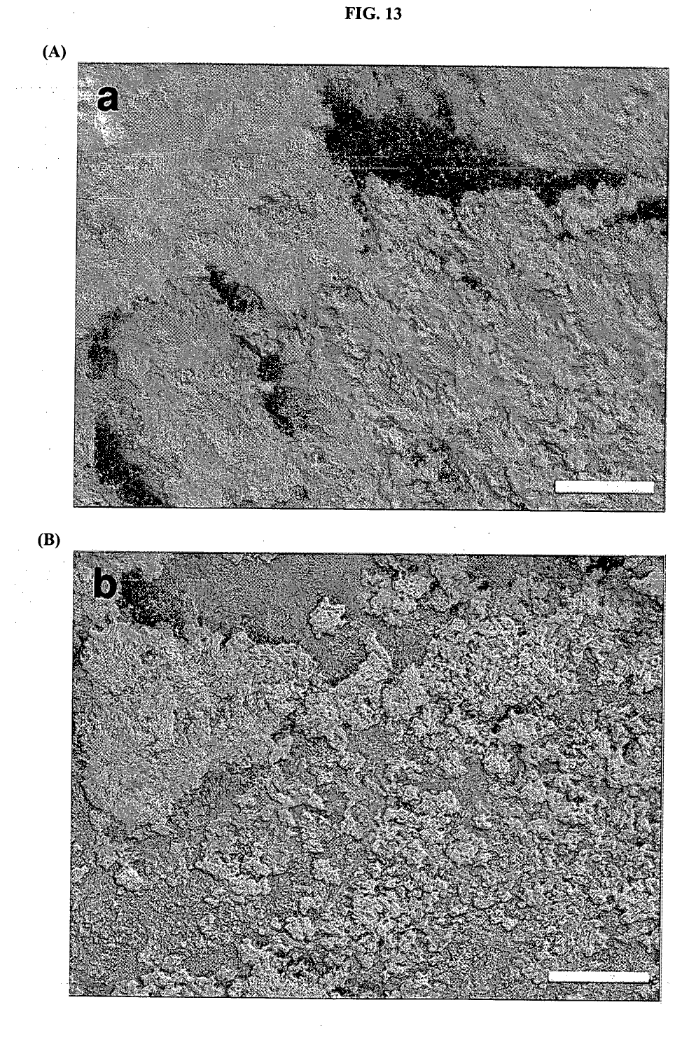

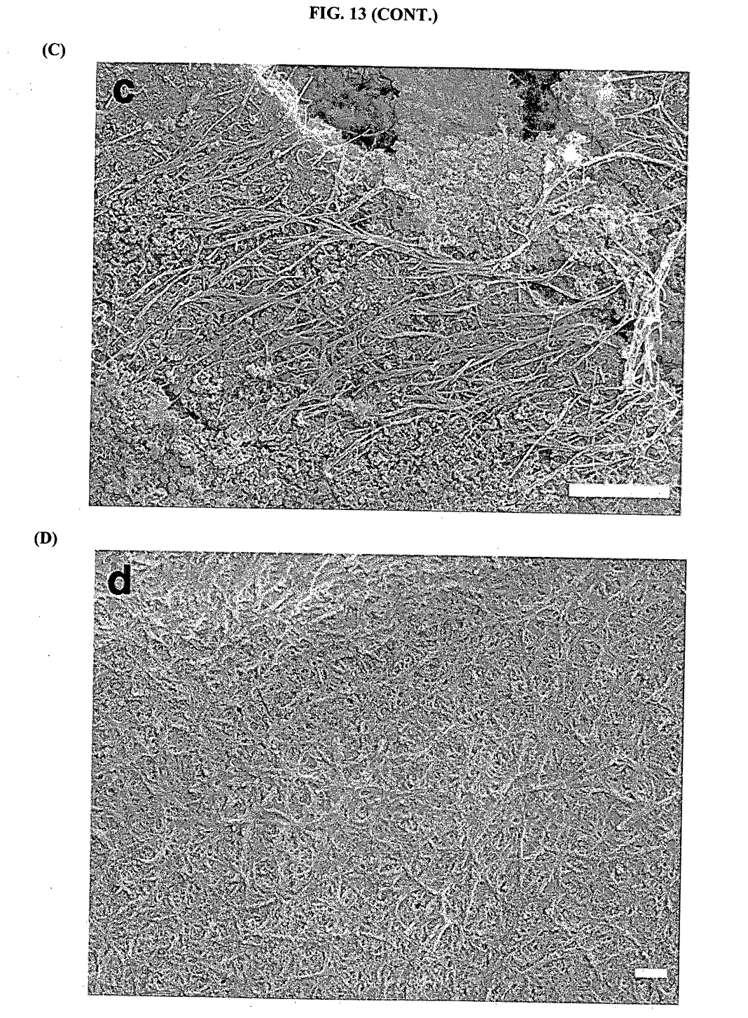

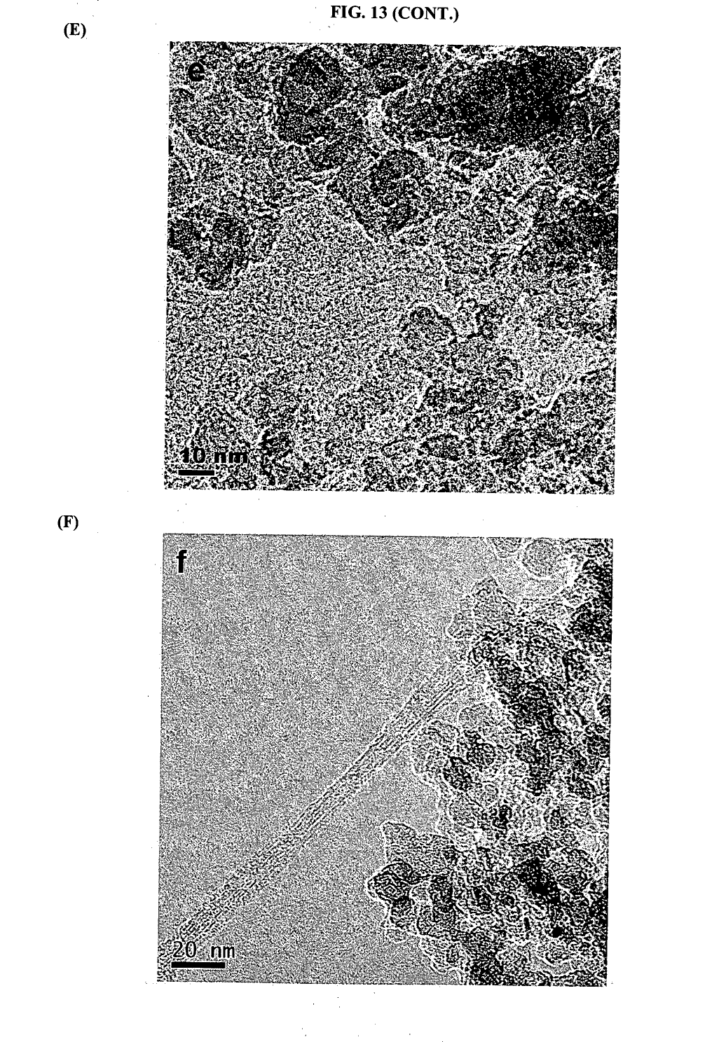

FIG. 13A shows that fresh catalyst is composed of small SiO₂ particles. FIG. 13E indicates that the size of these solid SiO₂ particles is around 20 nm. They aggregate together to form a porous composite. After catalyst reduction at 540° C. and SWCNT growth, the catalyst shows no noticeable morphological changes (see FIG. 13B and FIG. 13C). This is because the fumed SiO₂ particles are produced by the flame hydrolysis of chlorosilanes at high temperature, and they are usually stable after high-temperature treatments. FIG. 13C shows a large amount of SWCNTs on the surface of aggregated SiO₂ particles. FIG. 13F indicates that SWCNTs grow from Co particles on/in SiO₂ particles and aggregate together into small bundles of 10 nm to 20 nm in diameter. Very few Co particles can be easily observed in TEM analysis of the catalysts after temperature was reduced to 540° C. or after SWCNT growth. It was postulated that Co particles could be embedded under or near the surface of SiO₂ particles. This also suggests that Co species are well-dispersed on SiO₂ particles. After SWCNT growth, SiO₂ particles can be easily dissolved by refluxing in NaOH aqueous solution. FIG. 13D shows dense SWCNT networks on filter paper after SiO₂ removal.

### Example 9.2

### XRD Measurement (Embodiment 2)

The physicochemical properties of the catalyst were further characterized by XRD, nitrogen physisorption, UV-vis spectroscopy, and H₂-TPR. XRD measurement of CoSO₄/SiO₂ catalyst powders was carried out on a Bruker Axs D8 X-ray diffractometer (Cu KR, λ=0.15, 4 nm, 40 kV, 30 mA).

Nitrogen adsorption-desorption isotherms of the catalyst were measured at 77 K using a Quantachrome Autosorb-6b static volumetric instrument. Prior to the physisorption analysis, samples were degassed at 250° C. under high vacuum (<0.01 mbar). The specific surface area was calculated by the Brunauer, Emmet, and Teller (BET) method. The pore size and pore size distribution were calculated by the Barrett, Joyner, and Halenda (BJH) method using the desorption branch of the isotherms.

UV-vis diffuse reflectance spectra of the CoSO₄/SiO₂ catalyst and several references, such as Co₃O₄ (Aldrich), CoSO₄ (Aldrich), and fumed silica (SiO₂), were recorded on the Varian Cary 5000 spectrophotometer. The samples were first dried at 100° C. for 3 h, and then UV-vis spectra were recorded in the range of 200 nm to 800 nm with BaSO₄ as a reference.

The reducibility of calcined catalysts was characterized by H₂-TPR equipped with a thermal conductivity detector (TCD) of a gas chromatography (Techcomp 7900). Two-hundred milligrams of the catalyst or reference samples with equivalent Co loadings was loaded into a quartz cell. CoO, Co₃O₄, and CoSO₄ (Sigma-Aldrich) were used as reference samples in TPR analysis. H₂ (5%) in Ar was introduced to the quartz cell at 30 sccm. Pure Ar gas was used as a reference for the TCD. After the TCD baseline was stable, the temperature of the quartz cell was increased to 950° C. at 5° C./min and then held at 950° C. for 30 min. An acetone-liquid N₂ trap was installed between the quartz cell and the TCD to condense water or H₂S produced during the catalyst reduction.

The weight concentration of sulphur in the catalysts at different reduction conditions was determined by an Elementarvario CHN elemental analyzer. Around 5 mg of each treated catalyst was used for each test, and at least three samples from each treatment condition were measured to obtain the mean value.

FIG. 14A shows a broad diffraction peak near 2θ=21° originating from SiO₂ supports, suggesting the absence of Co oxides (CoOₓ) or bulk Co silicates. FIG. 14B shows that the catalyst is a porous material with a pore size around 32 nm. The pores are likely the gaps among SiO₂ particles in the catalyst aggregate. It has a surface area of 208 m²/g and a large pore volume of 1.54 mL/g. UV-vis spectra in FIG. 14C designate the local environment of Co species on SiO₂. Similar to the pure CoSO₄, the catalyst shows a broad peak ascribed to the ⁴T_{1g}→⁴T_{1g}(P) transition of octahedral Co²⁺ ions. In contrast to Co₃O₄, the catalyst does not have absorption peaks at 410 nm and 710 nm. This is also different from the UV-vis spectrum of the Co-TUD-1 catalyst, which displays a minor peak shoulder at 660 nm and two broad peaks at 410 nm and 710 nm, pointing to the existence of tetrahedral Co²⁺ and octahedral Co⁺ ions.

The H₂-TPR profile of the catalyst in FIG. 14D shows a sharp reduction peak centered at 470° C. This is different from common CoOₓ catalysts, which are usually reduced below 400° C., as sketched by the two CoOₓ references (CoO and Co₃O₄). In comparison, pure CoSO₄ powder is reduced at 584° C., suggesting that the reduction peak at 470° C. is credited to the reductive decomposition of highly dispersed CoSO₄. These results show that the CoSO₄/SiO₂ catalyst has unique physicochemical properties, as compared with other Co catalysts, with a very narrow Co reduction window. The narrow reduction window suggests that Co particles with a narrow size distribution may have been formed.

### Example 10

### XAS Characterization and Analysis (Embodiment 2)

Previous experimental and theoretical studies predict a linear correlation between catalyst particle size and SWCNT diameter with their ratio ranging from 1.1 to 1.6. The (9,8) tubes at 1.17 nm produced after catalyst reduction at 540° C. suggest that catalytic particles have a narrow diameter distribution around 1.29 nm to 1.87 nm.

To verify this hypothesis, catalysts using XAS were investigated. XAS was used here because most small Co particles are under the surface of SiO₂ particles, and it is difficult to quantify their diameters by TEM. The XAS spectra at the Co K-edge were recorded at the Beamline X18B at Brookhaven National Laboratory, USA. Three ex situ samples were measured, including the fresh CoSO₄/SiO₂ catalyst, the catalyst after SWCNT growth by reduction at 540° C., and a Co metal foil.

For catalyst samples, catalyst fine powder was pressed at about 2 tons into a round self-supporting wafer (1.5 cm in diameter) using a hydraulic pellet press to reach the optimum absorption thickness (Δμx≈1.0, Δμ is the absorption edge, x is the thickness of the catalyst wafer). Spectra were collected in a transmission mode at room temperature by scanning from 200 below the Co K-edge to 1000 eV above the Co K-edge using gas-filled ionization chamber detectors. The monochromator of this beamline was a double-crystal Si(111) with an energy resolution of approximately 0.2 eV. The XANES spectra at the sulfur K-edge were recorded at the Beamline X15B.

Four catalyst samples after different treatment conditions were measured. CoSO₄.7H₂O and CoS were used as references. The sample powder was brushed onto a thin strip of sulfur-free kapton tape, uncovered, facing the beam at 45°. Spectra were collected in a fluorescence mode at room temperature with the energy range of 2460 eV to 2500 eV with the step of 0.2 eV. Pure sulphur was used to calibrate the Si(111) monochromator.

The XAS experimental data at the Co K-edge were analyzed using the IFEFFIT program in three steps. (1) The XAS function (χ) was obtained by subtracting the post-edge background, and then normalized with respect to the edge jump step. (2) The normalized (E) was transferred from energy space to photoelectron wave vector k-space. The χ(k) data were multiplied by k² to compensate for the damping of oscillations in the high k-region. Then the k²-weighted χ(k) data ink-space ranging from 2 Å⁻¹ to 12.5 Å⁻¹ for the Co K-edge were Fourier transformed to r-space to separate the contribution from the different coordination shells. (3) The spectra in the r-space between 1.1 Å and 3.35 Å were fitted using paths of metallic Co generated by the FEFF 9 to obtain parameters, including the first shell coordination number (N_{Co—Co}), bond distance (R), and the Debye-Waller factor (Δσ²).

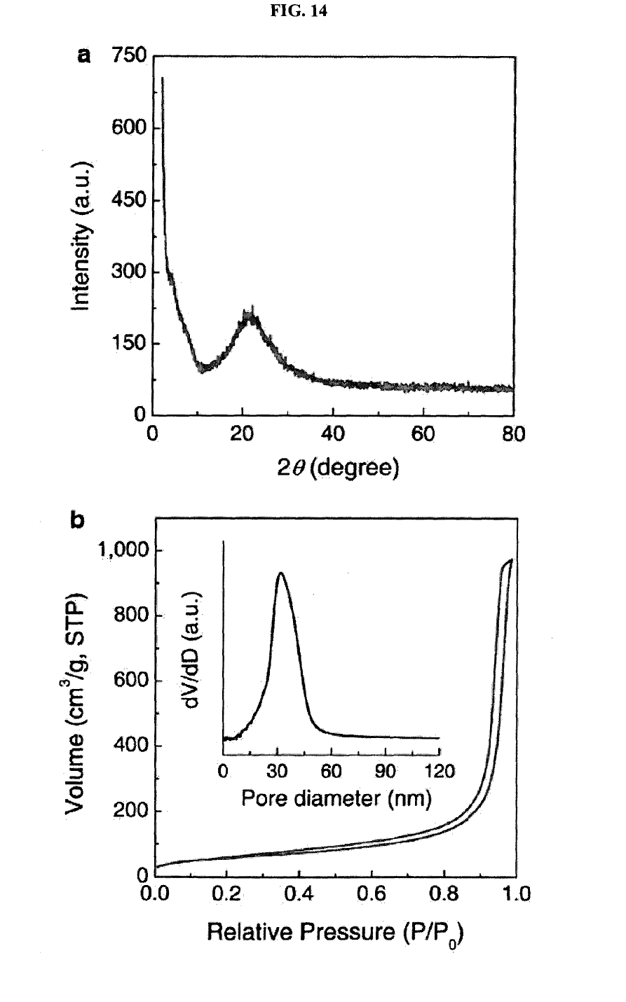

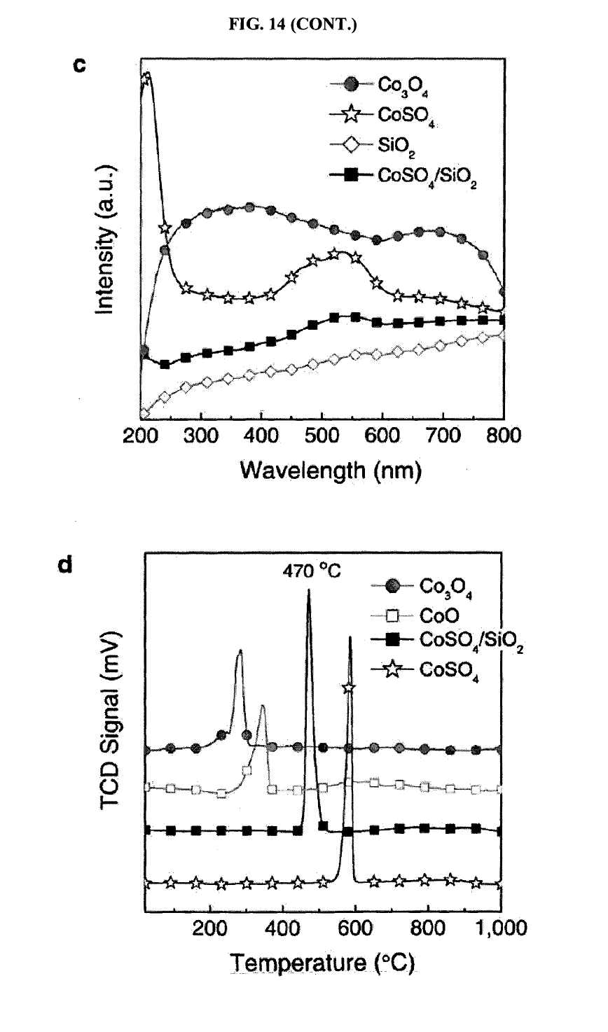

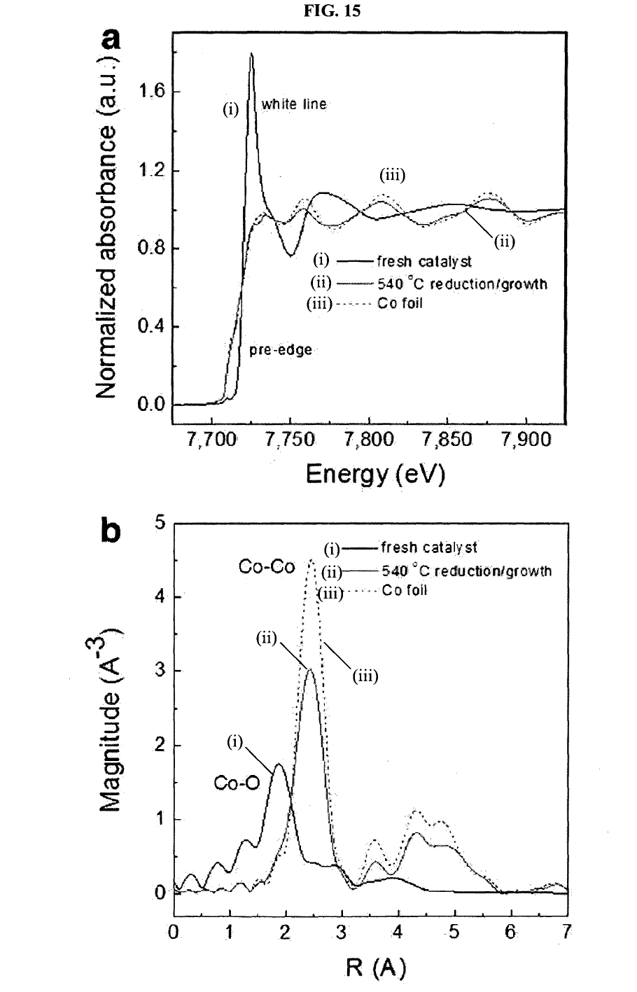

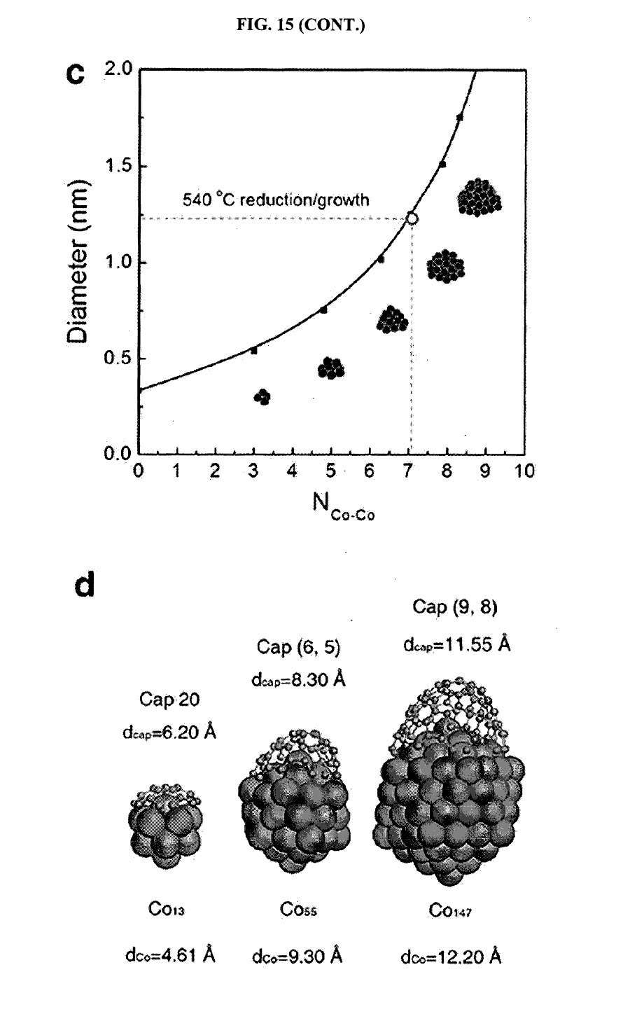

The near-edge spectra (XANES) at the Co K-edge in FIG. 15A show that Co atoms in the fresh catalyst are oxidized with a strong white line peak. After H₂ reduction and SWCNT growth, the white line is reduced together with the appearance of a strong pre-edge peak, showing the formation of metal Co particles. The extended X-ray absorption fine structure (EXAFS) of catalysts was Fourier transformed to r-space to separate the contribution from different coordination shells of Co atoms. FIG. 15B shows that the fresh catalyst has a strong Co—O peak, while the reduced catalyst after SWCNT growth has an intense Co—Co peak. The spectrum in the r-space was fitted using paths of metallic Co generated by the FEFF 9 program to obtain the first shell coordination number (N_{Co—Co}), listed in TABLE 8.

TABLE 8
Structure Parameters of the First Co—Co Coordination Shell
in Catalyst Determined from the EXAFS Data (FIG. 15B)
at the Co K-Edge by Fitting Using FEFF 9.

| | Co—Co first shell fitting results | | |
|---|---|---|---|
| Catalysts | N_{Co—Co} | dR(\acute{Å}) | Δσ² |
| 540° C. | 7.04 ± 0.86 | −0.016 ± 0.007 | 0.007 |

The catalyst reduced at 540° C. after SWCNT growth has a N_{Co—Co} of 7.04. The difference in bond distances with respect to the theoretical references (dR) is −0.016. The Debye-Waller factor (Δσ²) is 0.007, indicating that the fit is within acceptable limits. The first shell coordination number of nanoparticles is a nonlinear function of particle size, which has been used to quantify the nanoparticle size. Using a (111)-truncated hemispherical cubic octahedron model, FIG. 15C shows that the average size of Co particles produced after catalyst reduction at 540° C. is 1.23 nm, which matches the diameter of (9,8) tubes.

### Example 11

### Simulation of Coₙ Particles Embodiment 2

The structures of a series of Coₙ (n=2, 3, 5, 13, 55, and 147) particles were fully relaxed to optimize without any constraint. All spin-polarized computations were performed with the Perdew-Burke-Ernzerhof (PBE) exchange correlation function using the VASP code. The interaction between an atomic core and electrons was described by the projector-augmented wave method. The plane-wave basis set energy cutoff was set to 400 eV. Periodic boundary conditions were implemented with at least 1 nm vacuum to preclude interactions between a cluster and its images. Simulation boxes were 22×22×C Å (where C is from 20 to 24 Å) for different calculated systems. The reciprocal space integration was performed with a 1×1×1 k-point mesh for all calculated systems with discrete characters.

On the basis of previous studies, Co particles with icosahedral structures are lower in energy than other structures. Co₁₃, Co₅₅, and Co₁₄₇ adopt the icosahedral geometry. Co₁₃ has one atom at the center and the other 12 identical atoms on the spherical shell surface with a coordination number of 6. The distance between the spherical shell and the central atom is 2.32 Å. The surface bond length is 2.44 Å. From the Co₁₃ icosahedral structure, the Co₅₅ was built by adding 30 atoms on the edge atoms of Co₁₃ with a coordination of 8, and additional 12 atoms on the vertex atoms of Co₁₃ with a coordination number of 6. Using the same methodology, Co₁₄₇ was built by adding 80 atoms on the edge atoms of Co₅₅ with a coordination of 8, and additional 12 atoms on the vertex atoms of Co₅₅ with a coordination number of 6. Their diameters successively increase from about 0.46 nm to about 0.93 nm and 1.22 nm, respectively. The geometrical structure of these three clusters is illustrated in FIG. 15D. Co2, Co₃, Co₅ clusters, and Co-bulk has also been calculated as references.

### Example 12

### Discussion (Embodiment 2)

The result in this work was compared with a number of previous SWCNT chiral selectivity growth studies, as listed in TABLE 9.

TABLE 9
Comparison of (n, m) selectivity and carbon yield among several
reported chiral selective growth studies.

| | | | Carbon yields |
|---|---|---|---|
| | | Reported chiral | (over the total |
| | Dominant | selectivity | catalyst weight |
| | (n, m) | (characterization | including catalyst |
| Catalysts | species | methods used) | substrates) |
| Co-MCM-41^{9,10} | (7, 5) | 45% (PL) | 4 wt % |
| Co—Mo CAT¹¹ | (6, 5), (7, 5) | two together 62% | didn't report |
| | | (PL) | |
| Fe/Co-zeolite¹² | (6, 5), (7, 5) | no quantitive data | didn't report |
| Fe—Ni¹³ | (8, 4) | no quantitive data | didn't report |
| Fe—Ru¹⁴ | (6, 5) | similar to Co—Mo | didn't report |
| | | CAT | |
| Au catalysts¹⁵ | (6, 5) | no quantitive data | didn't report |
| Fe—Cu¹⁶ | (6, 5) | no quantitive data | didn't report |
| Co/Pt¹⁷ | (6, 5) | 30% (PL) | didn't report |
| Co—Mn- | (6, 5) | 47.4% (PL) | 11 wt % |
| MCM41¹⁸ | | | |
| Co—Cr-MCM- | (6, 5) | 30.9% (PL) | 6.3 wt % |
| 41¹⁹ | | | |
| Ferrocene + | (13, 12), | 30% | didn't report |
| NH₃²⁰ | (12, 11), | | |
| | (13, 11) | | |
| Co-TUD-1²¹ | (9, 8) | 59.1% (PL) | 1.5 wt % |
| This work | (9, 8) | 51.7% (PL) | 3.8 wt % |

Numerals 9-21 in the table denote:-
⁹Chen, Y. et al., J. Catal. 2004, 226, 351-362.
¹⁰Wei, L. et al., J. Phys. Chem. B 2008, 112, 2771-2774.
¹¹Bachilo, S. M. et al, J. Am. Chem. Soc 2003, 125, 11186-11187.
¹²Miyauchi, Y. et al., Chem. Phys. Lett. 2004, 387, 198-203.
¹³Chiang, W. H. et al., Nature Mater. 2009, 8, 882-886.
¹⁴Yao, Y. G. et al., Nature Mater. 2007, 6, 283-286.
¹⁵Ghorannevis, Z. et al., J. Am. Chem. Soc 2010, 132, 9570-9572.
¹⁶He, M.; Chernov, A. I. et al., J. Am. Chem. Soc. 2010, 132, 13994-13996.
¹⁷Liu, B. L. et al., Chem. Commun. 2012, 48, 2409-2411.
¹⁸Loebick, C. Z. et al., J. Phys. Chem. C 2009, 113, 21611-21620.
¹⁹Zoican Loebick, C. et al., Appl. Catal., A 2009, 368, 40-49.
²⁰Zhu, Z. et al., J. Am. Chem. Soc. 2011, 133, 1224-1227.
²¹Wang, H. et al., J. Am. Chem. Soc. 2010, 132, 16747-16749.

Especially, compared to the Co-TUD-1 catalyst, which has similar chiral selectivity toward (9,8) tubes, the carbon yield of the CoSO₄/SiO₂ catalyst is more than twice that of the Co-TUD-1 catalyst (1.5 wt %). Moreover, it would take 3 days to synthesize the Co-TUD-1 catalyst through aging, drying, and hydrothermal treatments, while the CoSO₄/SiO₂ catalyst can be produced by impregnation within 12 hours.

Overall, the CoSO₄/SiO₂ catalyst formed by a method of the invention shows several advantages: firstly, it provides a unique single chiral selectivity toward a large diameter tube; secondly, this catalyst has an adequate SWCNT yield, which is important for scalable production of SWCNTs; and thirdly, it is easy to synthesize, as compared to many mesoporous catalysts.

It is interesting to note that the selectivity of the CoSO₄/SiO₂ catalyst is toward (9,8) tubes rather than some other chiral species. The tentative nature of the following explanation is emphasized on the chiral selectivity toward (9,8) tubes in the spirit of stimulating further exploration in understanding the chiral selection mechanism in SWCNT growth. Previous theoretical studies on the structure stability of Ni₂₋₅₅ and the electric dipole polarizability experimental study of Ni₁₂₋₅₈ and Ptₙ (n=13, 38, and 55) showed that some nanoparticles with optimized structures are more stable than others.

Using the method of previous studies, the structure of Co particles was investigated and it was found that the optimized stable Co₁₃, Co₅₅, and Co₁₄₇ particles adopt an icosahedral geometry. The detailed calculated results, including the average binding energy E_{b}, bond lengths from the central Co atom R_{Co-Cen}, and surface bond lengths R_{Co—Co}, are listed in TABLE 10.

TABLE 10
Calculated results of the average binding energy E_{b} (eV),
bond lengths from the central Co atom R_{Co-Cen} (Å),
and surface bond lengths R_{Co-Co} (in Å) for pure Coₙ clusters
(with n = 2, 3, 5, 13, 55, and 147), respectively.

| | Co₂ | Co₃ | Co₅ | Co₁₃ | Co₅₅ | Co₁₄₇ | Co-bulk |
|---|---|---|---|---|---|---|---|
| E_{b} | 1.88 | 2.24 | 2.99 | 3.67 | 4.54 | 4.81 | 5.57 |
| R_{Co-Cen} | | 1.38 | 3.06 | 2.31 | 2.38, | 6.08, | |
| | | | | | 4.03, | 6.21, | |
| | | | | | 4.71 | 7.09 | |
| R_{Co-Co} | 1.97 | 2.08, | 2.19, | 2.43 | 2.48, | 2.47, | 2.51 |
| | | 2.42 | 2.65 | | 2.49 | 2.51 | |

The results show that the average binding energies increase with the increase of Co cluster size. The minimum Co—Co binding energy (3.67 eV for Co₁₃) is higher than the binding energy of a Co₂ dimmer (1.88 eV), and the strongest Co—Co binding energy (4.81 eV for Co₁₄₇) is lower than the cohesive energy of the bulk Co (5.57 eV). The average interatomic distance also increases with the increase of the Co cluster size, varying between the bond distance of Co₂ dimmer (1.97 Å) and bulk Co (2.51 Å).

As depicted in FIG. 15D, the stable Co₁₃ and Co₅₅ particles are comparable with carbon caps (cap 20 and cap (6,5)) at diameters of 6.2 Å and 8.3 Å, respectively. Very small SWCNTs extended from the “cap 20” are unstable. Thus, they are seldom found in SWCNT products. The (6,5) tube matching with the Co₅₅ is the most common species found in a number of (n,m)-selective synthesis studies. By adding one complete atomic layer of Co atoms on the surface of Co₅₅, the Co₁₄₇ particle is more stable than other clusters in its diameter range. The cap (9,8) with a diameter of 11.55 Å fits well with the Co₁₄₇. There is a clear match between the most abundant (n,m) species (i.e., (6,5) and (9,8)) and the stable Co particles (i.e., C₅₅ and Co₁₄₇). The shift of (n,m) selectivity from the small-diameter (6,5) tube to the larger diameter (9,8) tube found in this study could be credited to the jump in the diameter of Co particles with optimized structures.

Even though previous chirality selective growth studies may be able to tune (n,m) selectivity to some extent, none of the methods are able to achieve continuous changes of (n,m) selectivity over a wider diameter range. This suggests that matching with stable catalytic particles may be a fundamental requirement governing the growth of SWCNTs. It highlights that the efforts in achieving chiral-selective synthesis of SWCNTs should focus on growing chiral tubes with diameters similar to the most stable particles in their size range under growth conditions, other than seeking selectivity to random chiral structures. It should also be noted that adsorption and diffusion of carbon species during SWCNT growth can cause the reconstruction of catalytic particles, which may also change the (n,m) selectivity to some extent. This may explain why tubes, such as (9,7), (10,6), and (10,9) near the main (9,8), are also produced. Moreover, the chiral angle dependent growth rate could also be the reason of growing the large chiral angle (9,8) tubes, rather than other (n,m) species at the same diameter with smaller chiral angles.

From the catalyst design perspective, a key task is to find out what components in the CoSO₄/SiO₂ catalyst are responsible for stabilizing Co particles which leads to the growth (9,8) tubes. Cobalt oxides (CoOₓ) are usually reduced below 400° C., leading to large Co particles, which are easily covered by graphite layers during SWCNT synthesis. On the other hand, Co incorporated in some mesoporous SiO₂ templates, such as MCM-41, or in cobalt silicates, is reduced at temperature above 700° C. They would form smaller Co particles, which are selective to smaller diameter tubes, such as (6,5) and (7,5). In our previous study of Co-TUD-1 catalyst, we proposed that Co species on the mesoporous TUD-1 can nucleate in two steps. First, Co²⁺ ions are partially reduced in H₂ during pre-reduction, but they are still dispersed in an isolated manner on the large surface of TUD-1. Second, Co atoms aggregate quickly into clusters under CO to initiate SWCNT growth. Co ions are incorporated into the amorphous silica walls of TUD-1, and the large surface area of TUD-1 and the strong metal_support interaction are sufficient in stabilizing these clusters with a narrow diameter distribution at around 1.2 nm, responsible for the growth of (9,8) nanotubes.

However, the structure of the CoSO₄/SiO₂ catalyst is very different from the Co-TUD-1: first, Co ions cannot be incorporated into solid SiO₂ particles by the impregnation method; secondly, the surface area of the CoSO₄/SiO₂ catalyst is much smaller (208 m²/g) as compared to TUD-1 (740 m²/g). Thus, the way the CoSO₄/SiO₂ catalyst controls the formation of Co particles is expected to be different from that of the Co-TUD-1.

Different Co precursors in catalyst synthesis, including cobalt (II) nitrate, cobalt (II) acetate, cobalt (II) acetylacetonate, and cobalt (III) acetylacetonate, were tested. None of the above Co precursors deposited on SiO₂ particles showed good selectivity toward (9,8) tubes. Thus, it is postulated that the narrow reduction peak of the CoSO₄/SiO₂ catalyst at 470° C. may be credited to the reduction of highly dispersed CoSO₄, following the chemical reaction eqs 1 and 2. The reduction of Co₃O₄ and CoO (chemical reaction eqs 3 and 4) was used as references to quantify the H₂ consumption in CoSO₄ reduction on the CoSO₄/SiO₂ catalyst.

Stoichiometric ratio of H₂ needed for reducing the same amount of Co ions in CoSO₄ over those in Co₃O₄ or CoO is 3.75-3 or 5-4, respectively. The integrated reduction peak area ratio between CoSO₄ and Co₃O₄ in FIG. 14D is 3.68, and the ratio between CoSO₄ and CoO is 4.12. It is consistent with the proposed chemical reaction equations. Moreover, the existence of reaction eq (2) suggests that the presence of sulfur or SO₄²⁻ ions is a contributing factor to stabilize Co particles on the CoSO₄/SiO₂ catalyst.

CoSO₄+5H₂→Co+H₂S+4H₂O eq (1)

CoSO₄+4H₂→CoS+4H₂O eq (2)

Co₃O₄+4H₂→3Co+4H₂O eq (3)

CoO+H₂→CO+H₂O eq (4)

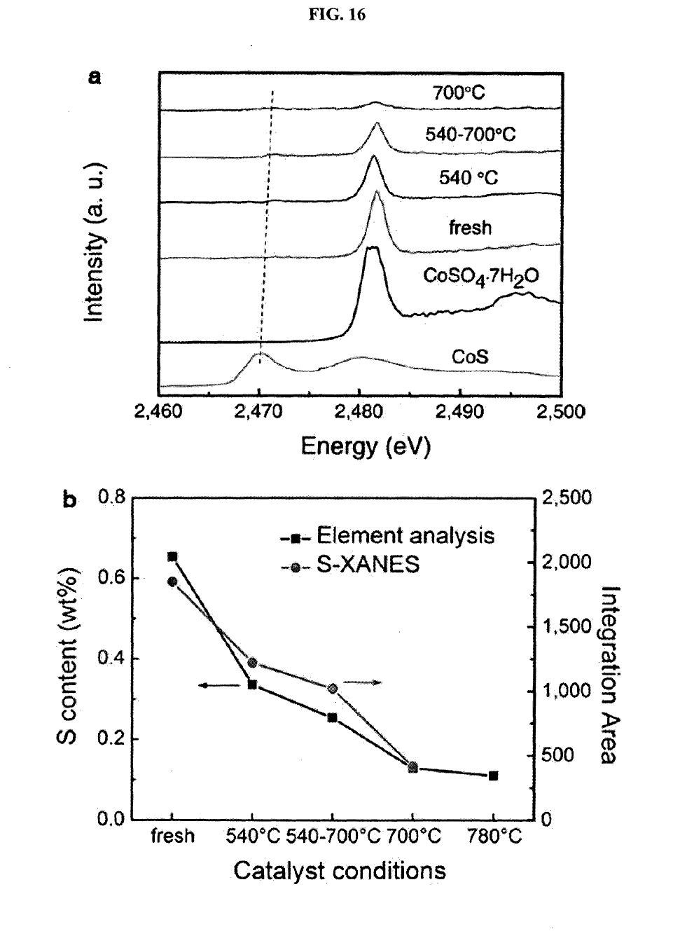

The existence of sulfur compounds in the catalyst during SWCNT synthesis was verified using XAS and elemental analysis. FIG. 16A shows the XANES spectra at sulfur K-edge of catalysts after different treatments. The peak belonging to SO₄²⁻ ions decreases with the increase of reduction temperature, and a small CoS peak may be observed. Sulfur contents in catalysts were quantified by integrating the sulfur peak area of XANES spectra. FIG. 16B shows that sulfur content decreases with increasing reduction temperature. This is further corroborated by element analysis of sulfur. The sulfur content in fresh catalyst is 0.65 wt %. After reduction at 540° C., it drops to 0.36 wt %. In contrast, after reduction at 780° C., catalyst only contains 0.11 wt % sulfur. FIG. 16, combining with the above SWCNT analysis, suggests that the sulfur content correlates with the (n,m) selectivity changes of the CoSO₄/SiO₂ catalyst.

From the TPR result in FIG. 16D, the reduction of Co species under H₂ starts at 435° C. and completes at 530° C. When catalyst is reduced at 540° C., the existence of sulfur compounds may stabilize reduced Co atoms for forming Co particles with suitable diameter and composition under CO. Such particles lead to the selective growth of (9,8) tubes. In contrast, if the reduction temperature is further increased to 780° C., sulfur compounds (e.g., SO₄²⁻ ions) are removed from the catalysts, and reduced Co atoms nucleate into Co particles with various diameters, leading to SWCNTs with a broader (n,m) distribution. The TGA result in FIG. 12B shows the formation of amorphous carbon and graphite, resulting from Co particles of random sizes.

Previous studies showed that, when suitable amounts of sulfur are added in carbon precursors, not only does it promote the growth rate and the yield of carbon nanotubes it also strongly affects nanotube structures (such as shell number and diameter). One study proposed a mechanism that sulfur (from thiophene or carbon disulfide added in gas phase) would restrict the growth of Fe particles at about 1.6 nm for chiral selective growth of metallic (9,9) and (12,12) tubes. They also suggested that sulphur may form C—S bonds at the edge steps of the nanotube growth front, which lowers the activation energy of Stone-Thrower-Wales dislocation motion for SWCNT growth.

In this study, sulfur compounds are directly impregnated on the catalyst instead, and the growth temperature at 780° C. is much lower than the previous study at 1200° C. Thus, the Co particles would not be in a liquid state during SWCNT growth. It is postulated that sulfur could play two roles: First, the coexistence of sulfur atoms near Co atoms may limit the aggregation of Co atoms, which does not happen on catalysts prepared using other Co precursors without sulfur. Second, sulfur atoms may also form various Co—S compounds on Co particles, as indicated by the small CoS peak in XAS results (FIG. 16A). The Co—S compounds could enable the specific chiral selectivity different from pure Co particles.

In this work, it has been shown that the sulfate-promoted CoSO₄/SiO₂ catalyst is highly selective in growing large-diameter (9,8) SWCNTs. In contrast, the chiral selectivity reported by most previous studies is restricted to small-diameter (6,5) and (7,5) SWCNTs. After the catalyst is reduced in H₂ at 540° C., it grows 51.7% (by PL, 33.5% by absorption) of (9,8) tubes. The total carbon yield over all catalyst materials used is 3.8 wt %, in which at least 90% is SWCNTs. The selectivity toward (9,8) tubes disappears if the catalyst is reduced at 780° C. The uniqueness of the CoSO₄/SiO₂ catalyst is that the highly dispersed CoSO₄ is reduced in a narrow window near 470° C. XAS results indicate the formation of Co particles with average size of 1.23 nm, matching the diameter of (9,8) tubes. Experimental and theoretical results suggest a correlation between the most abundant (n,m) species and the stable Co particles of scattered sizes. This suggests that growing chiral tubes with diameters matching the most stable particles in their size range could be much easier than seeking selectivity to random chiral structures. Furthermore, XAS results show that the sulfur content in the catalyst changes after catalyst reduction at different conditions, which correlates with the (n,m) selectivity change observed.

Sulfur compounds incorporated in catalyst preparation may help to limit the aggregation of Co atoms and/or form various Co—S compounds, which contributes to the chiral selectivity.

### Example 13

### Catalyst Preparation (Embodiment 3)

The CoSO₄/SiO₂ catalysts with ˜1 wt % Co (based on the starting materials used) were prepared by the incipient wetness impregnation method.

Co (II) sulphate heptahydrate (Sigma-Aldrich≧99%) was dissolved in deionized water, and then added to the Cab-O-Sil M-5 silica powder (Sigma-Aldrich). Fumed silica produced by hydrolysis of SiCl₄ at high temperature may be used. In the experiments, fumed silica was used because it is stable after high temperature treatment. Its porous structure provides sufficient surface areas to accommodate Co species. Fumed silica can also be easily dissolved in a NaOH solution, which facilitates SWCNT purification.

The mixture was aged at room temperature for 1 h, and dried in an open glass Petri plate at 100° C. for 2 h. The dried catalyst was ground into fine powders, calcined under a dry airflow in a fluidized bed calcinator from room temperature to a chosen calcination temperature, and kept at that temperature for 1 h before cooling to room temperature. It was found that the airflow rate, temperature increasing rate, and calcination time may affect the catalyst performance. The calcination temperature is the most critical parameter among them.

Other calcination parameters at their optimal conditions (i.e. airflow of 20 sccm per gram of catalyst from room temperature to a desired calcination temperature at 1° C./min, 5 grams of the catalyst each batch) were held, and only the calcination temperature was varied from 400° C. to 950° C.

### Example 14

### Catalyst Characterization (Embodiment 3)

The physiochemical properties of CoSO₄/SiO₂ catalysts obtained after different calcination treatments were characterized by scanning electron microscope (SEM), transmission electron microscope (TEM), X-ray diffraction (XRD), nitrogen physisorption, H₂—temperature programmed reduction (H₂-TPR), UV-vis diffuse reflectance spectroscopy, element analysis (EA), and X-ray absorption spectroscopy (XAS).

Several reference samples were also used in catalyst characterization, including Co (II, III) oxides (99.8%, Aldrich), Co (II) oxide (99.99%, Aldrich) and Co silicate (ICN215905, MP Biomedicals).

SEM images of catalysts were obtained from a field-emission SEM (JEOL, JSM-6701F) at 5 kV.

XRD measurements of CoSO4/SiO2 catalysts were carried out on a Bruker Axs D8 X-ray diffractometer (Cu Kα, λ=0.15, 4 nm, 40 KV, 30 mA).

Nitrogen adsorption-desorption isotherms of catalysts were measured at 77 K using a Quantachrome Autosorb-6b static volumetric instrument. The samples were first degassed at 250° C. under high vacuum (<0.01 mbar). The specific surface area was calculated by the Brunauer, Emmet, and Teller (BET) method, while the pore size and pore size distribution were calculated by the Barrett, Joyner, and Halenda (BJH) method using the desorption branch of the isotherms.

H₂-TPR was conducted in a TPR system equipped with a thermal conductivity detector (TCD, Techcomp 7900, Singapore). The CoSO₄/SiO₂ catalysts (200 mg) or Co reference samples with equivalent Co loadings were loaded into a quartz cell. H₂ (5%) in Ar was introduced to the quartz cell at a flow rate of 30 sccm. Pure Ar gas was used as a reference for the TCD. After the TCD baseline was stable, the temperature of the quartz cell was increased to 950° C. at 5° C./min, and held at 950° C. for 30 min. An acetone-liquid N₂ trap was installed between the quartz cell and the TCD to condense water or H₂S produced during catalyst reduction.

UV-vis diffuse reflectance spectra of solid samples were collected on the Varian Cary 5000 spectrophotometer with an integrating sphere for solid-phase characterization.

The X-ray Absorption Near Edge Structure (XANES) and extended X-ray absorption fine structure (EXAFS) spectra at the Co K-edge (7709 eV) were collected at the beamline X18B, National Synchrotron Light Source at Brookhaven National Laboratory, USA. The monochromator of this beamline is a double-crystal Si (111). Catalysts were pressed into a round self-supporting wafer (1.5 cm in diameter) using a hydraulic pellet press under about 2 tons forces. The thickness of wafers was made near the optimum absorption thickness, where Δμx≈1.0 (Δμ is the absorption edge, and x is the thickness of the catalyst wafer). XAS spectra were collected in a fluorescence mode at room temperature by scanning from 200 below to 1000 eV above the Co—K edge using gas-filled ionization chamber detectors.

The XAS data at the Co K-edge were analyzed using the IFEFFIT program in three steps. First, the XAS function (χ) was obtained by subtracting the postedge background, and normalized with respect to the edge jump step. Next, the normalized χ(E) was transferred from energy space to photoelectron wave vector k-space. The χ(k) data were multiplied by k² to compensate the damping of oscillations in the high k-region. Subsequently, the k²-weighted χ(k) data in k-space ranging from 2 Å⁻¹ to 10 Å⁻¹ for the Co K-edge were Fourier transformed to r-space to separate the contribution from the different coordination shells. Last, the spectra in the r-space between 0.8 Å and 2.0 Å were fitted using theoretical paths of Co₃O₄ and CoSO₄ generated by the FEFF 9 program to obtain parameters, including the first shell coordination number (N_{Co—O}), the bond distance (R) and the Debye-Waller factor (Δσ²).

The weight fraction of sulfur in catalysts was measured by an elemental analyzer (Elementarvario CHN). Before each test, all samples were dried at 100° C. overnight. About 5 mg sample was used in each test, and each catalyst sample was tested three times to obtain the average and standard errors.

The S K-edge XANES spectra of CoSO₄/SiO₂ catalysts were measured at the beamline 9-BM of the Advanced Photon Source at Argonne National Laboratory. Air absorption was eliminated by using He to purge the incident light path. The XANES spectra were collected in the total electron yield mode in the energy range of 2450 eV to 2600 eV, and up to 3 scans for each sample were collected and averaged to improve the signal-to-noise ratio. CoSO₄.7H₂O was used as a reference compound. The XANES data at S K-edge were processed using the EXAFSPAK software.

### Example 15

### SWCNT Synthesis (Embodiment 3)

SWCNT growth was carried out in a horizontal chemical vapor deposition reactor. Catalysts were loaded in a ceramic boat at the center of the reactor. In typical growth conditions, 100 mg of the calcined CoSO₄/SiO₂ catalyst was first reduced under flowing H₂ (1 bar, 50 sccm) from room temperature to 540° C. at a ramp of 20° C./min. Once the temperature reached 540° C., the reactor was purged with Ar, while its temperature was further increased to 780° C. Next, CO (99.9% from Alphagaz, Soxal, Singapore) was introduced into the reactor at 6 bar for 1 h. Carbonyl residues in CO gas were removed by a purifier (Nanochem, Matheson Gas Products, Montgomeryville, Pa., USA) before CO entered the reactor. The same growth conditions were employed for all catalysts.

### Example 16

### SWCNT Characterization (Embodiment 3)

As-grown SWCNTs deposited on catalysts were first examined by Raman spectroscopy. Raman spectra were collected on a Renishaw Ramanscope in the backscattering configuration over several random spots on each sample. Measurements were done under 514 nm and 785 nm lasers. The laser energy of 2.5 mW to 5 mW was used with an integration time of 10 s. The Raman signals from SWCNTs after catalyst removal were also measured, and they were similar to the signals obtained on as-grown SWCNTs.

Next, the catalysts loaded with carbon deposits were refluxed in a NaOH aqueous solution (1.5 mol/L) to dissolve silica substrates. Carbon deposits were filtered on a nylon membrane (0.2 μm pore). The filtered carbon deposits were further suspended in 2 wt % sodium dodecyl benzene sulfonate (SDBS) (Aldrich, Singapore) D₂O (99.9 atom % D, Sigma-Aldrich, Singapore) solution by sonication in a cup-horn sonicator (VCX-130, SONICS, Newtown, Conn., USA) at 20 W for 1 h.

After sonication, the suspension was centrifuged at 50,000 g for 1 h. The clear SWCNT supernatant obtained after centrifugation was characterized by photoluminescence (PL) and ultraviolet-visible-near-infrared (UV-vis-NIR) absorption spectroscopy. PL signals were collected on a Jobin-Yvon Nanolog-3 spectrofluorometer with the excitation wavelength scanned from 450 nm to 950 nm and the emission wavelength collected from 900 nm to 1600 nm. The UV-vis-NIR absorption spectra were measured from 500 nm to 1600 nm on a Varian Cary 5000 spectrophotometer.

The carbon deposits were also characterized by thermogravimetric analysis (TGA). The total carbon yield was determined by analyzing weight loss of as-synthesized carbon deposits with catalysts. TGA was conducted on a PerkinElmer Diamond TG instrument. For a typical test, about 2 mg as-synthesized catalyst was placed in an alumina pan. The sample was heated to 200° C., and held for 10 min under airflow (200 sccm) to remove moisture. Subsequently, its temperature was continuously raised from 200° C. to 1000° C. at a 10° C./min rate. The weight loss was monitored and recorded as a function of the temperature. The same procedure was repeated after the sample was cooled to room temperature to get the second weight-temperature curve for baseline correction. The differential thermogravimetric (DTG) analysis was performed on the baseline corrected TG profiles.

TEM images were captured via a Philips Tecnai 12 microscope at 120 kV. The solid samples were dispersed in anhydrous ethanol by bath sonication for 30 min, and the homogenous dispersion was dropped on a TEM grid covered with holey carbon film for TEM analysis. Atomic force microscope (AFM) image of SWCNTs deposited on a silicon wafer was recorded via a MFP3D microscope (Asylum Research, Santa Barbara, Calif.) with a cantilever (Arrow NC, Nanoworld) operating in the tapping mode.

### Example 17

### Chiral Selectivity of the CoSO₄/SiO₂ Catalyst Embodiment 3

### Example 17.1

### Raman Spectroscopy

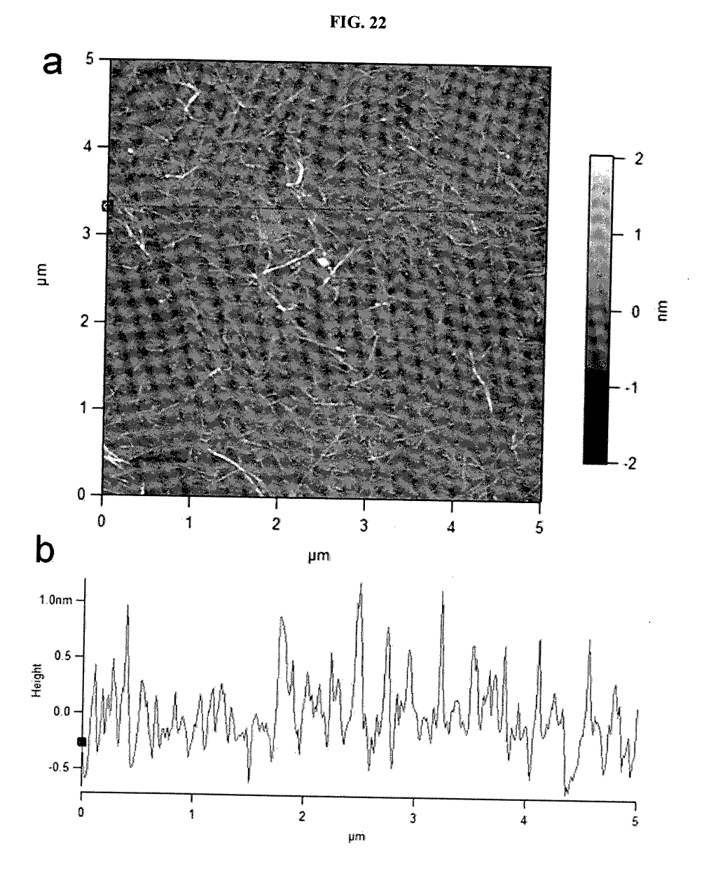

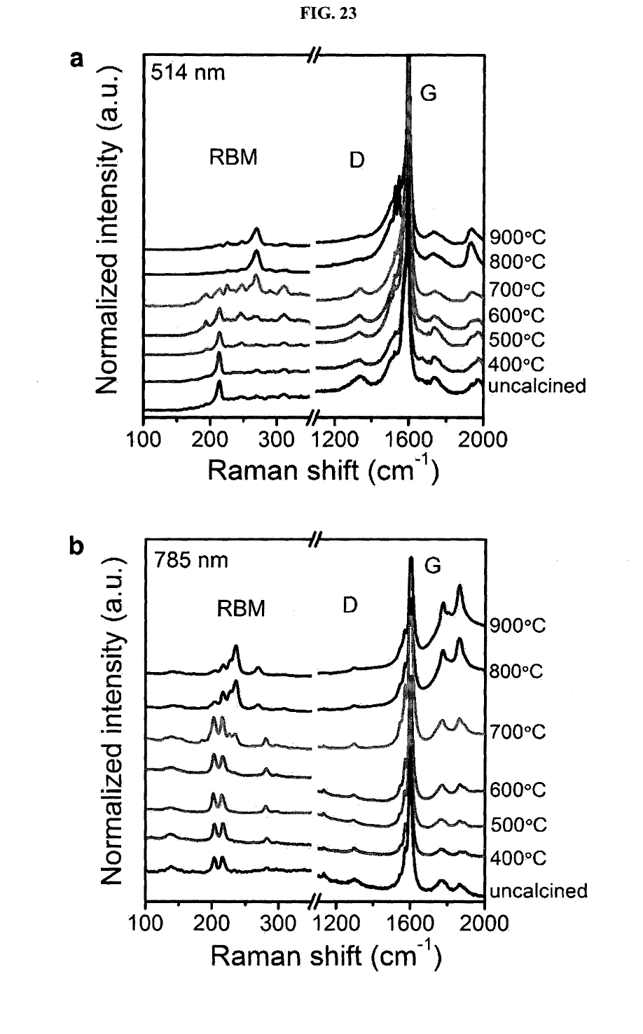

Raman spectroscopy is often used to evaluate the quality and (n,m) selectivity of SWCNTs based on their radial breathing mode (RBM), D band and G band features. FIG. 23 shows Raman spectra of as-synthesized SWCNTs from catalysts calcined at different conditions under 514 nm and 785 nm laser excitations. All spectra have strong RBM and G band peaks with weak D band peaks, suggesting that high quality SWCNTs have been synthesized. The RBM peaks can be correlated with the (n,m) structures of SWCNTs according to the Kataura plot generated by the tight-binding model.

RBM frequencies are calculated as 223.5 cm⁻¹/dₜ+12.5 cm⁻¹, where dₜ is the diameter of SWCNTs. We used a combination of empirical and theoretical Kataura plots to identify the (n,m) structures of SWCNTs in our samples because the empirical plot is more accurate for the E₁₁ and E₂₂ van Hove transitions of semiconducting SWCNTs. FIGS. 23A and B display a shift in the nanotube (n,m) structures with the change of catalyst calcination temperatures. Besides that, the (n,m) distribution of SWCNTs gradually becomes broader with the increment of calcination temperature. The catalysts calcined below 700° C. mainly grow large diameter (dₜ≧1.1 nm) SWCNTs. Based on the empirical Kataura plot, the RBM peaks at 193 cm⁻¹ (FIG. 23A), 213 cm⁻¹ (FIG. 23A), 203 cm⁻¹ (FIG. 23B) and 215 cm⁻¹ (FIG. 23B) come from the (10,8), (10,6), (9,8) and (9,7) nanotubes respectively. When the catalyst calcination temperature is greater than 700° C., the distribution of RBM peaks becomes broader, and the strongest RBM peaks shift to larger wavelength, implying that more small diameter (dt<1.0 nm) SWCNTs are produced. The strongest RBM peaks at 270 cm⁻¹ (FIG. 23A) and 246 cm⁻¹ (FIG. 23B) belong to the (7,6) and (8,6) nanotubes, respectively. Table 11 lists SWCNTs identified by their RBM peaks in FIG. 23. Due to the Raman resonance effect, it is difficult to quantify the abundance of various (n,m) species using only two excitation lasers in Raman analysis; hence, PL spectroscopy was also employed to assign the (n,m) structure of semiconducting tubes.

TABLE 11
Summary of RBM peaks identified in FIG. 23 from SWCNT samples synthesized
from the CoSO₄/SiO₂ catalysts uncalcined and calcined at different temperatures.

| Excitation | 514 nm | | | | | | 785 nm | | | | | |
|---|---|---|---|---|---|---|---|---|---|---|---|---|
| RBM, cm⁻¹ | 193 | 213 | 226 | 246 | 270 | 312 | 203 | 215 | 227 | 236 | 270 | 280 |
| dₜ, nm | 1.24 | 1.11 | 1.03 | 0.97 | 0.90 | 0.76 | 1.17 | 1.10 | 1.03 | 0.97 | 0.90 | 0.83 |
| uncalcined | √ | √ | x | x | x | √ | √ | √ | x | x | x | √ |
| 400° C. | √ | √ | x | x | x | x | √ | √ | x | x | x | √ |
| 500° C. | √ | √ | x | √ | x | √ | √ | √ | x | x | x | √ |
| 600° C. | √ | √ | x | √ | √ | √ | √ | √ | x | x | x | √ |
| 700° C. | √ | √ | √ | √ | √ | √ | √ | √ | √ | √ | x | √ |
| 800° C. | x | x | √ | √ | √ | √ | √ | √ | √ | √ | √ | x |
| 900° C. | x | x | √ | √ | √ | √ | √ | √ | √ | √ | √ | x |

### Example 17.2

### PL Spectroscopy

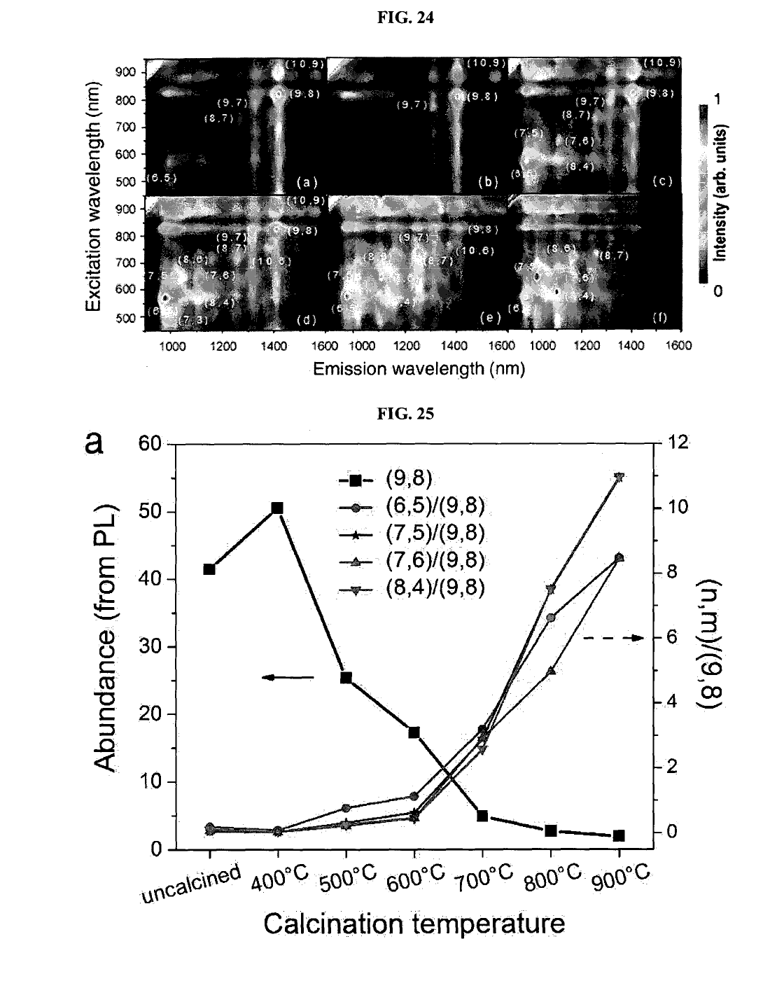

FIG. 24 sketches the PL contour plots of SWCNTs grown from catalysts calcined at different temperature conditions. The spikes from the resonance behaviour of both excitation and emission events represent the transition pair belonging to individual semiconducting (n,m) species. The relative abundance of semiconducting (n,m) tubes identified in FIG. 24 was calculated based on their PL peak intensity. The detailed results are listed in TABLES 12 to 18.

TABLE 12
Tabulated values of PL peak intensity and the
relative abundance of (n, m) species in SWCNTs
grown on the uncalcined CoSO₄/SiO₂ catalyst.

| | | Chiral | | | PLE | Relative |
|---|---|---|---|---|---|---|
| (n, m) | Diameter | angle | E₁₁ | E₂₂ | intensity | abundance, |
| index | dₜ (nm) | θ (°) | (nm) | (nm) | (counts) | (%) |
| (6, 5) | 0.76 | 27.00 | 993 | 566 | 774.3 | 8.32% |
| (7, 3) | 0.71 | 17.00 | 996 | 498 | 427.5 | 4.59% |
| (7, 5) | 0.83 | 24.50 | 1022 | 634 | 239.9 | 2.58% |
| (7, 6) | 0.90 | 27.46 | 1126 | 642 | 301.1 | 3.23% |
| (8, 4) | 0.84 | 19.11 | 1124 | 574 | 454.6 | 4.89% |
| (8, 6) | 0.97 | 25.28 | 1162 | 710 | 147.7 | 1.59% |
| (8, 7) | 1.03 | 27.80 | 1273 | 726 | 468.8 | 5.04% |
| (9, 7) | 1.10 | 25.87 | 1329 | 790 | 1214.4 | 13.05% |
| (9, 8) | 1.17 | 28.05 | 1424 | 818 | 3857.4 | 41.46% |
| (10, 6) | 1.11 | 21.79 | 1380 | 754 | 527.4 | 5.67% |
| (10, 8) | 1.24 | 26.30 | 1470 | 870 | 325.7 | 3.50% |
| (10, 9) | 1.31 | 28.30 | 1567 | 886 | 565.9 | 6.08% |

TABLE 13
Tabulated values of PL peak intensity and the
relative abundance of (n, m) species in SWCNTs
grown on the CoSO₄/SiO₂ catalyst calcined at 400° C.

| | | Chiral | | | PLE | Relative |
|---|---|---|---|---|---|---|
| (n, m) | Diameter | angle | E₁₁ | E₂₂ | intensity | abundance, |
| index | dₜ (nm) | θ (°) | (nm) | (nm) | (counts) | (%) |
| (6, 5) | 0.76 | 27.00 | 981 | 566 | 157.2 | 4.34% |
| (7, 3) | 0.71 | 17.00 | 995 | 498 | 136.1 | 3.76% |
| (7, 5) | 0.83 | 24.50 | 1021 | 638 | 66.8 | 1.85% |
| (7, 6) | 0.90 | 27.46 | 1112 | 642 | 65.9 | 1.82% |
| (8, 4) | 0.84 | 19.11 | 1103 | 578 | 101.9 | 2.82% |
| (8, 6) | 0.97 | 25.28 | 1163 | 710 | 44.5 | 1.23% |
| (8, 7) | 1.03 | 27.80 | 1265 | 726 | 99.7 | 2.75% |
| (9, 7) | 1.10 | 25.87 | 1319 | 790 | 437.4 | 12.1% |
| (9, 8) | 1.17 | 28.05 | 1413 | 818 | 1828.6 | 50.52% |
| (10, 6) | 1.11 | 21.79 | 1380 | 754 | 222.9 | 6.16% |
| (10, 8) | 1.24 | 26.30 | 1465 | 870 | 113.3 | 3.13% |
| (10, 9) | 1.31 | 28.30 | 1559 | 886 | 344.7 | 9.52% |

TABLE 14
Tabulated values of PL peak intensity and the
relative abundance of (n, m) species in SWCNTs
grown on the CoSO₄/SiO₂ catalyst calcined at 500° C.

| | | Chiral | | | PLE | Relative |
|---|---|---|---|---|---|---|
| (n, m) | Diameter | angle | E₁₁ | E₂₂ | intensity | abundance, |
| index | dₜ (nm) | θ (°) | (nm) | (nm) | (counts) | (%) |
| (6, 5) | 0.76 | 27.00 | 985 | 570 | 2746.6 | 19.51% |
| (7, 3) | 0.71 | 17.00 | 990 | 502 | 963.4 | 6.85% |
| (7, 5) | 0.83 | 24.50 | 1026 | 642 | 1167.5 | 8.29% |
| (7, 6) | 0.90 | 27.46 | 1114 | 642 | 824.2 | 5.86% |
| (8, 4) | 0.84 | 19.11 | 1110 | 574 | 940.6 | 6.68% |
| (8, 6) | 0.97 | 25.28 | 1166 | 710 | 296.3 | 2.11% |
| (8, 7) | 1.03 | 27.80 | 1263 | 726 | 875.8 | 6.22% |
| (9, 7) | 1.10 | 25.87 | 1319 | 790 | 1136.1 | 8.07% |
| (9, 8) | 1.17 | 28.05 | 1414 | 822 | 3572.9 | 25.38% |
| (10, 6) | 1.11 | 21.79 | 1382 | 758 | 648.6 | 4.61% |
| (10, 8) | 1.24 | 26.30 | 1469 | 874 | 405.3 | 2.88% |
| (10, 9) | 1.31 | 28.30 | 1559 | 886 | 499.0 | 3.54% |

TABLE 15
Tabulated values of PL peak intensity and the
relative abundance of (n, m) species in SWCNTs
grown on the CoSO₄/SiO₂ catalyst calcined at 600° C.

| | | Chiral | | | PLE | Relative |
|---|---|---|---|---|---|---|
| (n, m) | Diameter | angle | E₁₁ | E₂₂ | intensity | abundance, |
| index | dₜ (nm) | θ (°) | (nm) | (nm) | (counts) | (%) |
| (6, 5) | 0.76 | 27.00 | 983 | 570 | 3394.1 | 19.55% |
| (7, 3) | 0.71 | 17.00 | 990 | 502 | 1182.8 | 6.81% |
| (7, 5) | 0.83 | 24.50 | 1026 | 642 | 1886.4 | 10.86% |
| (7, 6) | 0.90 | 27.46 | 1114 | 642 | 1373.1 | 7.91% |
| (8, 4) | 0.84 | 19.11 | 1108 | 578 | 1401.4 | 8.07% |
| (8, 6) | 0.97 | 25.28 | 1166 | 710 | 580.2 | 3.34% |
| (8, 7) | 1.03 | 27.80 | 1263 | 726 | 1227.4 | 7.07% |
| (9, 7) | 1.10 | 25.87 | 1319 | 790 | 1294.0 | 7.45% |
| (9, 8) | 1.17 | 28.05 | 1414 | 822 | 2993.0 | 17.24% |
| (10, 6) | 1.11 | 21.79 | 1381 | 754 | 803.8 | 4.63% |
| (10, 8) | 1.24 | 26.30 | 1467 | 874 | 564.9 | 3.25% |
| (10, 9) | 1.31 | 28.30 | 1558 | 886 | 663.0 | 3.82% |

TABLE 16
Tabulated values of PL peak intensity and the
relative abundance of (n, m) species in SWCNTs
grown on the CoSO₄/SiO₂ catalyst calcined at 700° C.

| | | Chiral | | | PLE | Relative |
|---|---|---|---|---|---|---|
| (n, m) | Diameter | angle | E₁₁ | E₂₂ | intensity | abundance, |
| index | dₜ (nm) | θ (°) | (nm) | (nm) | (counts) | (%) |
| (6, 5) | 0.76 | 27.00 | 983 | 574 | 1618.2 | 15.45% |
| (7, 3) | 0.71 | 17.00 | 990 | 498 | 469.8 | 4.48% |
| (7, 5) | 0.83 | 24.50 | 1026 | 646 | 1468.7 | 14.01% |
| (7, 6) | 0.90 | 27.46 | 1114 | 646 | 1487.0 | 14.19% |
| (8, 4) | 0.84 | 19.11 | 1108 | 582 | 1315.4 | 12.55% |
| (8, 6) | 0.97 | 25.28 | 1166 | 714 | 1022.3 | 9.75% |
| (8, 7) | 1.03 | 27.80 | 1263 | 730 | 1102.2 | 10.52% |
| (9, 7) | 1.10 | 25.87 | 1319 | 790 | 623.5 | 5.95% |
| (9, 8) | 1.17 | 28.05 | 1414 | 826 | 509.3 | 4.86% |
| (10, 6) | 1.11 | 21.79 | 1380 | 758 | 390.0 | 3.72% |
| (10, 8) | 1.24 | 26.30 | 1468 | 870 | 171.7 | 1.64% |
| (10, 9) | 1.31 | 28.30 | 1559 | 890 | 302.2 | 2.88% |

TABLE 17
Tabulated values of PL peak intensity and the
relative abundance of (n, m) species in SWCNTs
grown on the CoSO₄/SiO₂ catalyst calcined at 800° C.

| | | Chiral | | | PLE | Relative |
|---|---|---|---|---|---|---|
| (n, m) | Diameter | angle | E₁₁ | E₂₂ | intensity | abundance, |
| index | dₜ (nm) | θ (°) | (nm) | (nm) | (counts) | (%) |
| (6, 5) | 0.76 | 27.00 | 981 | 570 | 4571.9 | 17.68% |
| (7, 3) | 0.71 | 17.00 | 990 | 498 | 1098.8 | 4.25% |
| (7, 5) | 0.83 | 24.50 | 1022 | 650 | 5174.5 | 20.01% |
| (7, 6) | 0.90 | 27.46 | 1112 | 646 | 3426.3 | 13.25% |
| (8, 4) | 0.84 | 19.11 | 1102 | 594 | 5188.8 | 20.07% |
| (8, 6) | 0.97 | 25.28 | 1166 | 714 | 2292.6 | 8.86% |
| (8, 7) | 1.03 | 27.80 | 1263 | 726 | 1496.6 | 5.79% |
| (9, 7) | 1.10 | 25.87 | 1320 | 790 | 884.5 | 3.42% |
| (9, 8) | 1.17 | 28.05 | 1413 | 826 | 690.5 | 2.67% |
| (10, 6) | 1.11 | 21.79 | 1376 | 758 | 480.4 | 1.86% |
| (10, 8) | 1.24 | 26.30 | 1467 | 862 | 273.6 | 1.06% |
| (10, 9) | 1.31 | 28.30 | 1557 | 886 | 279.9 | 1.08% |

TABLE 18
Tabulated values of PL peak intensity and the
relative abundance of (n, m) species in SWCNTs
grown on the CoSO₄/SiO₂ catalyst calcined at 900° C.

| | | Chiral | | | PLE | Relative |
|---|---|---|---|---|---|---|
| (n, m) | Diameter | angle | E₁₁ | E₂₂ | intensity | abundance, |
| index | dₜ (nm) | θ (°) | (nm) | (nm) | (counts) | (%) |
| (6, 5) | 0.76 | 27.00 | 980 | 570 | 3984.6 | 16.19% |
| (7, 3) | 0.71 | 17.00 | 994 | 498 | 896 | 3.64% |
| (7, 5) | 0.83 | 24.50 | 1022 | 634 | 5147 | 20.92% |
| (7, 6) | 0.90 | 27.46 | 1114 | 646 | 3977.3 | 16.16% |
| (8, 4) | 0.84 | 19.11 | 1105 | 582 | 5161.7 | 20.98% |
| (8, 6) | 0.97 | 25.28 | 1166 | 714 | 2298.8 | 9.34% |
| (8, 7) | 1.03 | 27.80 | 1263 | 726 | 1368.5 | 5.56% |
| (9, 7) | 1.10 | 25.87 | 1320 | 790 | 645.5 | 2.62% |
| (9, 8) | 1.17 | 28.05 | 1414 | 822 | 470.7 | 1.91% |
| (10, 6) | 1.11 | 21.79 | 1378 | 758 | 396.9 | 1.61% |
| (10, 8) | 1.24 | 26.30 | 1463 | 870 | 129.6 | 0.53% |
| (10, 9) | 1.31 | 28.30 | 1557 | 886 | 132.7 | 0.54% |

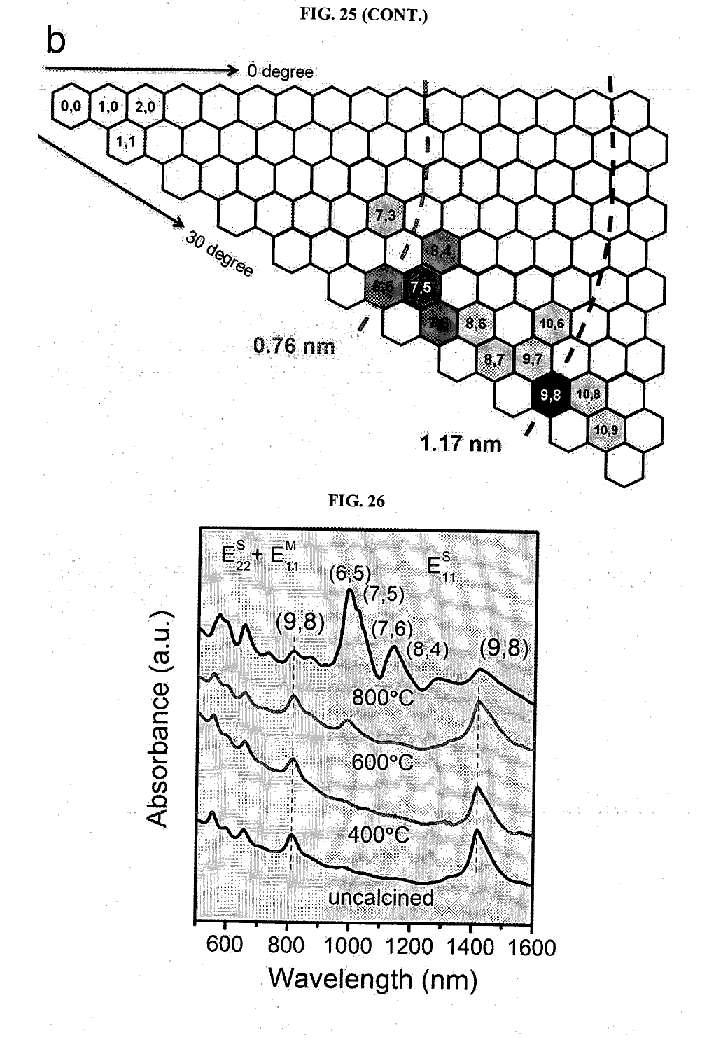

Corroborating with FIG. 23, FIG. 24 suggests that the diameter of SWCNTs shifts from large diameters to small diameters with increasing calcination temperature, as also evidenced on the chiral map in FIG. 25B. More importantly, FIG. 24B has an intense peak from the (9,8) nanotubes with minor peaks from the (10,9) and (9,7) nanotubes. As shown in FIG. 25A, the relative abundance of the (9,8) nanotubes is 50.52%, which suggests that the catalyst calcined at 400° C. has an excellent single chiral selectivity towards the large diameter (9,8) nanotubes. The uncalcined catalyst can also grow the (9,8) nanotubes; however, the peaks from the (10,9), (9,7), (8,7) and (6,5) nanotubes are more intense as compared to FIG. 24B. The relative abundance of the (9,8) nanotubes is 41.46% for the uncalcined catalyst. When the catalyst calcination temperature raised from 400° C. to 600° C., the (n,m) distribution of the resulting SWCNTs becomes broader, which include (10,9), (10,6), (9,8), (9,7), (8,7), (7,6), (7,5), (8,4), and (6,5) nanotubes. The intensity of PL peaks from small diameter nanotubes, such as the (6,5) and (7,5) nanotubes, continues to rise. When the catalyst calcination temperature reaches 700° C., the dominant (n,m) species shifts from the (9,8) to the (6,5) nanotubes. The relative abundance of the (6,5) nanotubes is 15.45%, a few times higher than that of the (9,8) nanotubes at 4.86%. When the catalyst calcination temperature is further increased to 800° C. or 900° C., their PL plots show some major changes: the large diameter nanotubes, such as (10,9), (9,8) and (9,7), disappear, and the main species are small diameter nanotubes such as (6,5), (7,5), (7,6) and (8,4). We also examined the catalyst calcined at 950° C.; the catalyst becomes inactive to SWCNT growth.

### Example 17.3

### UV-Vis-NIR Absorption Spectroscopy

As PL spectroscopy can only detect semiconducting SWCNTs, UV-vis-NIR absorption spectroscopy was used to complement the results from PL analysis. FIG. 26 indicates that the chirality distribution of SWCNTs varies in a similar trend as that in the PL plots. The spectra of SWCNTs grown from the uncalcined catalyst and the catalyst calcined at 400° C. have a single main peak in their E^{S}₁₁ transition bands, which belongs to the (9,8) nanotubes. Similarly, the strongest peaks in their E^{S}₂₂ transition bands also come from the (9,8) nanotubes. There are a few absorption peaks below 700 nm, which can be assigned to the E^{M}₁₁ transition of metallic tubes or E^{S}₂₂ transition of semiconducting tubes. Based on the positions of these peaks, they likely belong to metallic (9,6) and (10,10) nanotubes. When the catalyst calcination temperature increases to 600° C., the dominant (n,m) species remains as (9,8); however, the E^{S}₁₁ peak from the (6,5) nanotubes at 980 nm becomes larger. When the catalyst calcination temperature reaches 800° C., the (6,5), (7,5), (7,6) and (8,4) become dominant species. All absorption spectra were normalized at 1420 nm, thus the absorption peaks of small diameter tubes produced on the catalyst calcined at 800° C. have scaled up.

Based on the relative intensity of their absorption peaks, it may be concluded that when the catalyst is calcined at low calcination temperatures, the dominant semiconducting (9,8) nanotubes have much higher abundance than metallic tubes. Raman, PL, and UV-vis-NIR absorption spectroscopy analyses consistently show that (a) the CoSO₄/SiO₂ catalyst is highly selective towards the large diameter single chirality (9,8) nanotubes; (b) the chiral selectivity of the catalyst is correlated with the catalyst calcination temperatures; (c) the catalyst calcined at 400° C. has the highest selectivity towards the (9,8) nanotubes; and (d) the chiral selectivity can possibly shift to small diameter nanotubes when the catalyst is calcined above 700° C.

### Example 18

### Carbon Yield of the CoSO₄/SiO₂ Catalyst Embodiment 3

### Example 18.1

### TGA

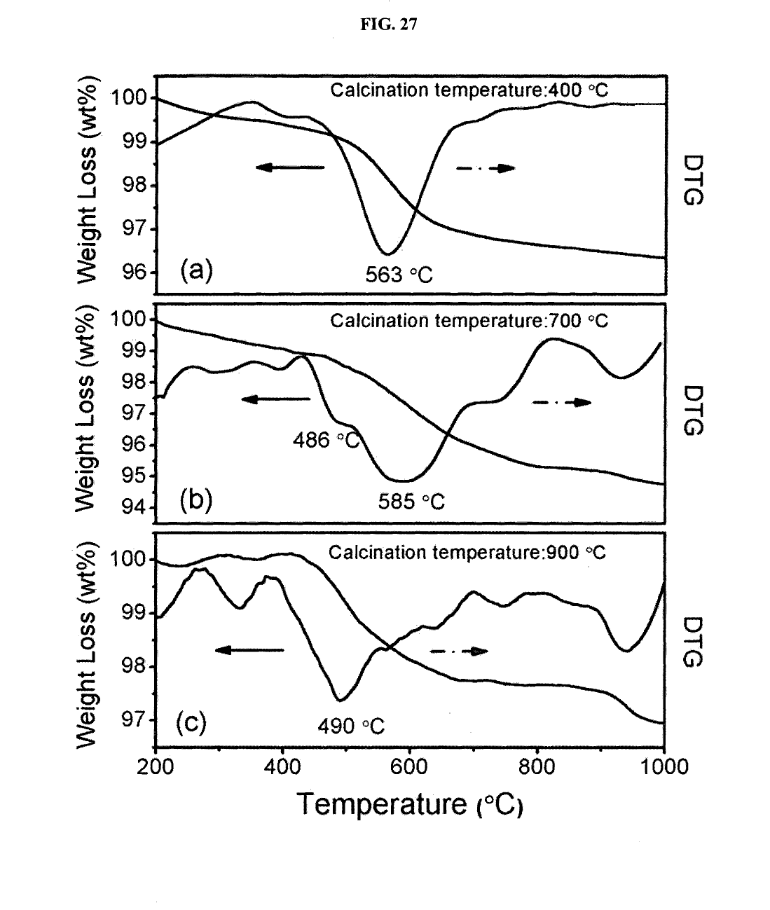

The total carbon yield and selectivity to SWCNTs are both important in evaluating the performance of catalysts used for SWCNT synthesis. TGA was adopted to determine the carbon yield and different carbon species in the carbon deposits grown from the CoSO₄/SiO₂ catalyst. As depicted in FIG. 27, the total carbon yield of three representative samples grown on the catalysts (with about 1 wt % Co) calcined at 400° C., 700° C. and 900° C. are 3.8 wt %, 5.3 wt %, and 3.2 wt % respectively.

This suggests that the carbon yield from the CoSO₄/SiO₂ catalyst is passable for developing scalable SWCNT production processes. The carbon yield increases slightly with the increase of catalyst calcination temperature from 400° C. to 700° C., and then decreases when the calcination further increases to 900° C. The DTG profiles of the carbon deposits in FIG. 27 may be divided into three oxidation regions: amorphous carbon from 250° C. to 400° C., carbon nanotubes (SWCNTs and MWCNTs) between 400° C. and 700° C., and graphite above 800° C. The weight loss below 250° C. is likely from the adsorbed water or the removal of surface hydroxyl groups on the catalysts. The DTG profile in FIG. 27A shows that 92% of carbon deposits are SWCNTs, which are oxidized at 563° C. The other three peaks in FIGS. 27B and C at 486° C., 586° C., and 490° C. can also be credited to SWCNTs of different diameters, which have been confirmed in the earlier works. The selectivity to SWCNTs is 73% and 55% based on the integrated peak areas. The appearance of peaks at about 490° C. suggests the growth of smaller diameter SWCNTs after catalyst calcination at higher temperatures, which is in agreement with the spectroscopic results. Furthermore, the peaks from graphite become more intense with the increase of catalyst calcination temperature.

### Example 18.2

### TEM, AFM and Physisorption

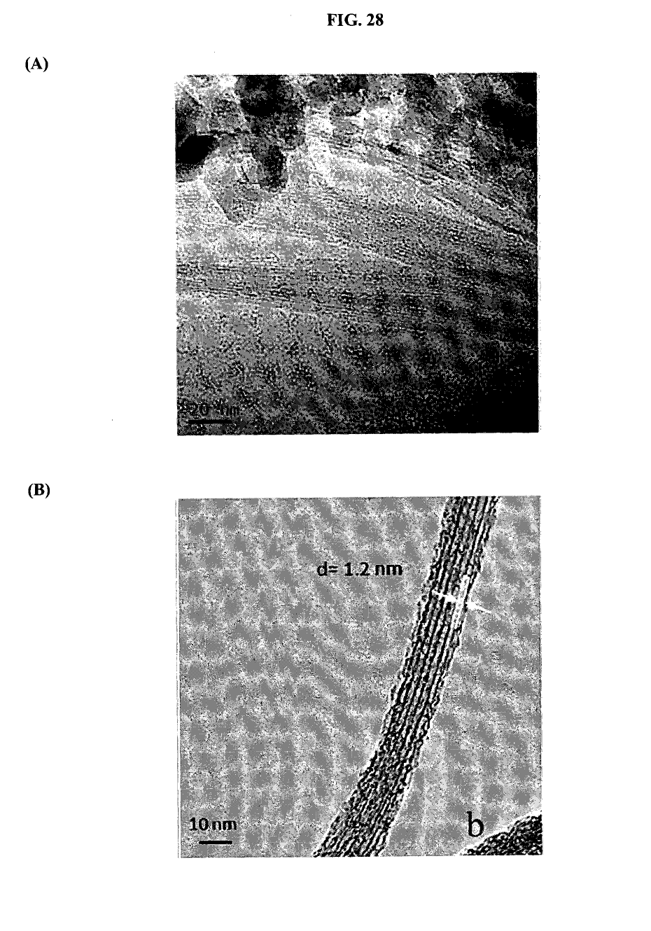

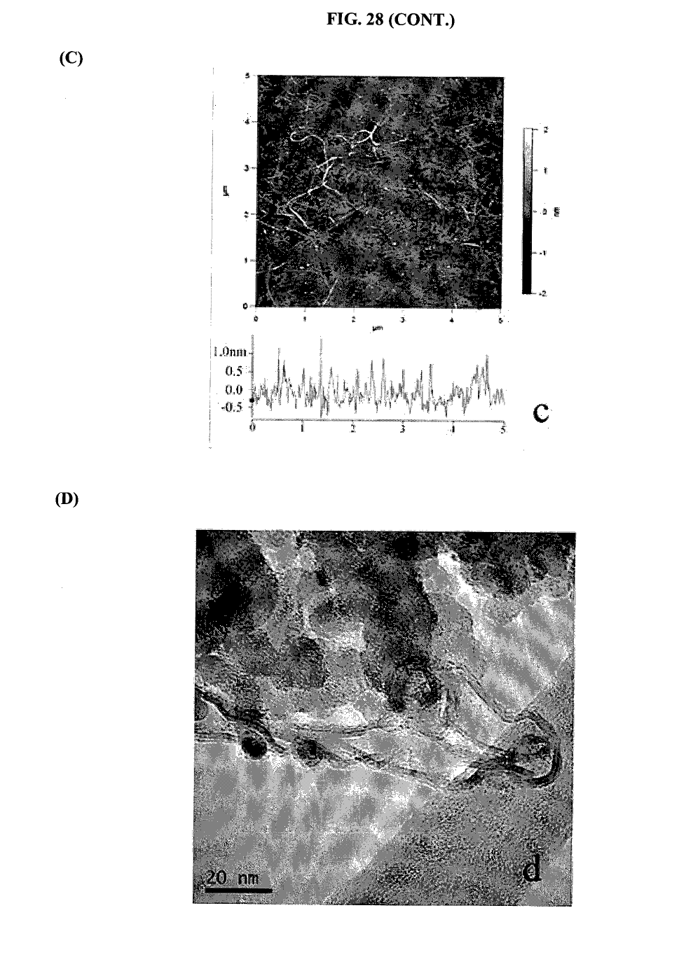

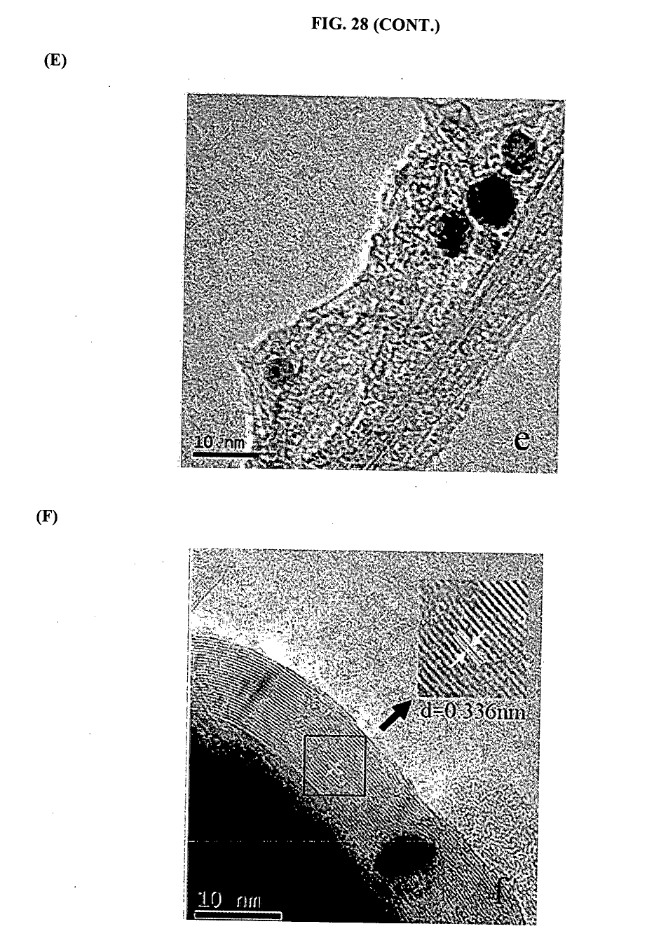

To further examine the morphology of carbon deposits, TEM images were captured on as-synthesized SWCNTs with catalysts. As seen in FIG. 28, SWCNTs grown from the catalyst would bundle together. The catalyst calcined at 400° C. yields mainly SWCNTs with diameter around 1.2 nm. The AFM image of purified SWCNTs in FIG. 28C also shows that the height of individual tubes deposited on silicon wafer is about 1.2 nm. It is difficult to find large metal particles on this catalyst, but a small amount of carbon fibers and graphite was found on the catalyst calcined at 800° C. Large metal particles can also be found on this catalyst, as well as in SWCNT bundles (see FIG. 28D to F). Large metal particles are covered by graphene layers (FIG. 28F). The TEM and AFM images agree with the results obtained from spectroscopies and TGA.

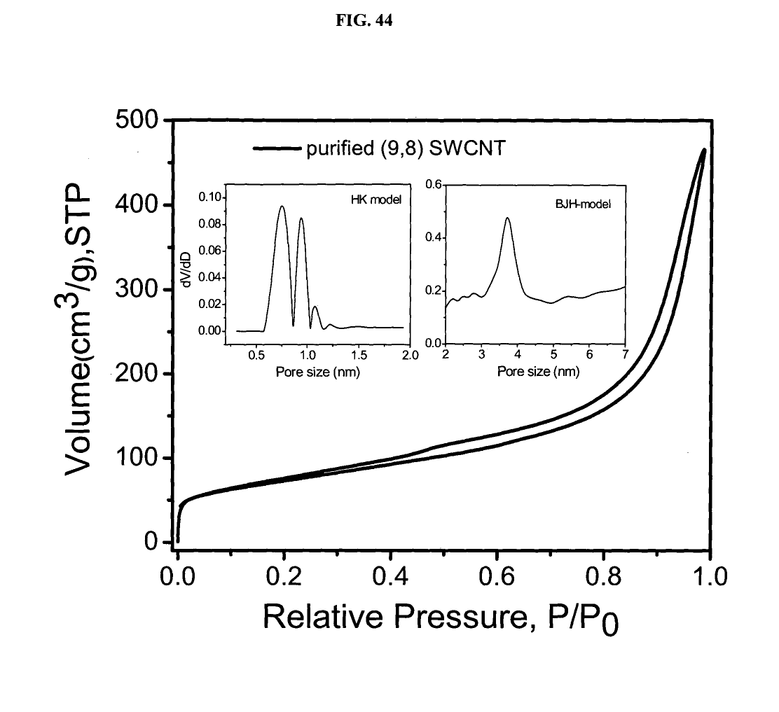

Nitrogen adsorption was performed on purified SWCNTs. The SWCNTs were purified using the four-step purification method reported in Y. Chen et al., ACS Nano 1, 2007, 327-336. The purified SWCNTs have a surface area of 256 m²/g. Their adsorption isotherms as shown in FIG. 44 suggest that they have both micropores and mesopores. The micropores are found at around 0.75 nm, 0.94 nm, 1.07 nm, and 1.22 nm. Since the diameter of (9,8) tubes is 1.17 nm, the micropores are likely from the inner space of SWCNTs, with an average pore size of about 3.7 nm. Mesopores can be attributed to the intertubular space in SWCNT bundles.

### Example 19

### Characterization of the CoSO₄/SiO₂ Catalyst Embodiment 3

### Example 19.1

### Morphology by TEM and SEM

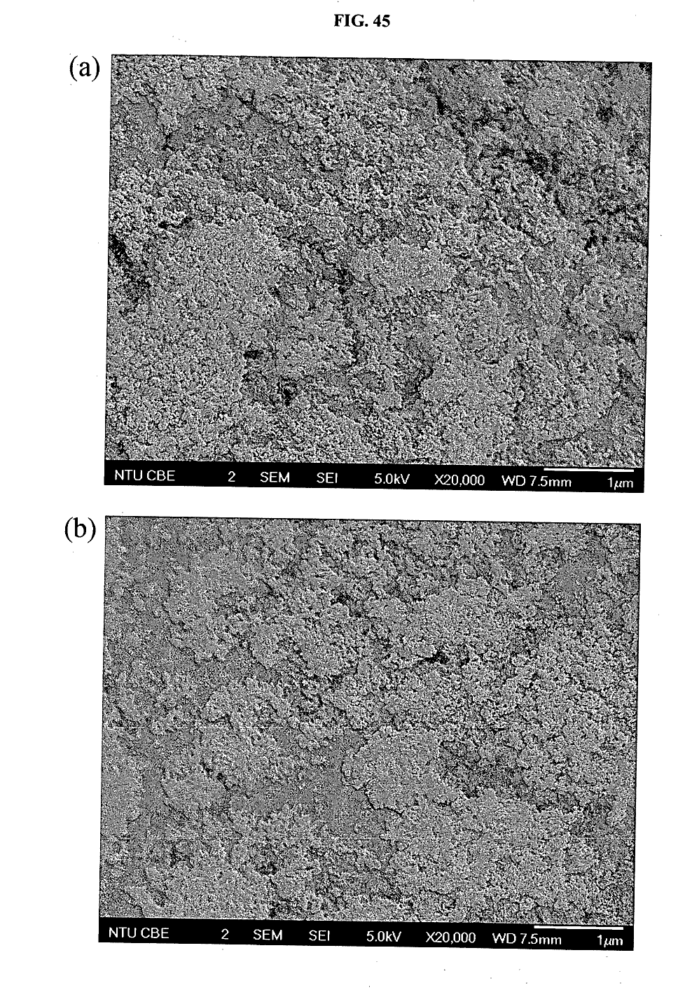

To understand how the different catalyst calcination temperature can affect the performances of the CoSO₄/SiO₂ catalyst in SWCNT synthesis, several characterization techniques were employed to study its physicochemical properties. The catalyst is supported on fumed silica. As rendered in FIG. 28, the catalyst consists of SiO₂ particles with size around 20 nm. SEM images as shown in FIG. 45 indicate that SiO₂ particles aggregate together to form micrometer scale large particles. No significant changes were observed in the morphology of these SiO₂ particles after different calcination treatments and SWCNT growth.

### Example 19.2

### Structure by XRD and Physisorption

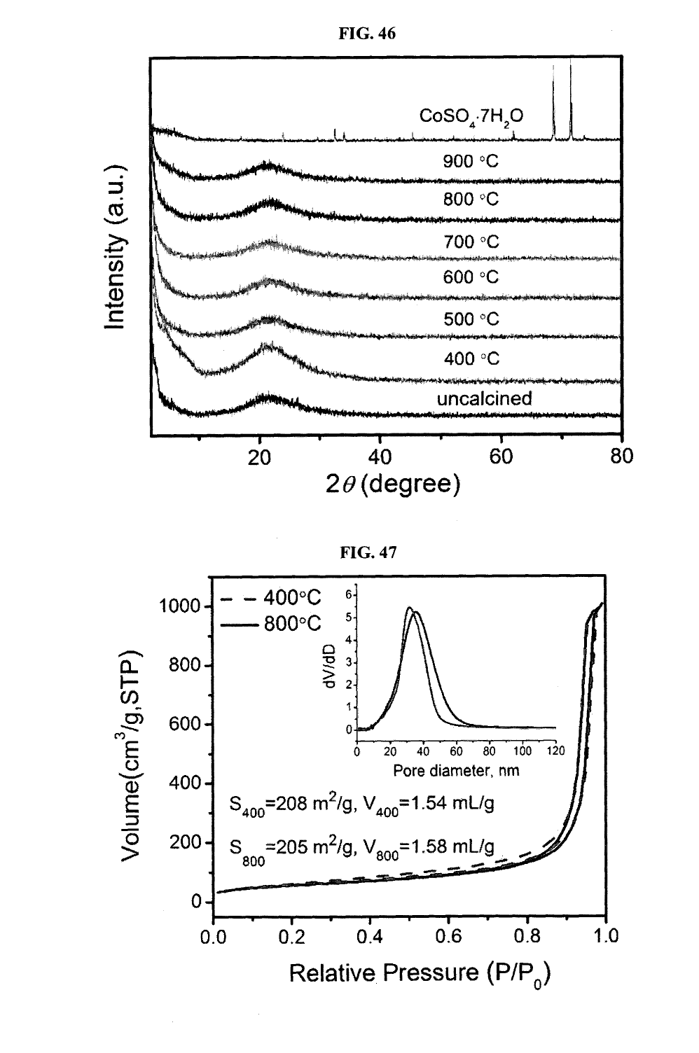

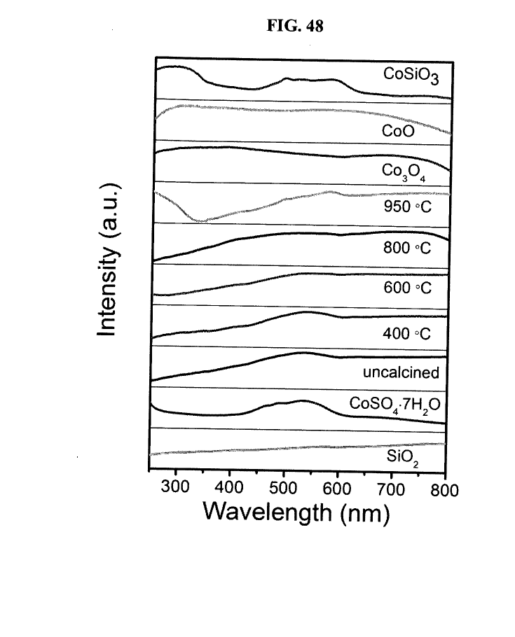

The structure of the catalyst is further characterized by XRD and nitrogen physisorption. As shown in FIG. 46, the catalysts have a broad diffraction peak near 2θ=21° originating from the SiO₂ supports. No diffraction peaks from bulk Co oxides or Co silicates are observed on the XRD spectrum of the uncalcined catalyst. After different calcination treatments, their XRD spectra show insignificant changes. Even though some surface Co oxides or Co silicates may have formed, there could not be detected in XRD analysis performed.

N₂ physisorption isotherms in FIG. 47 indicate that the catalyst is a porous material with the pore size around 32 nm. The pores likely come from the gaps among SiO₂ particles (see FIG. 45). For the catalyst calcined at 400° C., it has a surface area of 208 m²/g, and a large pore volume of 1.54 mL/g. When the catalyst is calcined at 800° C., its surface area is 205 m²/g, and its pore volume is 1.58 mL/g. These findings suggest that the observed chiral selectivity changes in SWCNT synthesis are unlikely due to the morphology or physical structure changes of the catalysts.

### Example 19.3

### H₂-TPR

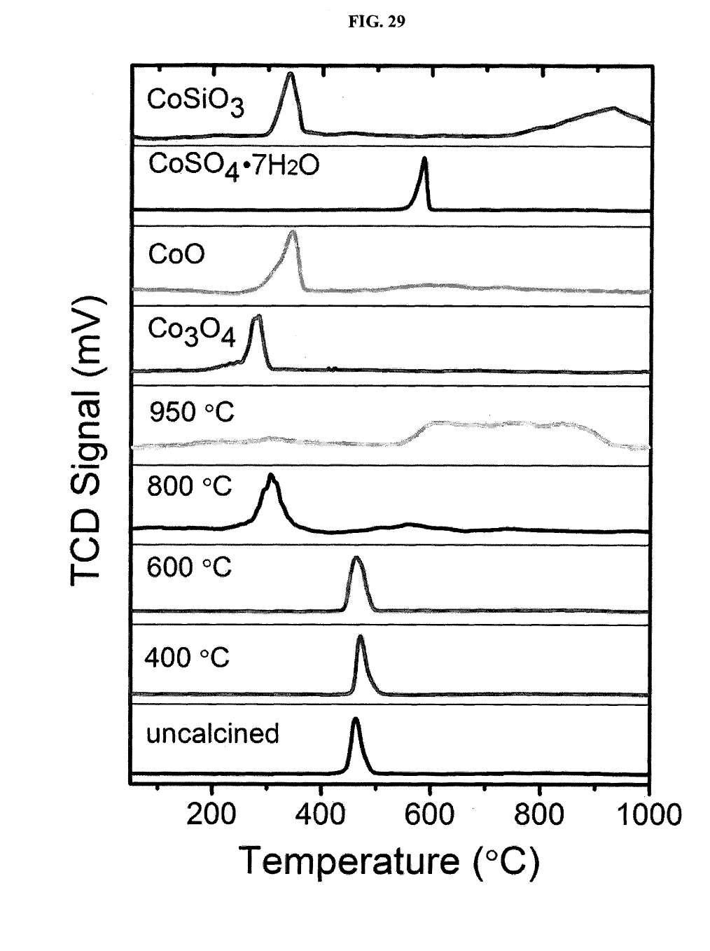

H₂-TPR is often used to investigate the metal support interaction and provide surface chemical information, such as stability, metal species, and metal distribution. FIG. 29 illustrates the TPR profiles of the uncalcined CoSO₄/SiO₂ catalyst and those calcined at different temperatures in comparison with several references. The CoSO₄.7H₂O displays a sharp peak around 585° C., which is ascribed to the reductive decomposition of bulk CoSO₄. Co oxides are usually reduced below 400° C., which is shown by the two Co oxides references (Co₃O₄ and CoO). Co silicates typically show a high reduction temperature above 600° C.

The uncalcined catalyst and those calcined at 400° C. and 600° C. all have a sharp peak around 460° C. to 470° C., which can be attributed to the reductive decomposition of highly dispersed CoSO₄ on the SiO₂ substrate. The reduction peaks from Co oxides and Co silicates are minor on their TPR profiles. When the catalyst calcination temperature rises to 800° C., there is a strong peak at 310° C., and its position lies between the peaks of CoO and Co304, advocating that the calcination at 800° C. may lead to the formation of Co oxides. When the catalyst is calcined at 950° C., a broad low intensity peak shows up from 600° C. to 950° C., which suggests the formation of various Co silicates, such as Co hydrosilicate, surface and bulk Co silicates H₂-TPR results demonstrate that different Co species can be formed after catalyst calcination at different conditions. It is postulated that this may be the key reason for the observed chiral selectivity changes.

### Example 19.4

### UV-Vis Diffuse Reflectance Spectroscopy

Surface chemistry of catalysts was further studied by UV-vis diffuse reflectance spectroscopy. FIG. 49 shows that the uncalcined catalyst and those calcined at 400° C. and 600° C. have a broad peak around 535 nm similar to that of CoSO₄.7H₂O. These three catalysts are light pink in color. When the calcination temperature increases to 800° C., the catalyst turns into gray and black. Its UV-vis spectrum is similar to that of Co₃O₄ with two broad peaks around 400 nm and 720 nm, respectively. These two peaks can be assigned to v₁⁴A_{1g}→¹T_{1g} and v^{2 1}A_{1g}→¹T_{2g} transitions, implying the existence of octahedral configured Co³⁺ ions. The UV-vis spectrum of CoO is same as that of Co₃O₄ below 400 nm. Thus, it is difficult to judge whether the calcined catalysts also contain CoO based on their UV-vis spectra alone. When the catalyst is calcined at 950° C., its UV-vis spectrum has several peaks at 250 nm to 300 nm, and 500 nm to 600 nm, just like that of CoSiO₃. The peak around 580 nm suggests the formation of amorphous Co silicates.

### Example 19.5

### XANES Spectra at Co K-Edge

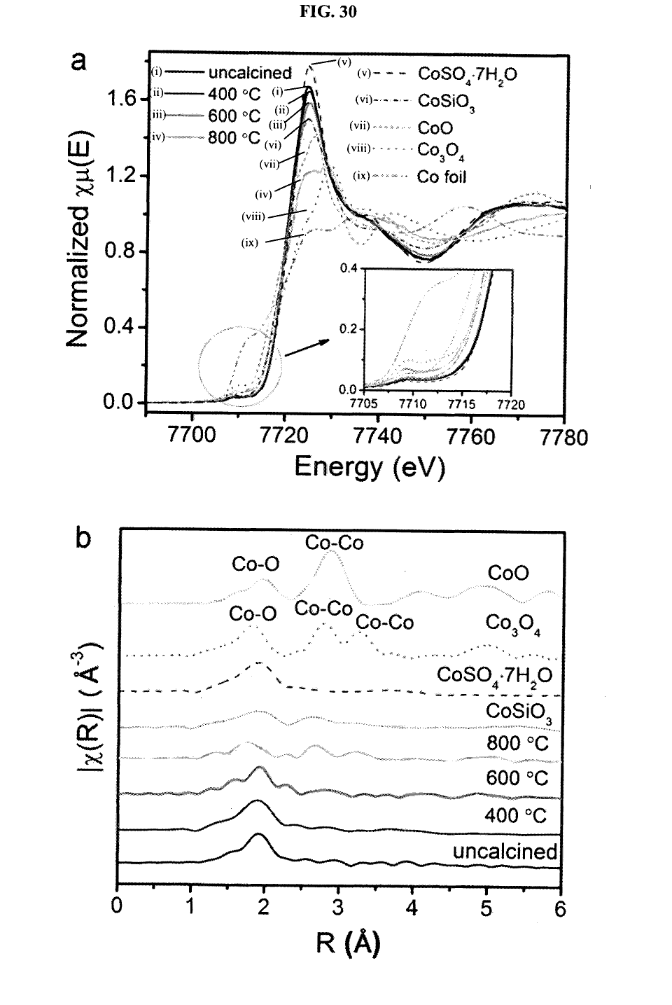

XAS was utilized to characterize the local chemical environment of Co atoms in the CoSO₄/SiO₂ catalyst. FIG. 30A shows the normalized XANES spectra of Co species in catalysts calcined at different conditions. CoSO₄.7H₂O, CoSiO₃, CoO, Co₃O₄ and Co foil were used as references. CoSO₄.7H₂O contains octahedrally coordinated Co ions. Co atoms are located in a distorted octahedral environment in Co silicates. CoO has all Co atoms sitting in an octahedral environment. In Co₃O₄, Co²⁺ ions are in a tetrahedral coordination and Co³⁺ ions are in an octahedral coordination.

Two spectroscopic features reveal significant differences among these catalysts. One is their preedge peaks and edge jumps shown in the insert of FIG. 30A. The preedge peak was assigned to the dipole forbidden 1s→3d transitions whose intensities are strong functions of the local symmetry of the Co species. The edge jump was ascribed to the 1s→np transitions when 1s electron is excited and the position of the K edge varies linearly with the valence of the Co species. In FIG. 8A, the preedge spectra of three catalysts (uncalcined, calcined at 400° C. and 600° C.) at 7709 eV almost overlap, and are similar to that of the CoSO₄.7H₂O, suggesting that Co atoms in these three catalysts are in an octahedrally coordinated structure. Their edge jumps around 7717 eV indicate that Co(II) is the dominant oxidation state of Co atoms in these catalysts.

In comparison, the peak at 7709 eV of the catalyst calcined at 800° C. locates between those of the CoO and Co₃O₄ references, and its edge jump is close to those of the Co₃O₄ and CoSiO₃ references, implying that Co atoms in this catalyst are in a distorted tetrahedral structure. The other spectroscopic feature is the white line peak at 7725 eV, which is attributed to the unfilled d states of Co atoms at the Fermi level.

The intensity of the white line peak increases with the number of unfilled d states. Cobalt foil has a weak white line peak, while the CoSO₄.7H₂O has a strong white line peak. When the hydrated water is removed, the intensity of white line decreases a bit. The uncalcined CoSO₄/SiO₂ catalyst has a strong white line peak, which indicates that Co atoms are in an oxidized state. The white line of the catalyst calcined at 400° C. is almost identical to that of the uncalcined catalyst, suggesting that most of Co atoms in the catalyst are in an oxidized state after calcination at 400° C. The white line peak intensity of the catalyst calcined at 600° C. slightly decreases. In contrast, after the calcination at 800° C., the white line peak of the catalyst splits into two peaks, in which one at 7729 eV can be attributed to the existence of Co₃O₄, and the other at 7726 eV is similar to those from CoO and CoSiO₃, which advocates the formation of Co oxides and Co silicates in the catalyst.

The extended X-ray absorption fine structure (EXAFS) of catalysts was Fourier transformed to r-space to separate the contribution from different coordination shells of Co atoms. FIG. 30B revealed that the uncalcined catalyst has a strong Co—O peak at 1.96 Å, similar to that of CoSO₄.7H₂O.

With the increase of catalyst calcination temperature, the Co—Co peak appears. The spectrum of the catalyst calcined at 800° C. is similar to those of Co₃O₄ and CoSiO₃. The spectra in r-space were fitted using Co paths in both Co₃O₄ and CoSO₄ generated by the FEFF 9 program to get the first shell coordination number (N_{Co—O}) and the bond distance (R_{Co—O}). In theoretical references, N_{Co—O} is 4, 2, and 6, and R_{Co—O} is 1.816 Å, 2.099 Å, and 2.133 Å in Co₃O₄, CoSO₄, and CoO, respectively. Fitting results are listed in TABLE 19.

TABLE 19
Structure parameters of the first Co—O coordination shell
in catalysts determined from the EXAFS data (FIG. 30B)
at the Co K-edge by fitting using FEFF 9.

| Catalysts | N_{Co—O} | dR(\acute{Å}) | Δσ² |
|---|---|---|---|
| | Co—O first shell fitting by | | |
| | the Co₃O₄ model | | |
| uncalcined | 4.8 ± 0.1 | 0.271 ± 0.011 | 0.006 |
| 400° C. | 5.2 ± 0.2 | 0.266 ± 0.016 | 0.008 |
| 600° C. | 4.6 ± 0.1 | 0.258 ± 0.011 | 0.007 |
| 800° C. | 2.6 ± 0.1 | 0.154 ± 0.014 | 0.008 |
| | Co—O first shell fitting by | | |
| | the CoSO₄ model | | |
| uncalcined | 5.7 ± 0.2 | −0.010 ± 0.009 | 0.007 |
| 400° C. | 6.0 ± 0.3 | −0.015 ± 0.013 | 0.009 |
| 600° C. | 5.4 ± 0.1 | −0.022 ± 0.008 | 0.008 |
| 800° C. | 3.2 ± 0.2 | −0.124 ± 0.015 | 0.009 |

The Debye-Waller factors (Δo²) are 0.006-0.009, which means that the fitting is within acceptable limits. The N_{Co—O} is in the range of 2.6-6.0, suggesting that Co atoms are in the distorted octahedral or tetrahedral environment. The N_{Co—O} slightly increases when the catalyst calcined at 400° C. as compared to that of the uncalcined catalyst, and then drops when the calcination temperature was further increased, indicating that the catalyst is undergoing transitions. The fitting results of N_{Co—O} obtained by using the Co paths from CoSO4 are higher than those obtained by using the Co paths from Co₃O₄. The deviation of the fitted bond distances (dR) is larger when the Co paths from Co₃O₄ are used, except for the catalyst calcined at 800° C. This indicates that the local environment of Co atoms is similar to that in CoSO₄, when calcination temperature is below 600° C. The environment of Co atoms changes to become more like that in Co₃O₄, when the calcination temperature increases to 800° C.

### Example 20

### S in the CoSO₄/SiO₂ Catalyst (Embodiment 3)

### Example 20.1

### Elemental Analysis of Sulfur

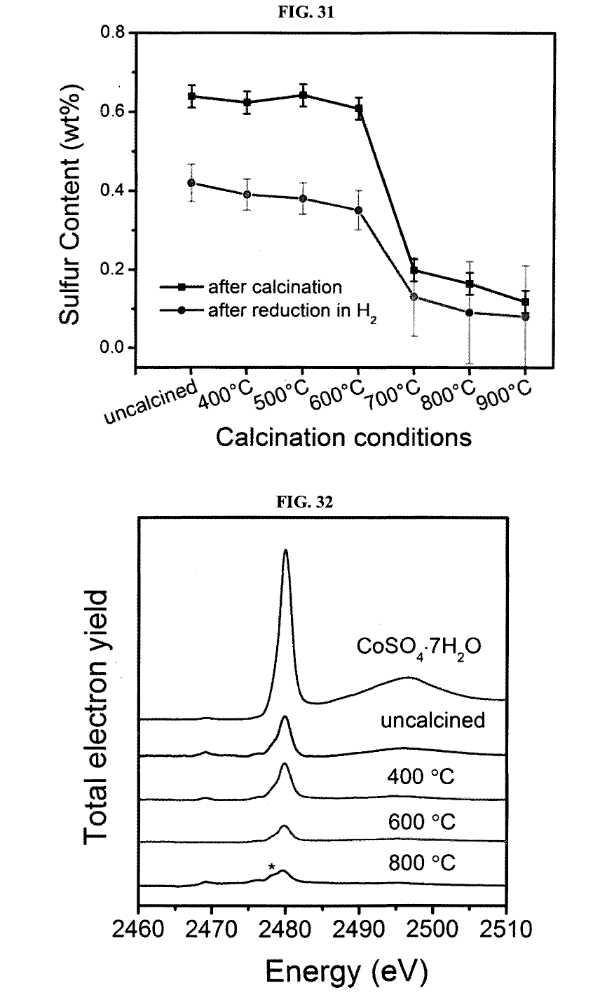

Several SiO₂ supported Co catalysts for SWCNT synthesis using different Co precursors have been evaluated: Co (II) nitrate, Co (II) acetate, Co (II) acetylacetonate, and Co (III) acetylacetonate. None of them shows a good selectivity to the (9,8) nanotubes. The results in this study suggest that the catalyst from CoSO₄ behaves differently from the catalysts using other Co precursors. It is suspected that S plays an important role in the chiral selectivity of the CoSO₄/SiO₂ catalyst. The elemental analysis was first used to corroborate the existence of S in the catalyst. FIG. 31 depicts the weight fraction of S in the CoSO₄/SiO₂ catalysts after calcination at different temperatures. There is 0.64 wt % S in the uncalcined catalyst. Sulfur content shows a slight decrease to 0.61 wt % when the catalyst calcination temperature increases to 600° C. A sharp drop to 0.20 wt % occurs when the calcination temperature is elevated to 700° C. The S content continues to drop to 0.12 wt % after catalyst calcination at 900° C.

Sulfur (S) content in catalysts after reduction in H₂ at 540° C. during SWCNT growth was also measured. The S content in reduced catalysts is lower due to the reduction in H₂. We can still observe a sharp drop when the calcination temperature changes from 600° C. to 700° C. Although the changing trend of S content does not exactly mirror the chiral selectivity change shown in FIG. 25A, it is similar to the changing trend of TPR results in FIG. 29 and the white line peak change in FIG. 30. This finding suggests that SO₄² deposited on SiO₂ may have decomposed during calcination, and different amount of S is removed from the catalyst after catalyst calcination at different conditions.

### Example 20.2

### XANES Spectra at the Sulfur K-Edge

XAS was subsequently used to examine the chemical structures of S species in the catalyst. XANES spectra at the S K-edge of the CoSO₄/SiO₂ catalysts calcined at different temperatures are illustrated in FIG. 32. The S K-edge comes from the transition of S 1 s electrons to unoccupied antibonding orbitals at the bottom of the conduction band. The edge position correlates with the oxidation state of S from S²⁻ to S⁶⁺. The preedge peak at 2480 eV can be attributed to S⁶⁺ in SO₄²⁻. The intensity of this peak decreases with the increase of catalyst calcination temperature, which supports the elemental analysis results in FIG. 31. In addition, the S peak shifts slightly to 2479.5 eV with the increase of calcination temperature to 800° C., and an obvious shoulder peak also appears around 2478 eV. This outcome may result from the sulphate distortion, in which the S═O bond reduces its order from a highly covalent double-bond character to a lesser double-bond character.

### Example 21

### Effect of Catalyst Calcination (Embodiment 3)

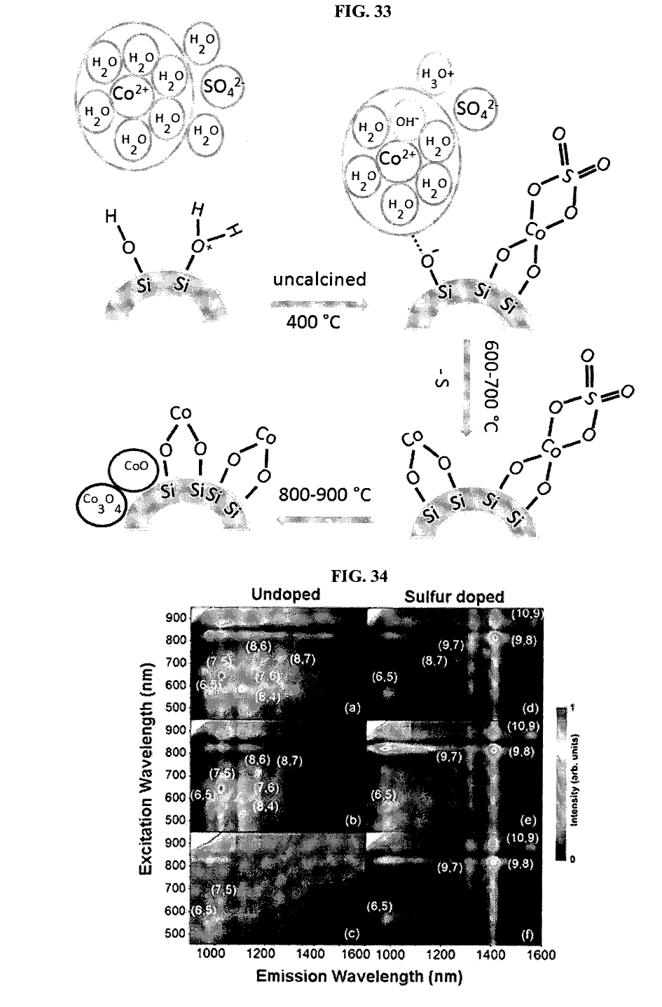

Based on characterization results of the CoSO₄/SiO₂ catalyst, it is postulated that the catalyst undergoes transitions at different calcination temperatures, as illustrated in FIG. 33. The tentative nature of the proposed mechanism is emphasized in the spirit of stimulating further exploration to understand the connection between catalyst structure and its chiral selection. The zero points of charge of SiO₂ is about 2-3; therefore, SiO₂ particles are negatively charged at pH>3. The aqueous solution of CoSO₄ has a pH around 5. Cations can adsorb on SiO₂ by ion exchange with H⁺ from silanol groups (SiOH). CoSO₄.7H₂O dissolved in deionized water forms [Co(H₂O)₆]²⁺ ions. For the uncalcined catalyst, Co ions adsorb on SiO₂ surface through electrostatic interaction. Another possibility is to form strongly bonded Co to the SiO₂ surface through oxolation reaction. When the catalyst calcination temperature is low (e.g. 400° C.), S in the CoSO₄/SiO₂ catalyst may exist as chelating bidentate SO₄²⁻, which is a common structure on sulfate promoted metal oxide catalysts. Cobalt ions could stay in either the octahedral environment surrounded by H₂O, or the tetrahedral environment, where each Co atom links to one S atom through two O atoms, and is also bonded to the SiO₂ surface through silanol groups. With the increase of calcination temperature, S═O bonds would decompose. The removal of S causes the formation of surface Co oxides. When the calcination temperature further increases to 800° C., S═O bonds in the catalyst decompose completely, while most of Co atoms are converted into Co oxides. Some of them would form rather large CoO or Co₃O₄ particles. At very high calcination temperature (e.g. higher than 950° C.), the reaction between Co oxides and SiO₂ may also lead to the formation of Co silicates.

Previous theoretical studies predict a linear correlation between the size of metal particles and the diameter of SWCNTs with their ratio ranging from 1.1 to 1.6. It has also been proposed that the chiral selectivity comes from the different growth rates of SWCNTs, which correlates with the chiral angle of nanotubes. The selectivity towards the large chiral angle (9,8) nanotubes at 1.17 nm by the CoSO₄/SiO₂ catalyst suggests that the catalytic Co metal particles leading to their growth may have a narrow size distribution around 1.29-1.87 nm. Our results suggest that the unique Co and S structures formed on SiO₂ surface at different catalyst calcination temperatures may influence the formation of Co particles for SWCNT growth. For the uncalcined catalyst and the catalyst calcined at 400° C., Co species are well spread on the large surface of SiO₂ particles. Therefore, Co metal particles with a suitable size could be formed on SiO₂ surface during SWCNT growth without severe aggregation. On one hand, the coexistence of S atoms near Co atoms may limit the aggregation of Co atoms, in contrast to catalysts prepared using other Co precursors without S. On the other hand, S atoms may also form various Co—S compounds, which could lead to the specific chiral selectivity towards the (9,8) nanotubes.

Based on current results, it cannot be concluded beyond doubt which of the above two roles played by S atoms is more important. With the increase of catalyst calcination temperature, some fractions of S atoms have been removed from the catalyst. The formation of surface Co oxides or Co silicates leads to the growth of Co metal particles in different sizes during the SWCNT synthesis. This is evident by the growth of the small diameter (6,5) nanotubes. Besides that, the abundance of the (6,5) nanotubes increases with the increasing catalyst calcination temperature and the decreasing S content in the catalyst. A previous study also reported that well dispersed Co silicates on SiO₂ surface can grow small diameter tubes, such as (6,5), (7,5), (7,6) and (8,4). When the catalyst calcination temperature further raises to 800° C. and 900° C., it may lead to the formation of some bulk Co oxides and Co silicates, although we cannot detect them in XRD. The bulk Co silicates are inactive for SWCNT growth, which correlates with the drop of the observed carbon deposit yield. Furthermore, bulk Co oxides can be reduced into large Co particles, which leads to the growth of carbon fibers and graphite observed in TEM analysis. Lastly, it is postulated that the shift of (n,m) selectivity from small diameter (6,5) to large diameter (9,8) may be credited to the jump in the diameter of stable Co particles. The diameter of (6,5) and (9,8) nanotubes match with two stable Co clusters (Co₅₅ at 0.93 nm and Co₁₄₇ at 1.22 nm). Previous theoretical studies have investigated the stability of Ni and Pt clusters. The size of most stable metal clusters is at some scattered values.

In experiments, it is more likely to form stable metal clusters at certain sizes, other than continually tuning the size of metal clusters. Thus, when the size of stable Co particles changes from one (Co₅₅) to the other (Co₁₄₇), the (n,m) selectivity jumps accordingly. It should be noted that the complexity of the chemical nature of the compound catalyst, especially S may also influence the nucleation of Co particles, making it difficult to obtain a detailed mechanism at present.

The CoSO₄/SiO₂ catalyst prepared by impregnating 1 wt % Co from Co (II) sulphate heptahydrate on fumed silica powder is an active catalyst for SWCNT growth. The catalyst shows unique selectivity toward the large diameter single chirality (9,8) nanotubes. When the catalyst is calcined in air at 400° C., it yields 50.52% of (9,8) nanotubes among all semiconducting SWCNTs. The catalyst also possesses a passable carbon yield of 3.8 wt %, which is useful in developing a scalable SWCNT production process. The chiral selectivity of the catalyst is correlated with the catalyst calcination temperatures; the selectivity would shift to small diameter nanotubes when the catalyst is calcined above 700° C.

The catalyst calcination plays a critical role in forming active Co species on SiO₂ surface for SWCNT growth. TEM, XRD and physisorption results show that the chiral selectivity change is not resulted from the morphology or physical structure changes of the catalyst. H₂-TPR, UV-vis spectroscopy and XAS studies demonstrate that, at low calcination temperature (≦400° C.), Co ions adsorb on SiO₂ surface through electrostatic interaction and/or form strongly bonded Co to the SiO₂ surface through the oxolation reaction. Sulfur exists as chelating bidentate SO₄²⁻ on the surface with Co atoms. The coexistence of S atoms near Co atoms may limit the aggregation of Co atoms or form various Co—S compounds, which may produce specific chiral selectivity towards the (9,8) nanotubes. With the increase of calcination temperature, some S atoms are removed from the catalyst, leading to the formation of surface Co oxides and Co silicates which are more selective to the small diameter SWCNTs. It is believed that novel sulfate promoted catalysts may be further developed to improve the chirality control and the yield of SWCNTs, which eventually reveal their enormous potentials in electronic and optoelectronic applications.

### Example 22

### Catalyst Preparation (Embodiment 4)

It is demonstrated herein that non-selective Co/SiO₂ catalysts can be converted into efficient chiral selective catalysts by S doping. SWCNTs were characterized by photoluminescence (PL), UV-vis-near-infrared (UV-vis-NIR) absorption and Raman spectroscopies. Catalysts were characterized by elemental analysis, H₂ temperature programmed reduction (H₂-TPR), and UV-vis diffuse reflectance spectroscopy. The molecular structural changes of Co species on SiO₂ caused by S doping are believed to be responsible for the chiral selectivity.

Three Co/SiO₂ catalysts with 1 wt. % Co were prepared by the impregnation method using three Co precursors, including cobalt (II) acetylacetonate (Co(acac)₂, Sigma-Aldrich, 97%), Co (II) chloride (CoCl₂, Alfa Aesar, 97%), and Co (II) nitrate hexahydrate (Co(NO₃)₂.6H₂O, Sigma-Aldrich, 99.999%). Co(acac)₂ was dissolved in dichloromethane (Sigma-Aldrich, anhydrous, 9.8%), while Co(NO₃)₂.6H₂O and CoCl₂ was dissolved in deionized water. The Co precursor solutions were then added to fumed silicon dioxide powders (Cab-O-Sil, M-5, Sigma-Aldrich) with surface area of 254 m²/g. The mixtures were aged at room temperature for 1 h, and subsequently dried in an oven at 100° C. for 2 h. The dried catalyst was further calcined under airflow of 20 sccm per gram of catalyst from room temperature to 400° C. at 1° C./min, and then kept at 400° C. for 1 h. These three catalysts were denoted as CoACAC/SiO₂, CoN/SiO₂, and CoCl/SiO₂.

In order to dope S into Co/SiO₂ catalysts, the above calcined catalysts were impregnated by dilute sulphuric acid (H₂SO₄, 0.04 mol/L) at the 8 mL solution/g catalyst ratio for 1 h. Afterwards, the mixtures were dried and calcined again using the same procedure described above. The resulting S doped catalysts were denoted as CoACAC/SiO₂/S, CoN/SiO₂/S, and CoCl/SiO₂/S, respectively.

### Example 23

### SWCNT Growth (Embodiment 4)

SWCNTs were synthesized in a CVD reactor under the same condition for all catalysts. A catalyst was first reduced under pure H₂ (1 bar, 50 sccm) from room temperature to 540° C. at 20° C./min, and then further heated to 780° C. under an Ar flow (1 bar, 50 sccm). At 780° C., pressured CO (6 bar, 200 sccm) replaced Ar and growth lasted for 1 h. The carbonyls in CO were removed by a Nanochem Purifilter from Matheson Gas Products.

### Example 24

### SWCNT Characterization (Embodiment 4)

As-synthesized SWCNTs with catalysts were first dissolved in NaOH aqueous solution (1.5 mol/L) to remove SiO₂, and then filtered on a nylon membrane with 0.2 μm pores. Carbon deposits on filter membranes were further dispersed in 2 wt. % sodium dodecyl benzene sulphonate (SDBS, Aldrich) D₂O solution by sonication using a cup-horn ultrasonicator (SONICS, VCX-130) at 20 W for 1 h.

SWCNT suspension obtained after centrifugation at 50,000 g for 1 h was characterised by photoluminescence (PL) and UV-vis-near-infrared (UV-vis-NIR) absorption spectroscopies.

PL was conducted on a spectrofluorometer (Jobin-Yvon, Nanolog-3) with the excitation scanned from 450 nm to 950 nm and the emission collected from 900 nm to 1600 nm.

The UV-vis-NIR absorption spectra were collected from 500 nm to 1600 nm on a spectrophotometer (Varian Cary 5000).

As-synthesized SWCNTs with catalysts and SWCNTs filtered on nylon membranes after SiO₂ removal were both characterized by Raman spectroscopy. No significant differences were found on the two types of samples. Raman spectra were collected on a Ramanscope (Renishaw) in the backscattering configuration over several random spots on each sample under 514 nm and 785 nm laser excitations. The integration time of 10 s. Laser energy of 2.5 mW to 5 mW was used to prevent sample damages.

### Example 25

### Catalyst Characterization (Embodiment 4)

The physicochemical properties of catalysts were evaluated by elemental analysis, H₂—temperature programmed reduction (H₂-TPR), and UV-vis diffuse reflectance spectroscopy.

First, the weight fraction of Sin the doped catalysts was determined by an elemental analyzer (Elementarvario, CHN). Around 5 mg of catalyst sample was used for each test. Each type of catalyst was tested three times to obtain the average value. Before each test, all samples were dried at 100° C. overnight.

Next, the reducibility of Co species on undoped and S doped Co/SiO₂ catalysts was characterised by TPR. CoO (Sigma-Aldrich, 99.99%), Co₃O₄ (Sigma-Aldrich, 99.8%), CoSiO₃ (MP Biomedicals, ICN215905), CoCl₂ (Alfa Aesar, 97%), and CoSO₄.7H₂O (Sigma-Aldrich, 99%) were used as references for TPR analysis.

The TPR experimental setup was equipped with a thermal conductivity detector (TCD) of a gas chromatography (Techcomp 7900). An acetone-liquid N₂ trap was installed between a quartz cell and the TCD to condense water or H₂S produced during catalyst reduction. In each test, 200 mg of catalysts or reference samples with equivalent Co loadings were loaded into a quartz cell. 5% H₂ in Ar was introduced to the quartz cell at 30 sccm, and pure Ar gas was used as a reference for the TCD. After the TCD baseline was stable, the temperature of the quartz cell was increased to 950° C. at 5° C./min, and then held at 950° C. for 30 min.

Last, UV-vis diffuse reflectance spectra of catalysts and Co reference samples were recorded on the spectrophotometer (Varian Cary 5000). The samples were first dried at 100° C. for 3 h, and then UV-vis spectra were recorded in the range of 200 nm to 800 nm with BaSO₄ as a reference.

### Example 26

### Abundance of (Nm) Species Identified in PL (Embodiment 4)

### Example 26.1

### PL Maps

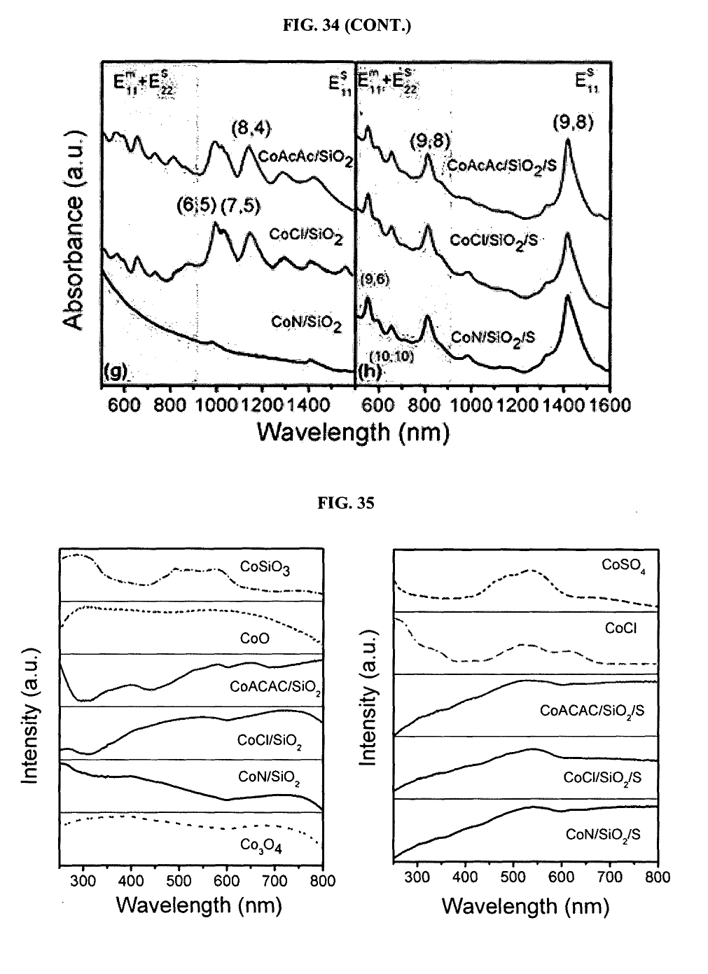

PL maps in FIG. 34A to F show that two undoped Co/SiO₂ catalysts (CoACAC/SiO₂ and CoCl/SiO₂) resulted in small-diameter tubes (<0.9 nm), such as (6,5), (7,5), (7,6) and (8,4). CoN/SiO₂ is not active for SWCNT growth. This is in agreement with previous studies using various SiO₂ supported Co catalysts.

In contrast, after doping with S, the major (n,m) products are large-80 diameter tubes (>1.1 nm), such as (9,8), (9,7), (10,6), and (10,9). The abundance of these four species calculated using their PL intensity is 52.4% to 69.1% of all semiconducting species identified, out of which, 32.7% to 40.5% is (9,8) (see TABLES 20 to 22).

### Example 26.2

### UV-Vis-NIR Absorption Spectra

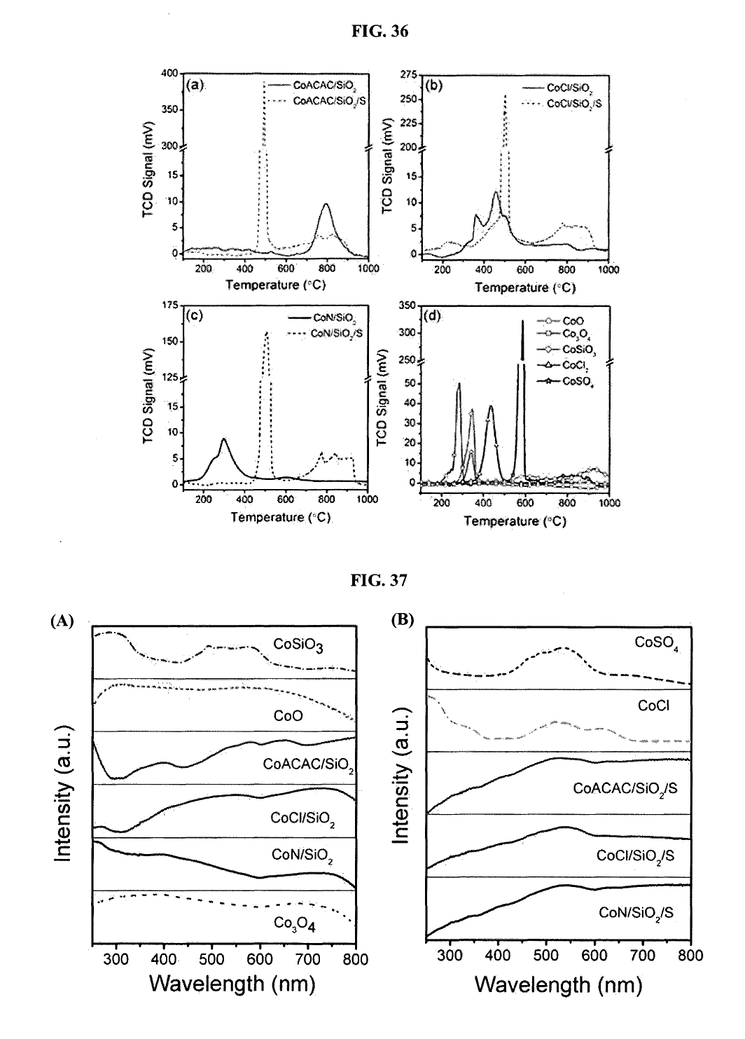

PL results were corroborated by UV-vis-NIR absorption spectra. FIG. 34G shows that SWCNTs from CoACAC/SiO₂ and CoCl/SiO₂ have intense absorption peaks at 992 nm, 1025 nm, and 1137 nm from (6,5), (7,5), (7,6), and (8,4). SWCNTs grown on CoN/SiO₂ have weak absorption peaks. In contrast, FIG. 36H shows that SWCNTs grown on S doped catalysts all have strong absorption peaks at 1420 nm and 818 nm, corresponding to the E^{S}₁₁ and E^{S}₂₂ transitions of (9,8). A few other absorption peaks below 700 nm can be assigned to either the E^{M}₁₁ transition of metallic (9,6) (1.02 nm) and (10,10) (1.36 nm), or the E^{S}₂₂ transition of semiconducting (6,5). Since the intensity of (6,5) PL peaks in FIG. 34D to F is low, the absorption peaks below 700 nm in FIG. 34H are likely to be from those metallic tubes.

TABLE 20
Tabulated values of PL intensities and relative abundances of (n, m)
species in SWCNTs produced on the CoACAC/SiO₂/S catalyst.

| | | Chiral | | | PL | Relative |
|---|---|---|---|---|---|---|
| (n, m) | Diameter | angle | E₁₁ | E₂₂ | intensity | abundance, |
| index | dₜ (nm) | θ (°) | (nm) | (nm) | (counts) | (%) |
| (6, 5) | 0.76 | 27.00 | 983 | 570 | 537.5 | 7.7 |
| (7, 3) | 0.71 | 17.00 | 990 | 510 | 264.9 | 3.8 |
| (7, 5) | 0.83 | 24.50 | 1023 | 642 | 155.0 | 2.2 |
| (7, 6) | 0.90 | 27.46 | 1122 | 646 | 169.5 | 2.4 |
| (8, 4) | 0.84 | 19.11 | 1111 | 578 | 241.0 | 3.4 |
| (8, 6) | 0.97 | 25.28 | 1165 | 714 | 113.5 | 1.6 |
| (8, 7) | 1.03 | 27.80 | 1264 | 726 | 403.8 | 5.8 |
| (9, 7) | 1.10 | 25.87 | 1321 | 790 | 995.2 | 14.2 |
| (9, 8) | 1.17 | 28.05 | 1414 | 822 | 2836.2 | 40.5 |
| (10, 6) | 1.11 | 21.79 | 1380 | 754 | 535.4 | 7.7 |
| (10, 8) | 1.24 | 26.30 | 1467 | 870 | 277.0 | 4.0 |
| (10, 9) | 1.31 | 28.30 | 1562 | 886 | 469.5 | 6.7 |

TABLE 21
Tabulated values of PL intensities and relative abundances of (n, m)
species in SWCNTs produced on the CoCl/SiO₂/S catalyst.

| | | Chiral | | | PL | Relative |
|---|---|---|---|---|---|---|
| (n, m) | Diameter | angle | E₁₁ | E₂₂ | intensity | abundance, |
| index | dₜ (nm) | θ (°) | (nm) | (nm) | (counts) | (%) |
| (6, 5) | 0.76 | 27.00 | 982 | 570 | 182.4 | 12.4 |
| (7, 3) | 0.71 | 17.00 | 986 | 502 | 131.6 | 8.9 |
| (7, 5) | 0.83 | 24.50 | 1023 | 642 | 96.1 | 6.5 |
| (7, 6) | 0.90 | 27.46 | 1113 | 642 | 72.3 | 4.9 |
| (8, 4) | 0.84 | 19.11 | 1109 | 578 | 75.4 | 5.1 |
| (8, 6) | 0.97 | 25.28 | 1162 | 714 | 49.0 | 3.3 |
| (8, 7) | 1.03 | 27.80 | 1265 | 722 | 59.5 | 4.0 |
| (9, 7) | 1.10 | 25.87 | 1319 | 790 | 106.6 | 7.2 |
| (9, 8) | 1.17 | 28.05 | 1412 | 818 | 478.2 | 32.7 |
| (10, 6) | 1.11 | 21.79 | 1376 | 758 | 63.2 | 4.3 |
| (10, 8) | 1.24 | 26.30 | 1469 | 866 | 36.4 | 2.5 |
| (10, 9) | 1.31 | 28.30 | 1558 | 890 | 119.9 | 8.2 |

TABLE 22
Tabulated values of PL intensities and relative abundances of (n, m)
species in SWCNTs produced on the CoN/SiO₂/S catalyst.

| | | Chiral | | | PL | Relative |
|---|---|---|---|---|---|---|
| (n, m) | Diameter | angle | E₁₁ | E₂₂ | intensity | abundance, |
| index | dₜ (nm) | θ (°) | (nm) | (nm) | (counts) | (%) |
| (6, 5) | 0.76 | 27.00 | 979 | 566 | 228.4 | 8.8 |
| (7, 3) | 0.71 | 17.00 | 986 | 506 | 135.4 | 5.2 |
| (7, 5) | 0.83 | 24.50 | 1024 | 642 | 121.8 | 4.7 |
| (7, 6) | 0.90 | 27.46 | 1113 | 642 | 101.6 | 3.9 |
| (8, 4) | 0.84 | 19.11 | 1110 | 578 | 120.8 | 4.7 |
| (8, 6) | 0.97 | 25.28 | 1165 | 714 | 63.9 | 2.5 |
| (8, 7) | 1.03 | 27.80 | 1263 | 726 | 120.6 | 4.7 |
| (9, 7) | 1.10 | 25.87 | 1319 | 790 | 259.1 | 10.0 |
| (9, 8) | 1.17 | 28.05 | 1413 | 818 | 1020.8 | 39.5 |
| (10, 6) | 1.11 | 21.79 | 1377 | 750 | 143.7 | 5.6 |
| (10, 8) | 1.24 | 26.30 | 1469 | 866 | 81.5 | 3.1 |
| (10, 9) | 1.31 | 28.30 | 1558 | 886 | 189.4 | 7.3 |

### Example 27

### Raman Spectra of SWCNTs (Embodiment 4)

SWCNTs were further characterized by Raman spectroscopy under two excitation lasers (785 nm and 514 nm).

FIG. 35 shows Raman spectra of carbon deposits grown from undoped and S doped Co/SiO₂ catalysts under 514 nm and 785 nm laser excitations. The radial breathing mode (RBM) peaks (below 400 cm⁻¹), D band and G band features can be used to evaluate the diameter and quality of resulting SWCNTs. The intense RBM peaks and weak D band peaks from carbon deposits grown on CoCl/SiO₂ and CoACAC/SiO₂ suggest that high quality SWCNTs are produced. In contrast, the low intensity RBM peaks and intense D band peaks from carbon deposits grown on CoN/SiO₂ suggest that this catalyst is not active for SWCNT growth. The RBM peaks can be correlated with the (n,m) structures of SWCNTs according to the Kataura plot computed by the tight-binding model.

The diameter of SWCNTs was calculated using the equation Ω_{RBM}=223.5 cm⁻¹/dₜ+12.5 cm⁻¹, where ω_{RBM} and dₜ are the RBM frequency and the diameter of SWCNTs. The RBM peaks in FIGS. 35A and C at 238 cm⁻¹ and 267 cm⁻¹ can be assigned to (8,6) and (7,6) according to the empirical Kataura plot, suggesting that the undoped catalysts mainly produce SWCNTs with diameters less than 1 nm.

In comparison, all S doped Co/SiO₂ catalysts produce SWCNTs with high quality, as indicated by their intense RBM peaks and weak D band peaks (see FIGS. 35B and D). The major RBM peaks centered around 202 cm⁻¹ and 213 cm⁻¹ can be ascribed to the (9,8) and (9,7) with diameters around 1.1 nm to 1.17 nm.

Raman results (see FIG. 35) agree with the findings from PL and UV-vis-NIR. Overall, the three spectroscopic techniques of PL, UV-vis-NIR absorption spectra, and Raman spectroscopy have demonstrated that S doping can shift the (m, m) selectivity of Co/SiO₂ catalysts from small-25 diameter tubes near (6,5) to large-diameter tubes with a narrow distribution around (9,8).

### Example 28

### UV-Vis Spectra of Co/SiO₂ Catalysts Embodiment 4

UV-vis diffuse reflectance spectroscopy was used to study the surface chemistry of undoped and S doped Co/SiO₂ catalysts. FIG. 37 shows that the spectrum of CoN/SiO₂ is similar to that of Co₃O₄, having two broad peaks at around 400 nm and 720 nm respectively. These two peaks can be assigned to the υ₁⁴A_{1g}→¹T_{1g} and υ₂¹A_{1g}→¹T_{2g} transitions of octahedral configured Co³⁺ ions. The spectrum of CoCl/SiO₂ shows two broad peaks around 550 nm and 720 nm, which suggests the presence of CoO_{X} and CoCl₂. CoACAC/SiO₂ has two peaks around 570 nm and 650 nm, suggesting the formation of surface Co silicates. In contrast, the three S doped Co/SiO₂ catalysts all have a broad peak around 535 nm similar to that of CoSO₄, suggesting the existence of Co species bonded to SO₄²⁻. It was found that all of them have a similar light pink color.

### Example 29

### Transmission Electron Microscopy (TEM) (Embodiment 4)

One milligram of as-synthesized SWCNTs together with the catalyst (CoACAC/SiO₂/S) was sonicated with 5 mL of anhydrous ethanol for 1 h, and a drop of the suspension was applied to a copper grid with holey carbon film. The grid was inserted into a Philips Tecnai 12 electron microscope, and TEM images were taken at an operation voltage of 120 kV.

TEM images in FIG. 39 shows that SWCNTs grown from Co nanoparticles on SiO₂ form nanotube bundles. The diameter of individual tubes is about 1.2 nm, which agrees with spectroscopic results. Because active Co nanoparticles would be embedded under or near SiO₂ surface, we are still unable to quantify their size and composition in TEM analysis.

### Example 30

### (NH₄)₂SO₄ Doped Co/SiO₂ Catalyst (Embodiment 4)

### Example 30.1

### Doping Method

The CoN/SiO₂ catalyst was impregnated by ammonium sulfate ((NH₄)₂SO₄, 0.2 mol/L) at the 8 mL solution/g catalyst ratio for 1 h, and subsequently dried in an oven at 100° C. for 2 h. The dried catalyst was further calcined under airflow of 20 sccm per gram of catalyst from room temperature to 400° C. at 1° C./min, and then kept at 400° C. for 1 h. The resulting S doped catalyst was denoted as CoN/SiO₂/AS.

### Example 30.2

### PL and Abundance of (n,m) Species

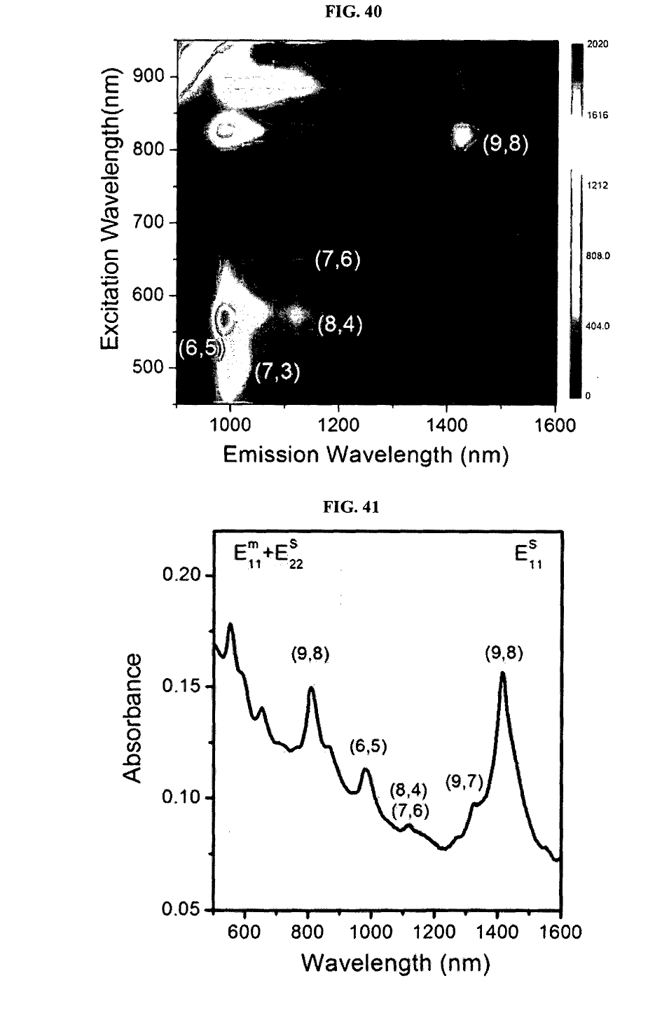

The PL map in FIG. 40 shows that (NH₄)₂SO₄ doped CoN/SiO₂ catalyst produces dominantly (6,5) tubes (35.4%) while (9,8) tubes are present in smaller amount (11.3%). This can be attributed to the doping of S. Overall, CoN/SiO₂/AS is less selective to (9,8) SWCNTs as compared to CoN/SiO₂/S.

TABLE 23
Tabulated values of PL intensities and relative abundances of (n, m)
species in SWCNTs produced on the CoN/SiO₂/AS catalyst.

| | | Chiral | | | PL | Relative |
|---|---|---|---|---|---|---|
| (n, m) | Diameter | angle | E₁₁ | E₂₂ | intensity | abundance, |
| index | dₜ (nm) | θ (°) | (nm) | (nm) | (counts) | (%) |
| (6, 5) | 0.76 | 27.00 | 991 | 566 | 1928.3 | 35.40% |
| (7, 3) | 0.71 | 17.00 | 989 | 502 | 734.1 | 13.50% |
| (7, 5) | 0.83 | 24.50 | 1025 | 638 | 408.4 | 7.50% |
| (7, 6) | 0.90 | 27.46 | 1127 | 642 | 409.7 | 7.50% |
| (8, 4) | 0.84 | 19.11 | 1120 | 574 | 486.4 | 8.90% |
| (8, 6) | 0.97 | 25.28 | 1163 | 718 | 138.3 | 2.50% |
| (8, 7) | 1.03 | 27.80 | 1269 | 726 | 173.7 | 3.20% |
| (9, 7) | 1.10 | 25.87 | 1330 | 790 | 216.7 | 4.00% |
| (9, 8) | 1.17 | 28.05 | 1428 | 822 | 613.6 | 11.30% |
| (10, 6) | 1.11 | 21.79 | 1377 | 754 | 123.1 | 2.30% |
| (10, 8) | 1.24 | 26.30 | 1470 | 866 | 105.7 | 1.90% |
| (10, 9) | 1.31 | 28.30 | 1557 | 890 | 107.2 | 2.00% |

### Example 30.3

### Absorption Spectra

The strong absorption peaks at 1415 nm and 810 nm in FIG. 41 correspond to the E^{S}₁₁ and E^{S}₂₂ transition of (9,8). The peak around 983 nm from the E^{S}₁₁ transition of (6,5) is much more intense compared to that of SWCNTs grown from CoN/SiO₂/S, indicating more (6,5) tubes are grown on CoN/SiO₂/AS. As the absorption coefficient of (9,8) is higher than that of (6,5), the absorption peaks from (9,8) look larger than that of (6,5). A few absorption peaks below 700 nm can be assigned to either the EM11 transition of metallic (9,6) and (10,10) or the E^{S}₂₂ transition of semiconducting (6,5).

### Example 30.4

### H₂-TPR

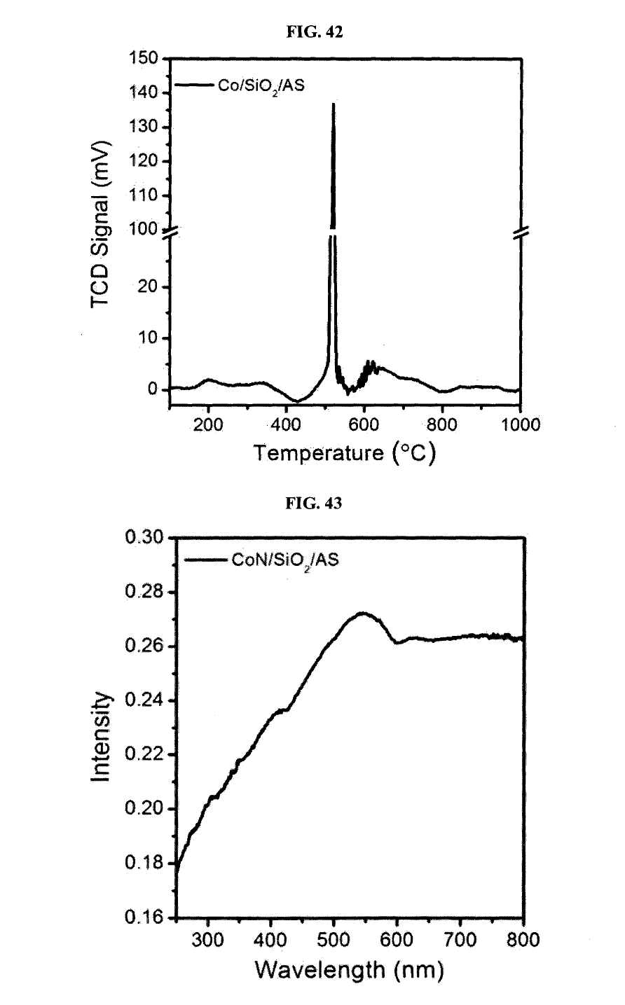

The TPR profile of CoN/SiO₂/AS has an intense peak around 519° C., which is similar to that of CoN/SiO₂/S shown in FIG. 36C. However, the large peak around 800° C. of CoN/SiO₂/S shown in FIG. 36C is very weak in FIG. 42. The CoN/SiO₂/AS has a broad peak from 425° C. to 800° C., suggesting the existence of several Co species, including unreacted CoOₓ, Co hydrosilicate, and surface Co silicate.

### Example 30.5

### UV-Vis Diffuse Reflectance Spectroscopy

FIG. 43 shows that the UV-vis spectrum of CoN/SiO₂/AS catalyst has a broad peak around 535 nm similar to that of CoN/SiO₂/S, suggesting the existence of Co species bonded to SO₄²⁻.

### Example 31

### Discussion (Embodiment 4)

Co species deposited on SiO₂ would first be partially reduced in H₂, and then nucleated into Co nanoparticles to initiate SWCNT growth. The change in (n,m) selectivity shown in FIG. 34 may be attributed to the changes in Co species caused by S doping. Firstly, we conducted an elemental analysis of S doped catalysts. The S content in CoACAC/SiO₂/S, CoCl/SiO₂/S, and CoN/SiO₂/S was found to be 0.91 wt. %, 1.17 wt. % and 0.83 wt. %, respectively. This confirms the existence of S.

Next, H₂-TPR was employed to study the reducibility of Co species. FIG. 36 shows that CoACAC/SiO₂ displays a peak around 797° C., which is due to the surface Co silicate. CoCl/SiO₂ has multiple peaks at 360° C. to 800° C., which may come from the reduction of CoO, CoCl₂, and surface Co silicate.

CoN/SiO₂ possesses a broad peak around 290° C. which can be attributed to Co₃O₄ and CoO. In contrast, all the TPR profiles of the three S doped Co/SiO₂ catalysts have a sharp peak at 493° C. to 506° C. In addition, it is observed that the CoOₓ peaks of undoped catalysts become significantly smaller after S doping, and new peaks around 800° C. appear on CoCl/SiO₂/S and CoN/SiO₂/S. This observation suggests the formation Co hydrosilicate or surface Co silicate, while the 797° C. peak of CoACAC/SiO₂ becomes smaller.

Lastly, UV-vis diffuse reflectance spectroscopy was used to probe the surface chemistry of the catalysts. As shown in FIG. 37, CoACAC/SiO₂ has two peaks around 570 nm and 650 nm, suggesting the formation of surface Co silicates. The spectrum of CoCl/SiO₂ shows two broad peaks at 550 nm and 720 nm, indicating the presence of CoOₓ and CoCl₂. The spectrum of CoN/SiO₂ is similar to that of Co₃O₄, having two broad peaks at about 400 nm and 720 nm, which can be assigned to the transitions of octahedral configured Co³⁺ ions. In contrast, all the three S doped Co/SiO₂ catalysts have a broad peak around 535 nm similar to that of CoSO₄ and this suggests the existence of Co species bonded to SO₄²⁻.

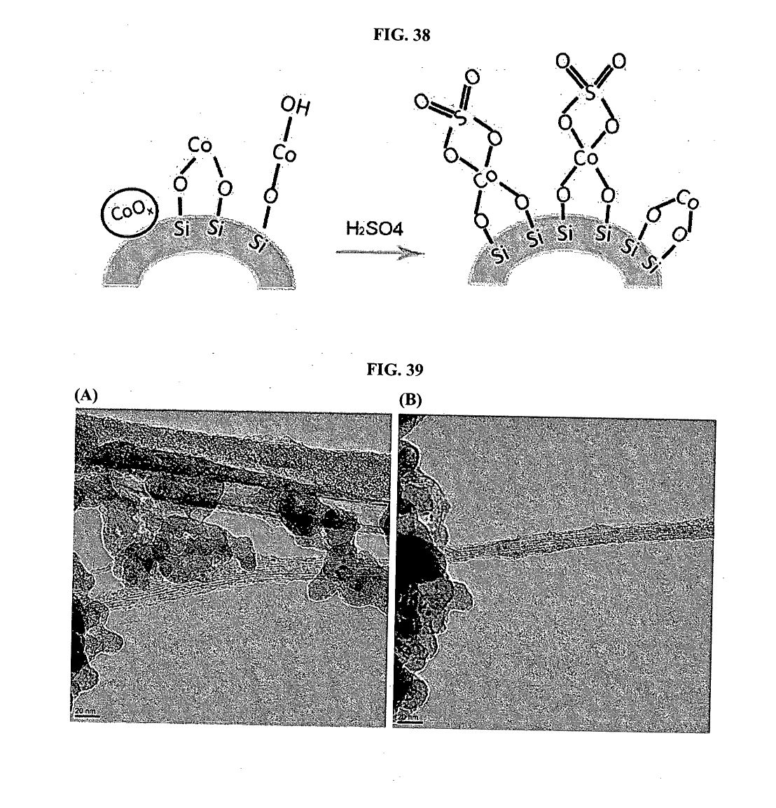

Doping sulfate ions to metal oxides has created various solid acid catalysts, such as SO₄²⁻/ZrO₂, SO₄²⁻/TiO₂, and SO₄²⁻/Fe₂O₃. Based on our characterization of the Co/SiO₂ catalysts, the following mechanism is proposed to explain their (n,m) selectivity in SWCNT growth. As shown in FIG. 38, undoped Co/SiO₂ catalysts contain CoOₓ, Co hydrosilicate, and surface Co silicates, which are evident from their H₂-TPR profiles and UV-vis spectra. Surface Co silicates on CoACAC/SiO₂ and CoCl/SiO₂ would be reduced and nucleated into small Co nanoparticles, which are selective toward small-diameter SWCNTs, as shown in FIG. 34.

CoOₓ on CoN/SiO₂ is reduced to form large Co particles, which are not selective to SWCNTs. Doping S through H₂SO₄ leads to the formation of chelating bidentate SO₄²⁻, where one S atom is linked to one Co atom through two O atoms, a common structure found in sulfate promoted metal oxide catalysts. This is supported by the sharp peaks at 493° C. to 506° C. in the TPR profiles and the broad peak around 535 nm in the UV-vis spectra.

It is proposed that the co-existence of S atoms near Co atoms may limit the nucleation of Co and/or form Co—S compounds, which change the selectivity of the catalysts to favor the formation of (9,8). The selectivity towards (9,8) may be attributed to the close match between carbon caps and the most stable Co particles in their size range, as well as the higher growth rate of high chiral angle tubes. As active Co nanoparticles are embedded under or near SiO₂ surfaces, their size and composition are not able to be quantified in transmission electron microscope analysis (see FIG. 39).

Furthermore, a reaction between H⁺ ions and CoOₓ is proposed, releasing Co ions to form well dispersed Co hydrosilicate and surface Co silicate on SiO₂. This increases selectivity towards (9,8) SWCNTs. This is shown by the increased SWCNT selectivity of CoN/SiO₂/S.

To further verify the proposed mechanism, CoN/SiO₂ was doped using (NH₄)₂SO₄. The same effect from SO₄²⁻ was expected, but selectivity towards SWCNTs may be compromised since NH⁴⁺ is less reactive than H⁺. As shown in FIG. 40 to FIG. 43, (NH₄)₂SO₄ doped CoN/SiO₂ can result in the growth of (9,8) nanotubes because of S doping. However, it is less selective to SWCNTs as compared to CoN/SiO₂/S. This provides strong credibility to our proposed mechanism.

In conclusion, a method to convert three types of Co/SiO₂ catalysts has been demonstrated, which are either inactive for the SWCNT growth or only selective to small-diameter nanotubes, into chirally selective catalysts to grow SWCNTs enriched with large-diameter (9,8) tubes (up to 40.5%) by doping catalysts with S. It is also proposed in the mechanism that S atoms near Co atoms assist the formation of Co nanoparticles which are selective to (9,8) tubes. Moreover, H⁺ ions may react with CoOₜ to form well dispersed Co hydrosilicate and surface Co silicate on SiO₂, which increases the selectivity to SWCNTs.

While the present invention has been particularly shown and described with reference to exemplary embodiments thereof, it will be understood by those of ordinary skill in the art that various changes in form and details may be made therein without departing from the spirit and scope of the present invention as defined by the following claims.

1. A method of preparing a sulfur-containing catalyst for the chirally selective synthesis of single-walled carbon nanotubes, the method comprising:
a)
i) providing a transition metal-containing support, wherein the transition metal is selected from the group consisting of cobalt, iron, nickel, chromium, manganese, copper, rhodium, ruthenium, and mixtures thereof;
ii) impregnating the transition metal-containing support with a solution comprising sulfate ions to form a sulfur-doped transition metal-containing support; and
iii) calcining the sulfur-doped transition metal-containing support at a temperature of less than 700° C. to form the sulfur-containing catalyst; or
b)
i) impregnating a support with a solution comprising a sulfate salt of a transition metal to form a transition metal sulfate-impregnated support, wherein the transition metal is selected from the group consisting of cobalt, iron, nickel, chromium, manganese, copper, rhodium, ruthenium, and mixtures thereof; and
ii) calcining the transition metal sulfate-impregnated support at a temperature of less than 700° C. to form the sulfur-containing catalyst.

2.-4. (canceled)

5. The method according to claim 1, wherein the transition metal comprises or consists essentially of cobalt.

6. The method according to claim 1, wherein providing the transition metal-containing support comprises
a) impregnating a support with a solution comprising transition metal to form an impregnated support; and
b) calcining the impregnated support at a temperature of less than 700° C. to form the transition metal-containing support.

7. The method according to claim 6, wherein the solution comprising transition metal is an aqueous solution having dissolved therein a salt of the transition metal, wherein the salt of the transition metal is selected from the group consisting of an acetylacetonate salt, a halide salt, a nitrate salt, a phosphate salt, a carbonate salt, and mixtures thereof.

8.-10. (canceled)

11. The method according to claim 1, wherein the sulfate ions are provided by an acid or salt selected from the group consisting of sulfuric acid, sulfurous acid, ammonium sulfate, ammonium bisulfate, and mixtures thereof.

12. (canceled)

13. The method according to claim 1, wherein concentration of sulfate ions in the solution comprising sulfate ions is in the range from about 0.01 mol/L to about 5 mol/L.

14.-17. (canceled)

18. The method according to claim 1, wherein calcining comprises heating the support at a temperature in the range from about 300° C. to about 700° C.

19.-22. (canceled)

23. A sulfur-containing catalyst for the chirally selective synthesis of single-walled carbon nanotubes, the catalyst comprising sulfur-doped transition metal as active phase on a support, wherein the sulfur-doped transition metal comprises a sulfur species having a S═O bond, wherein the transition metal is selected from the group consisting of cobalt, iron, nickel, chromium, manganese, copper, rhodium, ruthenium, and mixtures thereof.

24.-26. (canceled)

27. The catalyst according to claim 23, wherein the transition metal comprises or consists essentially of cobalt.

28. The catalyst according to claim 23, wherein the sulfur-doped transition metal has a sulfur content in the range from about 0.1 wt % to about 30 wt %.

29. (canceled)

30. The catalyst according to claim 23, wherein the sulfur-doped transition metal comprises or consists essentially of cobalt sulfate.

31. The catalyst according to claim 23, wherein the mean maximal dimension of the sulfur-doped transition metal on the support is in the range from about 1 nm to about 1.5 nm.

32. (canceled)

33. A method of forming single-walled carbon nanotubes having a selected chirality, the method comprising
i) reducing a sulfur-containing catalyst comprising sulfur-doped transition metal as active phase on a support, wherein the sulfur-doped transition metal comprises a sulfur species having a S═O bond, wherein the transition metal is selected from the group consisting of cobalt, iron, nickel, chromium, manganese, copper, rhodium, ruthenium, and mixtures thereof, with a reducing agent, and
ii) contacting a gaseous source of carbon with the catalyst to form the carbon nanotubes.

34. The method according to claim 33, wherein the reducing agent comprises or consists essentially of hydrogen gas.

35. The method according to claim 33, wherein reducing the catalyst is carried out at a temperature in the range from about 300° C. to about 550° C.

36. The method according to claim 33, further comprising purging the catalyst with an inert gas prior to contacting the gaseous source of carbon with the catalyst.

37. (canceled)

38. The method according to claim 36, wherein purging the catalyst is carried at a temperature in the range from about 500° C. to about 800° C.

39. The method according to claim 33, wherein the gaseous source of carbon is selected from the group consisting of carbon monoxide, methane, methanol, ethanol, acetylene and mixtures thereof.

40.-42. (canceled)

43. The method according to claim 33, wherein at least 50% of the single-walled carbon nanotubes formed have the chiral indices (9,8), (9,7), (10,6), and (10,9).

44. The method according to claim 33, wherein at least 30% of the single-walled carbon nanotubes formed have the chiral index (9,8).

45.-46. (canceled)
